(19) United States
(12) Patent Application Publication
(10) Pub. No.: US 2025/0255302 A1
(43) Pub. Date: Aug. 14, 2025

(54) FLUXAMETAMIDE COMPOSITION AND PROCESS OF PREPARATION THEREOF

(71) Applicant: RAJDHANI PETROCHEMICALS PRIVATE LIMITED, Ahmedabad, Gujarat (IN)

(72) Inventors: Dipakkumar PATEL, Ahmedabad (IN); Kenal V SHAH, Ahmedabad (IN); Bhavesh V SHAH, Ahmedabad (IN); Kawarlal DABODHIA, Ahmedabad (IN)

(73) Assignee: RAJDHANI PETROCHEMICALS PRIVATE LIMITED, Ahmedabad, Gujarat (IN)

(21) Appl. No.: 18/856,818

(22) PCT Filed: Apr. 15, 2023
(86) PCT No.: PCT/IN2023/050366

§ 371 Date: Oct. 14, 2024

(30) Foreign Application Priority Data
Apr. 15, 2022 (IN) 202221022468

(51) Int. Cl. A01N 43/80; A01N 25/04; A01N 43/56; A01N 43/78; A01N 43/90; A01N 47/30; A01N 53/00; A01P 3/00; A01P 7/02; A01P 7/04

(52) U.S. Cl. CPC A01N 43/80; A01N 25/04; A01N 43/56; A01N 43/78; A01N 43/90; A01N 47/30; A01N 53/00; A01P 3/00; A01P 7/02; A01P 7/04

(57) ABSTRACT

The present invention relates to fluxametamide composition and process of preparation thereof. The present invention more particularly relates to synergistic composition of fluxametamide or its agrochemically acceptable salts thereof, one insecticide selected from diamide group, at least one or more compound selected from insecticides, fungicide and plant health additives, and agrochemically acceptable excipients; and a method of preparing a stable and non-phytotoxic formulation. The present invention further relates to a pesticidal composition for controlling the harmful pests in plants, which can be formulated and is environmentally safe, and which demonstrates high efficacy, and acts for disease resistance management or to delay disease resistance development through engaging multiple modes of action, and increases plant tolerance against insect-pests, mites and, fungal and bacterial diseases, abiotic stress and improves overall health and vigor of the treated plant.

### FIELD OF INVENTION

The present invention relates to fluxametamide composition and process of preparation thereof. More specifically, the present invention relates to a pesticidal composition comprising bioactive amounts of fluxametamide or its agrochemically acceptable salts thereof, one insecticide selected from diamide group, at least one more compound selected from insecticides, fungicides and/or plant health additives, and agrochemically acceptable excipients; and a process of preparing said composition. The present invention further relates to a pesticidal composition that increases plant tolerance against insect-pests and mites, fungal and bacterial diseases, abiotic stress and improves overall health and vigor of the treated plant.

### BACKGROUND OF THE INVENTION

The protection of crops and its produce from insect pest damage is essential in agriculture produce enhancement. Each year insects, plant pathogens, and weeds, destroy more than 40% of all food production. This loss occurs despite the application of pesticides and the use of a wide array of non-chemical controls, such as, crop rotations, and biological controls. If just some of this food could be saved, it could be used to feed more than three billion people in the world who are malnourished.

The problem of pest resistance in agricultural production is a global problem, and it has always been the focus of attention of agricultural science and technology workers. Chemical control by the use of various chemicals and formulations is an important tool in agriculture for the prevention and control of pests. Insecticides of many types and groups are reported in the literature and a large number are in use, commercially, for control of pests in agriculture. With the continuous use of chemical pesticides to control pests year after year, the increase in the use of pesticides and the unscientific use of pesticides; the resistance to pests has become increasingly serious, and the types of pests that have developed resistance have increased. At the same time, the high-intensity use of pesticides has led to a series of problems such as excessive pesticide residues in agricultural products, environmental pollution, and increased costs for farmers to use drugs, which is not conducive to the sustainable development of agriculture.

The history of insecticidal isoxazolines can be traced back to the discovery of the phthalic and the anthranilic diamides. Isoxazolines target the γ-aminobutyric acid (GABA) receptor of the chloride channel and diamides target the ryanodine receptor (RyR) of the calcium-activated calcium channel. The phthalic diamide flubendiamide and anthranilic diamides chlorantraniliprole and cyantraniliprole act at an allosteric site of the RyR to activate calcium release in insects but not mammals. They are the most important insecticide introductions of the past two decades. Pesticide researchers at Nihon Nohyaku in Japan developed a pyrazine dicarboxamide herbicide lead with weak insecticidal activity into flubendiamide, the first of the diamide insecticides. A critical step was introducing an aniline moiety with a perfluoroalkyl side chain. These developments took place in 1993-2006. During that period, DuPont researchers discovered the highly effective anthranilic diamides optimized to first chlorantraniliprole and then cyantraniliprole. The phthalic and anthranilic diamides are highly effective, of low mammalian toxicity and act on an insect diamide binding site of little or no importance in mammals. This selectivity was a remarkable feature of these diamides which in contrast to Ry itself have a low toxicity to mammals and little or no binding to mammalian muscle membranes. They are particularly effective against lepidopteran pests of cruciferous vegetable crops, such as Plutella xylostella, the diamondback moth.

Agricultural biostimulants are blends of compounds, substances, and microorganisms that are sprayed on plants or soils to boost crop vigor, yields, quality, and abiotic stress tolerance. Biostimulants promote plant growth and development in a variety of ways throughout the crop life cycle, from seed germination to maturity. Biostimulants function via distinct mechanisms than fertilizers, irrespective of the presence of nutrients in the products. Biostimulants vary from crop protection products due to the fact they act best at the plant's vigor and do not have any direct actions against pests or disease. Crop biostimulation is as a consequence, complementary to crop nutrition and crop protection. Plant growth regulators are defined as small, simple chemicals produced naturally by plants to regulate their growth and development. Plant growth regulators (PGRs) are molecules that influence the development of plants and are generally active at very low concentrations. There are natural regulators, which are produced by the plant itself, and also synthetic regulators; those found naturally in plants are called phytohormones or plant hormones.

Combination of insecticides and fungicides are used to broaden the spectrum of control of insect and fungi, to improve the pest control with synergistic effect, reduce dosage, thereby reducing environmental impact, to broaden the spectrum of control, i.e. chewing and sucking insects and fungal disease at a time, decrease chances of resistance development and to enhance residual control so lesser the number of sprays for crop protections and minimizing the pesticidal load in ecosystem.

There are many combinations of insecticides along with other insecticides or fungicides known in the art for the control of pests. For example, CN107593723A relates to a binary composition comprising fluxametamide, and chlorfenapyr, chlorpheniridine, GF-2877, spiropidion, kappa-bifenthrin, kappa-tefluthrin, cyanocastrobin, fluconazolamide, fluacloxacin, mefentrifluconazole, ipfentrifluconazole, dipymetitrone, fenpicoxamid, aminopyrifen, inpyrfluxam, trifluoromide amide or more than one combination.

CN110199999A relates to a pesticide binary composition containing fluxametamide and tolfenpyrad in a weight ratio of fluxametamide to tolfenpyrad is 10:1 to 1:5, the composition comprises the active ingredients, and the balance of assistants.

WO 2018/224914 A1 relates to diamide insecticides in combination with at least one multi-site fungicide and at least a second fungicidally active compound. IN 201731033800 A relates to combinations comprising a diamide insecticide in combination with fungicidally active compounds and plant health promoting agents for controlling unwanted animal pests, such as insects, acaricides and/or nematodes, and unwanted phytopathogenic fungi.

There is however a need for improvement of these combinations. Single active combinations used over a long period of time have resulted in resistance. With the onset of resistance to certain pests, there is a need in the art for a combination of actives that decreases chances of resistance and improves the spectrum of disease and pest control.

The active ingredients known from the literature have certain disadvantages such as insufficient control efficacy, restriction of its use due to the appearance of drug-resistant pathogenic fungi, phytotoxicity and contamination to plants, or toxicity to human beings, beasts, fishes and the like. Hence, there is a long felt need to develop novel and effective pesticidal combinations for controlling the harmful pests in plants that demonstrate high efficacy, are environmentally safe and can be advantageously formulated.

The pesticides currently in use are not that effective; and due to their prolonged indiscriminate and non-judicious use, some pests have developed resistance to such commonly used pesticides. Their use is thereby becoming increasingly difficult.

Therefore, there is an urgent need to develop new methods and formulations for controlling these harmful pests. Therefore, there is a need to provide a pesticidal composition which overcomes some of the existing problems and can be prepared easily without much complex manufacturing process. The present inventors have surprisingly developed an effective pesticidal combination which ameliorates the aforesaid shortcomings of the prior art.

### OBJECT OF THE INVENTION

The principal object of the present invention is to provide fluxametamide composition and process of preparation thereof.

Another object of the present invention is to provide fluxametamide composition comprising bioactive amounts of fluxametamide or its agrochemically acceptable salts thereof, one insecticide selected from diamide group, at least one or more compound selected from insecticides, fungicides, and/or plant health additives that demonstrates synergistic effect, and agrochemically acceptable excipients; and method of preparation thereof.

Another object of the present invention is to provide fluxametamide composition for controlling the harmful pests in plants.

Yet another object of the present invention is to provide fluxametamide composition demonstrating high efficacy and to provide complete protection to crop plants against insect-pests, mites, fungal and bacterial diseases.

Further object of the present invention is to provide fluxametamide composition for disease resistance management or to delay disease resistance development through engaging multiple modes of action.

Yet another object of the present invention is to provide fluxametamide composition which improves overall health, yield and vigor of the treated plant.

Yet another object of the present invention is to provide fluxametamide composition which increases plant tolerance against insect-pests, mites, and fungal and bacterial diseases and abiotic stress.

Further object of the present invention is to provide a method of preparing a stable and non-phytotoxic formulation.

Further object of the present invention is to provide fluxametamide composition which can be easily formulated.

Further object of the present invention is to provide fluxametamide composition which is environmentally safe.

### SUMMARY OF THE INVENTION

The present invention provides a synergistic pesticidal composition comprising bioactive amounts of (A) fluxametamide or its agrochemically acceptable salts thereof; (B) an insecticide selected from class of diamides; (C) at least one or more compound selected from insecticides, fungicides and plant health additives; and agrochemically acceptable excipients.

The formulation for the pesticidal composition is selected from Capsule suspension (CS), Dispersible concentrate (DC), Emulsifiable concentrate (EC), Emulsion, water in oil (EO), Emulsion, oil in water (EW), Jambo balls or bags (bags in water soluble pouch), Micro-emulsion (ME), Oil dispersion (OD), Oil miscible flowable concentrate (oil miscible suspension (OF), Oil miscible liquid (OL), Suspension concentrate (SC), Suspo-emulsion (SE), Soluble concentrate (SL), Water dispersible granule (WG or WDG), Water soluble granule (SG), Water soluble powder (SP), Wettable powder (WP), A mixed formulation of CS and SC (ZC), A mixed formulation of CS and SE (ZE), a mixed formulation of CS and EW (ZW), Granule (GR)/Soil Applied Granules (SAG), and Controlled release granules (CR).

The present composition is in the form of oil dispersion (OD), suspension concentrate (SC), suspo-emulsion (SE), water dispersible granule (WG or WDG) and a mixed formulation of capsule suspension CS and SC (ZC).

The present invention can be formulated and is environmentally safe and is used for controlling harmful pests in plants, and demonstrates high efficacy, and acts for disease resistance management or to delay disease resistance development through engaging multiple modes of action, and increases plant tolerance against insect-pests and mites, and fungal and bacterial diseases, abiotic stress and improves overall health and vigor of the treated plant.

### DETAILED DESCRIPTION OF THE INVENTION

Before explaining the present invention in detail, it is to be understood that the invention is not limited in its application to the details of the parts illustrated. The invention is capable of other embodiments, as described above and of being practiced or carried out in a variety of ways. It is to be understood that the phraseology and terminology employed herein is for the purpose of description and not to limitation. The invention may have various embodiments and they may be performed as described in the following pages of the complete specification.

The terms and words used in the following description are not limited to the bibliographical meanings, but, are merely used by the inventors to enable a clear and consistent understanding of the invention. Accordingly, it should be apparent to those skilled in the art that the following description of exemplary embodiments of the present invention are provided for illustration purpose only and not for the purpose of limiting the scope of the invention.

It is to be understood that the singular forms “a,” “an,” and “the” include plural reference unless the context clearly dictates otherwise.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, steps or components but does not preclude the presence or addition of one or more other features, steps, components or groups thereof.

The term ‘plants’ as used herein, refers to all physical parts of a plant, including seeds, seedlings, saplings, roots, tubers, stems, stalks, foliage and fruits. The term “plant” is to be understood as including wild type plants and plants, which have been modified by either conventional breeding, or mutagenesis or genetic engineering, or by a combination thereof.

The term “crop” refers to both, growing and harvested crops.

The term “insects” as used herein, includes all organisms in the class “Insecta.”

The term “animal pest” includes arthropods, gastropods, and nematodes. Preferred animal pests according to the invention are arthropods, preferably insects and arachnids, in particular insects. Insects, which are of particular relevance for crops, are typically referred to as crop insect pests.

The term “pesticidal” as used herein, refers to the ability of a pesticide to increase mortality or inhibit growth rate of pests.

To “control” or “controlling” pests means to inhibit, through a toxic effect, the ability of pests to survive, grow, feed, and/or reproduce, or to limit pest related damage or loss in crop plants. To “control” pests may or may not mean killing the pests, although it preferably means killing the pests.

The term “health of a plant” or “plant health” is defined as a condition of the plant and/or its products. As a result of the improved health, yield, plant vigor, quality and tolerance to abiotic or biotic stress are increased.

“Yield” is to be understood as any plant product of economic value that is produced by the plant such as grains, fruits in the proper sense, vegetables, nuts, grains, seeds, wood (e.g. in the case of silviculture plants) or even flowers (e.g. in the case of gardening plants, ornamentals).

“Increased yield” of a plant, in particular of an agricultural, silvicultural and/or horticultural plant means that the yield of a product of the respective plant is increased by a measurable amount over the yield of the same product of the plant produced under the same conditions, but without the application of the composition according to the invention.

The present invention provides a synergistic pesticidal composition comprising
1. Compound A—fluxametamide or its agrochemically acceptable salts thereof,
2. Compound B—one insecticide selected from diamide group,
3. Compound C—at least one or more compound selected from insecticides, fungicides and/or plant health additives,
with the following mass percentage of the composition:

| Sr. No. | Ingredient | Concentration range (w/w %) |
|---|---|---|
| 1. | Compound A | 1 to 20 |
| 2. | Compound B | 1 to 20 |
| 3. | Compound C | 0.001 to 60 |

Fluxametamide, 4-((5RS)-5-(3,5-dichlorophenyl)-4,5-dihydro-5-(trifluoromethyl) isoxazol-3-yl)-N-((EZ)-(methoxyimino)methyl)-o-toluamide is a novel wide-spectrum insecticide that was discovered and synthesized by Nissan Chemical Industries, Ltd. It belongs to a class of compounds called isoxazolines, which are potent inhibitors of γ-aminobutyric acid (GABA)-, glutamate-, and glycine-gated chloride channels in insects.

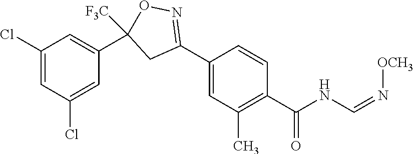 [SMILES: CO/N=C\NC(=O)c1ccc(C2=NOC(c3cc(Cl)cc(Cl)c3)(C(F)(F)F)C2)cc1C]

Fluxametamide is a wide-spectrum isoxazoline insecticide effective against a broad spectrum of pests. It is mainly used in the control of lepidopteran pests, thrips, whiteflies, leaf miners, beetles and mites on crops such as fruit trees, vegetables, soybeans, cotton and tea trees and other crops.

Compound B includes insecticides from the diamides group selected from chlorantraniliprole, cyantraniliprole, cyclaniliprole, tetraniliprole, tetrachlorantraniliprole, tyclopyrazoflor, cyhalodiamide, flubendiamide, fluchlordiniliprole and tiorantraniliprole.

More particularly, compound B is selected from the group consisting of chlorantraniliprole cyantraniliprole, tetraniliprole and flubendiamide.

Insecticide(s) for compound C from the class of carbamates (AChE-acetylcholine esterase inhibitors) is selected from carbaryl, carbofuran, carbosulfan, methomyl, oxamyl, pirimicarb, and thiodicarb; from the class of organophosphates (AChE-acetylcholine esterase inhibitors) is selected from acephate, cadusafos, chlorpyrifos, chlorpyrifos-methyl, demeton-S-methyl, dimethoate, ethion, fenamiphos, fenitrothion, fenthion, fosthiazate, methamidophos, monocrotophos, oxydemeton-methyl, parathion, parathion-methyl, phenthoate, phorate, phosalone, phosphamidon, profenofos, quinalphos, and triazophos; from the class of phenylpyrazoles-fiproles (GABA-gated chloride channel blockers) is selected from ethiprole, fipronil, flufiprole, nicofluprole, pyrafluprole, and pyriprole; from the class of pyrethroids (sodium channel modulators) is selected from bifenthrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, fenpropathrin, fenvalerate, tau-fluvalinate, permethrin, phenothrin, prallethrin, profluthrin, and pyrethrin (pyrethrum); from the class of nicotinic insecticides (nicotinic acteylcholine receptor (nAChR) competitive modulators) is selected from acetamiprid, clothianidin, dinotefuran, imidacloprid, nitenpyram, thiacloprid, thiamethoxam, flupyrimin, cycloxaprid, paichongding, guadipyr, cycloxylidin; sulfoximines-sulfoxaflor; butenolides-flupyradifurone; mesoionics-triflumezopyrim, dichloromezotiaz, and fenmezoditiaz; from the class of nereistoxin analogues (nicotinic acetylcholine receptor (nAChR) channel blockers) is selected from bensultap, monosultap, cartap hydrochloride, thiocyclam, thiocyclam hydrogen oxalate, thiocyclam hydrochloride, and thiosultap sodium; from the class of spinosyns (nicotinic acteylcholine receptor (nAChR) allosteric modulators-Site I) is selected from spinosad, and spinetoram; from the class of avermectins and milbemycins (glutamate-gated chloride channel (GluCl) allosteric modulators) is selected from avermectins-abamectin, emamectin benzoate, ivermectin, lepimectin; and milbemycins-milbemectin; from the class of juvenile hormone mimics is selected from hydroprene, kinoprene, methoprene, fenoxycarb, and pyriproxyfen; from the class of non-specific multi-site inhibitors is selected from chloropicrin, dazomet, and metam; from the class of chordotonal organs modulators is selected from pymetrozine, pyrifluquinazon, afidopyropen, and flonicamid; from the class of mite growth inhibitors affecting CHS1 is selected from clofentezine, hexythiazox, diflovidazin or etoxazole; from the class of benzoylureas (inhibitors of the chitin biosynthesis affecting CHS1 is selected from bistrifluron, chlorfluazuron, diflubenzuron, flucycloxuron, flufenoxuron, hexaflumuron, lufenuron, novaluron, noviflumuron, teflubenzuron, and triflumuron; from the class of buprofezin (inhibitors of the chitin biosynthesis type 1) is selected from buprofezin; from the class of cyromazine (moulting disruptors for dipteran) is selected from cyromazine; from the class of microbial disruptors of insect midgut membrane is selected from Bacillus thuringiensis and insecticidal proteins they produce; from the class of uncouplers of oxidative phosphorylation is selected from chlorfenapyr, DNOC, or sulfluramid; from the class of diacylhydrazines (ecdyson receptor agonists) is selected from diacylhydrazines-methoxyfenozide, tebufenozide, halofenozide, fufenozide or chromafenozide; from the class of octopamin receptor agonists is selected from amitraz; from the class of inhibitors of mitochondrial ATP synthase is selected from diafenthiuron, azocyclotin, cyhexatin, fenbutatin oxide, propargite, or tetradifon; from the class of METI (mitochondrial complex I) inhibitors is selected from fenazaquin, fenpyroximate, pyrimidifen, pyridaben, tebufenpyrad, tolfenpyrad, flufenerim, rotenone, fluacrypyrim, and pyriminostrobin; from the class of METI (mitochondrial complex II) inhibitors is selected from cyenopyrafen, cyflumetofen, and pyflubumide; from the class of METI (mitochondrial complex III) inhibitors is selected from hydramethylnon, acequinocyl, fluacrypyrim, bifenazate, and flometoquin; from the class of METI (mitochondrial complex IV) inhibitors is selected from phosphides and cyanides; from the class of voltage-dependent sodium channel blockers is selected from indoxacarb, and metaflumizone; from the class of inhibitors of the lipid synthesis, inhibitors of acetyl CoA carboxylase is selected from spirodiclofen, spiromesifen, spirotetramat, spidoxamat, spiropidion or spirobudifen; from the class of baculoviruses is selected from granuloviruses and nucleopolyhedrosis viruses; from the class of calcium activated potassium channel (KCa₂) modulators is selected from acynonapyr; compounds of unknown or uncertain mode of action is selected azadirachtin, benzoximate, bromopropylate, from benzpyrimoxan, chinomethionat, dicofol, pyridalyl, oxazosulfyl, dimpropyridaz, indazapyroxamet, acaricidal compounds-fluhexafon, cyetpyrafen, flupentiofenox, acyonapyr, trifluenfuronate, cyclobutrifluram, fluazaindolizine, tioxazafen and trifluenfuronate.

More particularly, insecticides for compound C is selected from the group consisting of abamectin, emamectin benzoate, tolfenpyrad, pyrifluquinazon, lambda cyhalothrin, fipronil, fenpyroximate, hexythiazox, etoxazole, diafenthiuron, methoxyfenozide, spinosad, indoxacarb, afidopyropen, flonicamid, pyriproxyfen, bifenthrin, deltamethrin, thiamethoxam and dinotefuran.

Fungicide(s) for compound C from the group of nucleic acid synthesis inhibitors is selected from benalaxyl, benalaxyl-M, furalaxyl, metalaxyl, metalaxyl-M, ofurace, oxadixyl, bupirimate, dimethirimol, ethirimol, octhilinone, hymexazole, oxolinic acid, 5-fluorocytosine, 4-amine, and 5-fluoro-2-(4-fluorophenylmethoxy)pyrimidin-4-amine; from the group of cytoskeleton and motor proteins/cell division inhibitors is selected from benomyl, carbendazim, fuberidazole, thiabendazole, thiophanate, thiophanate-methyl, diethofencarb, zoxamide, ethaboxam, pencycuron, fluopicolide, flufenoxadiazam, fluopimomide, phenamacril, metrafenone, and pyriofenone; from the group of SDHI (Succinate dehydrogenase inhibitors) is selected from benodanil, flutolanil, mepronil, isofetamid, fluopyram, fenfuram, carboxin, oxycarboxin, thifluzamide, benzovindiflupyr, bixafen, fluindapyr, fluxapyroxad, furametpyr, isopyrazam, penflufen, penthiopyrad, sedaxane, flubeneteram, pyrapropoyne, inpyrfluxam, isoflucypram, pydiflumetofen, boscalid, and pyraziflumid; from the group of QoI-fungicides (Quinone outside Inhibitors) is selected from pyribencarb, fluoxastrobin, fenamidone, mandestrobin, azoxystrobin, coumoxystrobin, enoxastrobin, flufenoxystrobin, picoxystrobin, pyraoxystrobin, pyraclostrobin, pyrametostrobin, triclopyricarb, famoxadone, dimoxystrobin, fenamistrobin, metominostrobin, orysastrobin, kresoxim methyl, and trifloxystrobin; from the group of QiI-fungicides (Quinone inside Inhibitors) is selected from cyazofamid, amisulbrom, fenpicoxamid, florylpicoxamid, metarylpicoxamid, and metyltetraprole; from the group of uncouplers of oxidative phosphorylation is selected from binapacryl, meptyldinocap, dinocap, and fluazinam; from the group of inhibitors of oxidative phosphorylation and ATP synthase is selected from fentin acetate, fentin chloride, and fentin hydroxide; from the group of inhibitors of ATP transport is selected from silthiofam; Quinone outside Inhibitors, stigmatellin binding type (QoSI) is selected from ametoctradin; from the group of amino acids and protein synthesis inhibitors is selected from cyprodinil, mepanipyrim, pyrimethanil, blasticidin-S, kasugamycin, streptomycin, and oxytetracycline; from the group of signal transduction inhibitors is selected from quinoxyfen, proquinazid, fenpiclonil, fludioxonil, chlozolinate, dimethachlone, iprodione, procymidone, and vinclozolin; from the group of lipid or transport and membrane synthesis inhibitors is selected from isoprothiolane, edifenphos, iprobenfos (IBP), pyrazophos, biphenyl, chloroneb, dicloran, quintozene, tecnazene, tolcofos methyl, etridiazole, iodocarb, propamocarb, prothiocarb, extract from Melaleuca arternifolia (tea tree), plant oils (mixtures), eugenol, geraniol, thymol, natamycin (pimaricin), oxathiapipronil, fluoxapipronil, and fluoxapiprolin-s; from the group of sterol biosynthesis inhibitors is selected from imazalil, oxpoconazole, pefurazoate, procloraz, triflumizole, piperazines-triforine, pyridines-pyrifenox, pyrisoxazole, pyrimidines-fenarimo, naurimol, triazoles-azaconazole, bitertanol, bromuconazole, cyproconazole, difenoconazole, diniconazole, epoxiconazole, etaconazole, fenbuconazole, fluquinconazole, flusilazole, frutriafol, hexaconazole, imibenconazole, ipconazole, mefentrifluconazole, metconazole, myclobutanil, penconazole, propiconazole, prothioconazole, simconazole, tebuconazole, tetraconazole, tiradimefon, tiradimenol, triticonazole, fluoxytioconazole, aldimoprh, dedomorph, tridemorph, fenpropimorph, piperalin, spiroxamine, fenpyrazamine, fenhexamid, naftifine, terbinafine, and pyributicarb; from the group of cell wall biosynthesis inhibitors is selected from polyoxin, dimethomorph, flumorph, pyrimorph, mandipropamid, benthiavalicard, iprovalicarb, and alifenalate; from the group of melanin synthesis in cell wall inhibitors is selected from fthalide, pyroquilon, tricyclazole, diclycymet, carpropamid, fenoxanil, and tolprocarb; from the group of plant defence inducers is selected from acibenzolar-S-methyl, probenazole, tiadinil, isotianil, laminarin, extract from Reynoutria sachalinensis (giant knowweed), bacterial Bacillus-Bacillus mycoides isolate J, cell wall of Saccharomyces cerevisiae strain LAS117, fosetyl-AL, and phosphoric acid and salts; from the group of unknown mode of action is selected from cymoxanil, teclofthalam, triazoxide, fluslfamide, diclomezine, cyflufenamid, dodine, flutianil, ferimzone, tebufloquin, picarbutrazox, and validamycin; from the group of not classified (N) is selected from mineral oils, inorganic oils, organic oils, potassium bicarbonates, and materials of biological origin; from the group of chemicals with multisite contact activities is selected from copper (copper hydroxide, copper oxychloride, copper (II) sulphate, bordeaux mixture, copper salicylate, cuprous oxide), sulphur, ferbam, mancozeb, maneb, metiram, propineb, thiram, zinc thiazole, zineb, ziram, phthalimides-captan, captafol, folpet, chlorothalonil, dichlofluanid, guazatine, iminoctadine, anilazine, dithianon, chinomethionat/quinomethionate, fluoroimide, and methasulfocarb; from the group of biologicals with multiple modes of action (BM) is selected from extract from the cotyledons of lupine plantlets (“BLAD”), plant extract-phenols, sesquiterpenes, triterpenoids, coumarins, microbial (living microbes or extract metabolites-Trichoderma atroviride strain SC1, Trichoderma atroviride strain I-1237, Trichoderma atroviride strain LU132, Trichoderma asperellum strain T34, Gliocladium catenulatum strain J1446, Clonostachys rosea strain CR-7, Bacillus amyloliquefaciens strain QST713, strain FZB24, strain MBI600, strain D747, strain F727, Bacillus subtilis strain AFS032321, Pseudomonas chlororaphis strain AFS009, Streptomyces griseovirides strain K61, Streptomyces lydicus strain WYEC108, and Polyoxin D zinc salt; from the group of others is selected from ipflufenoquin, pyridachlometyl, quinofumelin, dichlobentiazox, aminopyrifen, dipymetitrone, seboctylamine (bactericide), and chloroinconazide (virucide).

More particularly, the fungicide for Compound C is selected from the group consisting of pyraclostrobin, fluxapyroxad, azoxystrobin and difenoconazole.

Plant health additive(s) for compound C from the group of bio stimulants is selected from humic acid and salt, fulvic acid and salt, amino acid (alanine, arginine, aspartic acid, cysteine, glutamic acid, glycine, histidine, isoleucine, leucine, lysine, methionine, phenylalanine, proline, serine, threonine, tryptophan, tyrosine, valine or mixture thereof), protein hydrolysates, carboxylic acid, jasmonic acid, methyl jasmonate, chitosan, chitin, alginate, cyclodextrin, probenazole, acibenzolar-s-methyl, laminarin, seaweed extract (Ascophyllum nodosum), polyamines, silicic acid and salt-orthosilicic acid (H₄SiO₄), salicylic acid, lactic acid, phenyl lactic acid, fumaric acid, nitrobenzene, stigmasterol, campesterol, brassinolide (homo), forchlorfenuron, triacontanol, nitrophenolate (sodium para-nitrophenolate, ortho-nitrophenolate, sodium-5-nitroguaiacolate or mixture thereof; from the group of plant growth promoter/regulators is selected from limanarin, indole acetic acid, indole butyric acid, alpha-naphthyl acetic acid, kinetin, zeatin, 6-benzylaminopurine, 6-benzyladenine, dipheylurea, thidiazuron, anisiflupurin, aviglycine, prohexadione, prohexadione calcium, trinexapac, trinexapac-ethyl, aminoethoxyvinylglycine (AVG), gibberelline, gibberellic acid, GA₃, abscisic acid, chlorpropham, flumetralin, maleic hydrazide, mepiquat, mepiquat chloride, mepiquat pentaborate, chlormequat, chlormequat chloride, paclobutrazol, uniconazole-P or mixture thereof; from the group of micronutrients is selected from zinc (zinc sulphate heptahydrate, zinc sulphate mono hydrate, Zn-EDTA, zinc oxide, zinc lactate gluconate, zinc polyflavonoid), ferrous sulphate, copper sulphate, Manganese sulphate, boron (borax-sodium tetraborate, boric acid (H₃BO₃), di-sodium octa borate tetra hydrate (Na₂B₈O₁₃·4H₂O), di-sodium tetra borate pentahydrate, anhydrous borax, mepiquate chloride and sulphur (elemental sulphur, bentonite sulphur, boronated sulphur or a sulphate and thiosulphate salt) or mixture thereof.

More particularly, the plant heath additive for compound C is selected from the group consisting of zinc oxide, campesterol, Ascophyllum nodosum, salicylic acid, ortho silicic acid, limanarin, amino acid, fulvic acid, humic acid, gibberellic acid, mepiquate chloride, paclobutrazol and stigmasterol. The amino acid uses for compound C is glycine.

The present invention further optionally comprises agrochemically acceptable excipients including, but not limited to, dispersing agents, anti-freezing agent, anti-foam agent, wetting agents, suspension aid and carriers, anti-microbial agent, thickener, colorants, quick coating agent or sticking agents (also referred to as “stickers” or “binders”), polymers, disintegrating agent, oil additive, buffering agent, and solvents.

Surfactants that are used as dispersants have the ability to adsorb strongly onto a particle surface and provide a charged or steric barrier to re-aggregation of particles. The most commonly used surfactants are anionic, non-ionic, or mixtures of the two types. For wettable powder formulations, the most common dispersants are sodium lignosulphonates. For suspension concentrates, very good adsorption and stabilization are obtained using polyelectrolytes, such as sodium naphthalene sulphonate formaldehyde condensates. Tristyryl phenol ethoxylate phosphate esters are also used. Nonionics such as alkyl aryl ethylene oxide condensates and EO-PO block copolymers are sometimes combined with anionics as dispersants for suspension concentrates. In recent years, new types of very high molecular weight polymeric surfactants have been developed as dispersants. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. The dispersants used herein include but not limited to sodium lignosulphonates; sodium naphthalene sulphonate formaldehyde condensates; tristyryl phenol ethoxylate phosphate esters; aliphatic alcohol ethoxylates; alkyl ethoxylates; EO-PO block copolymers; and graft copolymers or mixtures thereof.

Anti-freezing agent as used herein can be selected from the group consisting of polyethylene glycols, methoxy polyethylene glycols, polypropylene glycols, polybutylene glycols, glycerin and ethylene glycol.

Water-based formulations often cause foam during mixing operations in production. In order to reduce the tendency to foam, anti-foam agents are often added either during the production stage or before filling into bottles. Generally, there are two types of anti-foam agents, namely silicones and non-silicones. Silicones are usually aqueous emulsions of dimethyl polysiloxane while the non-silicone anti-foam agents are water-insoluble oils, such as octanol and nonanol, or silica. In both cases, the function of the anti-foam agent is to displace the surfactant from the air-water interface.

The wetting agents used in wettable powder, suspension concentrate, and water-dispersible granule formulations include but not limited to sodium lauryl sulphate; sodium dioctyl sulpho-succinate; alkyl phenol ethoxylates; and aliphatic alcohol ethoxylates or mixtures thereof.

Suspension aid denotes a natural or synthetic, organic or inorganic material with which the active substance is combined in order to facilitate its application to the plant, to the seeds or to the soil. It is generally inert, and it must be agriculturally acceptable, in particular to the plant being treated. The carrier may be solid and is selected from, but not limited to diatomaceous earth, attapulgite or zeolites, dolomite, silica, fly ash, hydrated lime, wheat flour, wood flour, ground wheat straw, cellulose and soy flour, bentonite, kaolin, calcium carbonate, talc, muscovite mica, fused sodium potassium, aluminum silicate, perlite, urea, sulfur-coated urea, isobutylidene diurea, ammonium nitrate, ammonium sulfate, ammonium phosphate, triple super phosphate, phosphoric acid, potassium sulfate, potassium nitrate, potassium metaphosphate, potassium chloride, dipotassium carbonate, potassium oxide and a combination of these; or liquid and is selected from, but not limited to water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2 dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropyl benzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylene sulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2pyrrolidone and the like.

Biocides/Microorganisms cause spoilage of formulated products. Therefore, anti-microbial agents are used to eliminate or reduce their effect. Such agents include, but not limited to, propionic acid and its sodium salt; sorbic acid and its sodium or potassium salts; benzoic acid and its sodium salt; p-hydroxy benzoic acid sodium salt; methyl p-hydroxy benzoate; and biocide such as sodium benzoate, 1,2-benzisothiazoline-3-one, 2-methyl-4-isothiazolin-3-one, 5-chloro-2-methyl-4-isothiazolin-3-one, potassium sorbate, parahydroxy benzoates or mixtures thereof.

Thickening, gelling, and anti-settling agents generally fall into two categories, namely water-insoluble particulates and water-soluble polymers. It is possible to produce suspension concentrate formulations using clays and silicas, for example, but not limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose or mixtures thereof, for example, but not limited to, guar gum, locust bean gum, carrageenan, xanthan gum, alginates, methyl cellulose, sodium carboxymethyl cellulose (SCMC), hydroxyethyl cellulose (HEC) or mixtures thereof. Other types of anti-settling agents are based on modified starches, polyacrylates, polyvinyl alcohol and polyethylene oxide or mixtures.

Suitable colorant is selected from crystal violet, thalocyano dye chlorinated, aerosol green FFB dye, rodamine, azocompound, iron oxide, titan oxide, iron hexacyanoferrate, alizarin- and phthalocyanine colorants.

The quick coating agent can be a conventionally available sticker, for example polyesters, polyamides, poly-carbonates, polyurea and polyurethanes, acrylate polymers and copolymers, styrene copolymers, butadiene copolymers, polysaccharides such as starch and cellulose derivatives, vinylalcohol, vinylacetate and vinylpyrrolidone polymers and copolymers, polyethers, epoxy, phenolic and melamine resins, polyolefins and define copolymers and mixtures thereof. Polymers are selected from acrylate polymers such as poly(methacrylate), poly(ethyl methacrylate), poly(methylmethacrylate), acrylate copoylmers and styrene-acrylic copolymers, poly(styrene-co maleic anhydride), cellulosic polymers such as ethyl cellulose, cellulose acetate, cellulose acetatebutyrate, acetylated mono, di, and triglycerides, poly(vinylpyrrolidone), vinyl acetate polymers and copolymers, poly(alkylene glycol), styrene butadiene copolymers, poly(orthoesters), alkyd resins, and mixtures of two or more of these. Polymers that are biodegradable are also useful in the present invention. As used herein, a polymer is biodegradable if is not water soluble, but is degraded over a period of several weeks when placed in an application environment. Biodegradable polymers are selected from biodegradable polyesters, starch, polylactic acid starch blends, polylactic acid, poly(lactic acid-glycolic acid) copolymers, polydioxanone, cellulose esters, ethyl cellulose, cellulose acetate butyrate, starch esters, starch ester aliphatic polyester blends, modified corn starch, polycaprolactone, poly(namylmethacrylate), wood resin, polyanhydrides, polyvinylalcohol, polyhydroxybutyratevalerate, biodegradable aliphatic polyesters, and polyhydroxybutyrate or mixtures thereof.

Polymers that are biodegradable are also useful in the present invention. As used herein, a polymer is biodegradable if is not water soluble, but is degraded over a period of several weeks when placed in an application environment. Biodegradable polymers are selected from starch, polylactic acid starch blends, polylactic acid, poly(lactic acid-glycolic acid) copolymers, polydioxanone, cellulose esters, ethyl cellulose, cellulose acetate butyrate, starch esters, starch ester aliphatic polyester blends, modified corn starch, poly caprolactone, poly(namylmethacrylate), wood rosin, polyanhydrides, poly vinyl alcohol, poly hydroxyl butyrate valerate, biodegradable aliphatic polyesters, and poly hydroxyl butyrate or mixtures thereof.

Disintegrating agent is selected from, but not limited to citric acid, succinic acid or sodium bicarbonate.

Oil additive is selected from an oil of vegetable origin, for example rapeseed oil, olive oil or sunflower oil, emulsified vegetable oil, or animal origin, such as fish oil or beef tallow; alkyl esters of C₈-C₂₂ fatty acids, such as the methyl derivatives of C₁₂-C₁₈ fatty acids, for example the methyl esters of lauric acid, palmitic acid and oleic acid (methyl laurate, methyl palmitate and methyl oleate, respectively).

Buffering agent as used herein is selected from group consisting of calcium hydroxyapatite, Potassium Dihydrogen Phosphate, Sodium Hydroxide, carbonated apatite, calcium carbonate, sodium bicarbonate, tri-calcium phosphate, calcium phosphates, carbonated calcium phosphates, amine monomers, lactate dehydrogenase and magnesium hydroxide.

The solvent for the formulation of the present invention is selected from, but not limited to, water, water-soluble alcohols and dihydroxy alcohol ethers. The water-soluble alcohol which can be used in the present invention is selected from lower alcohols or water soluble macromolecular alcohols. The term “lower alcohol”, as used herein, represents an alcohol having 1-4 carbon atoms, such as methanol, ethanol, n-propanol, isopropanol, n-butanol, tert-butanol. Macromolecular alcohol is not limited, as long as it may be dissolved in water in a suitable amount range, e.g., polyethylene glycol, sorbitol, glucitol. Suitable dihydroxyalcohol ethers used in the present invention is selected from dihydroxy alcohol alkyl ethers or dihydroxy alcohol aryl ethers. Dihydroxy alcohol alkyl ether includes ethylene glycol methyl ether, diethylene glycol methyl ether, propylene glycol methyl ether, dipropylene glycol methyl ether, ethylene glycol ethyl ether, diethylene glycol ethyl ether, propylene glycol ethyl ether, dipropylene glycol ethyl ether. Dihydroxy alcohol arylethers include ethylene glycol phenyl ether, diethylene glycol phenyl ether, propylene glycol phenyl ether, dipropylene glycol phenyl ether, and the like. Any of the above mentioned solvent can be used either alone or in combination thereof.

However, those skilled in the art will appreciate that it is possible to utilize additional agrochemically acceptable excipients without departing from the scope of the present invention. The agrochemically acceptable excipient can be in the range from 0.1% to 99% of the total weight of the composition.

The amount of a composition according to the invention to be applied, will depend on various factors, such as the subject of the treatment, such as, for example plants, soil or seeds; the type of treatment, such as, for example spraying, dusting or seed dressing; the purpose of the treatment, such as, for example prophylactic or therapeutic disease control; in case of disease control the type of fungi to be controlled or the application time. This amount of the combinations of the present invention to be applied can be readily deduced by a skilled agronomist.

The combination of the present invention is formulated in a manner which suits the specific application. The formulation is selected from Capsule suspension (CS), Dispersible concentrate (DC), Emulsifiable concentrate (EC), Emulsion, water in oil (EO), Emulsion, oil in water (EW), Jambo balls or bags (bags in water soluble pouch), Micro-emulsion (ME), Oil dispersion (OD), Oil miscible flowable concentrate (oil miscible suspension (OF), Oil miscible liquid (OL), Suspension concentrate (SC), Suspo-emulsion (SE), Soluble concentrate (SL), Water dispersible granule (WG or WDG), Water soluble granule (SG), Water soluble powder (SP), Wettable powder (WP), A mixed formulation of CS and SC (ZC), A mixed formulation of CS and SE (ZE), a mixed formulation of CS and EW (ZW), Granule (GR)/Soil Applied Granules (SAG), Controlled release granules (CR).

More particularly, the formulation is selected from oil dispersion (OD), suspension concentrate (SC), a mixed formulation of capsule suspension CS and SC (ZC), suspo-emulsion (SE) and water dispersible granule (WG or WDG).

The inactive excipients used in various formulations are as follows:

### A. Lists of Inactive Excipient Used in the Oil Dispersion (OD) Formulation:

The wetting agent for oil dispersion (OD) is selected from the group consisting of ethylene oxide/propylene oxide block copolymer, polyarylphenyl ether phosphate, ethoxylated fatty alcohol, sodium dioctyl sulfosuccinate, sodium lauryl sulfate and sodium dodecyl benzene sulfonate, alkyldiphenyl sulfonates, sodium isopropyl naphthalene sulfonate, alkylnaphthalene sulfonate or mixture thereof.

The wetting-spreading-penetrating agent for oil dispersion (OD) is selected from the group consisting of organosilicone surfactants; trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, polyalkyleneoxide modified heptamethyl trisiloxane, polyether modified polysiloxane, may or may not be in modified form, may be liquid or powder form or mixture thereof.

The emulsifying agent for oil dispersion (OD) is selected from the group consisting of castor oil ethoxylates, alcohol ethoxylates, fatty acid ethoxylates, sorbitan ester ethoxylates, sulphosuccinate, calcium salts of dodecylbenzene sulphonate, alkylammonium salts of alkylbenzene sulphonate, alkylsulphosuccinate salts, ethylene oxide-propylene oxide block copolymers, ethoxylated alkylamines, ethoxylated alkyl phenols, polyoxyethylene sorbitan monolaurate or mixture thereof.

The dispersing agent for oil dispersion (OD) is selected from the group consisting of alkyl sulfonates, alkyl benzene sulfonates, alkyl aryl sulfonates, alkylphenolalkoxylates, tristyrylphenol ethoxylates, natural or synthetic fatty ethoxylate alcohols, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers), fatty acid-polyalkylene glycol condensates, polyamine-fatty acid condensates, polyester condensates, salts of polyolefin condensates, sodium ligno sulfonate, sodium ploycarboxylate, EO/PO based copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide or mixture thereof.

The stabilizers for oil dispersion (OD) are selected from the group consisting of hectorite clay, aluminium magnesium silicate, bentonite clay, silica, attapulgite clay or mixture thereof.

The antifoaming agent for oil dispersion (OD) is selected from the group consisting of silicone oil, silicone compound, C₁₀˜C₂₀ saturated fat acid compounds or C₈˜C₁₀ aliphatic alcohols compound, silicone antifoam emulsion, dimethylsiloxane, polydimethyl siloxane, vegetable oil based antifoam, tallow based fatty acids, polyalkyleneoxide modified polydimethylsiloxane or mixture thereof.

The anti-freezing agent for oil dispersion (OD) is selected from the group consisting of ethylene glycol, propane diols, glycerine or the urea, glycol (monoethylene glycol, diethylene glycol, polypropylene glycol, polyethylene glycol), glycerine, urea, magnesium sulfate heptahydrate, sodium chloride; preservative-1,2-benzisothiazolin-3 (2H)-one, sodium salt, sodium benzoate, 2-bromo-2-nitropropane-1,3-diol, formaldehyde, sodium o-phenylphenate, 5-chloro-2-methyl-4-isothiazolin-3-one and 2-methyl-4-isothiazolin-3-one or mixture thereof.

The solvent for oil dispersion (OD) is selected from the group consisting of as solvent for the present formulation is selected from and not limited to vegetable oil (plant, seed or tree) or it's alkylated or ethoxylated or esterified. The alkylated vegetable oil may be methylated vegetable oil or ethylated vegetable oil. The vegetable oils include olive oil, kapok oil, castor oil, papaya oil, camellia oil, sesame oil, corn oil, rice bran oil, cotton seed oil, soybean oil, groundnut oil, rapeseed-mustard oil, linseed oil, tung oil, sunflower oil, safflower oil, coconut oil. The alkyl ester of vegetable oils; methyl ester, ethyl ester, propyl ester or butyl ester of vegetable oils. Some of the examples are methylated seed oil, polyalkyleneoxide modified polydimethylsiloxane alkylphenol ethoxylate, rapeseed oil methyl ester, rapeseed oil ethyl ester, rapeseed oil propyl esters, rapeseed oil butyl esters, soybean oil methyl ester, soybean oil ethyl ester, soybean oil propyl ester, soybean oil butyl ester, castor oil methyl ester, castor oil ethyl ester, castor oil propyl ester, castor oil butyl ester, cotton seed oil methyl ester, cotton seed oil ethyl ester, cotton seed oil butyl ester, cotton seed oil propyl ester, tall oil fatty acids esters-tallow methyl ester, tallow ethyl ester, tallow propyl ester, bio-diesel, mineral oil (aromatic solvents, isoparaffin, base solvent), fatty acid amides (e.g. C₁-C₃ amines, alkylamines or alkanolamines with C₆-C₁₈ carboxylic acids), fatty acids, alkyl esters of fatty acids, methyl and ethyl oleate, methyl and ethyl soyate, alkyl benzenes and alkylnaphthalenes, polyalkylene glycol ethers, fatty acid diesters, fatty alkylamides and diamides, dialkylene carbonates, ketones and alcohols. The above oil based carrier/diluting agents may be used as solo or mixture of two or more if desired or mixture thereof.

The cosolvent for oil dispersion (OD) is selected from the group consisting of cyclohexanone, acetophenone, NMP, dimethyl sulfoxide, benzyl alcohol, butanol, N-octanol, N-propanol, 2-ethyl hexanol, tetrahydro furfuryl alcohol, isophorone, fatty acid dimethyl amide, 2-hexylethyl lactate, propylene carbonate or mixture thereof.

More particularly, the present invention also refers to the method of manufacturing of oil dispersion formulation as describing the following steps:

It is to be understood that the below mentioned steps are applicable to all the manufacturing process:

Step 1: Assure the cleanliness of all the plant's equipment and acquire an approval from QC department prior the inintiation of the process.

Step 2: Ensure an electrical connection and standardize the weighing balance.

### Manufacturing Process for Oil Dispersion (OD) Formulation:

### Part A—Preparation of the Liquid Premix

Step 1: The vegetable oil or other solvent or both are charged into a vessel with anchor stirrer.

Step 2: The emulsifier(s) and dispersing agent(s) are added under stirring condition, until all the ingredients get completely dissolved.

### Part B—Preparation of the Slurry

Step 1: The liquid premix is charged into a second vessel which is equipped with a cooling and a heating device of a high shear stirrer.

Step 2: The active ingredients are added and homogenized thoroughly. The mixture is pre-milled and a particle size distribution is achieved by the final milling practised along with a bead mill as required by the specification.

### Part C—Preparation of the Thickener Gel.

Step-1: The vegetable/plant/seed oil or solvent is/are charged to the vessel which is equipped with a high shear stirrer.

Step 2: The thickener(s) is/are gradually added throughout by maintaining high-shear mixing and continuously stirring until mixed thoroughly.

Step 3: The thickener activating agent(s) is/are added while stirring. Further, the gel is allowed to get swell whilst maintaining the mixing.

### Part D—Preparation of the Final Formulation

Step 1: The thickener gel is added and the mixture is dispersed by applying a high shear stirrer.

Step 2: The wetting and spreading agent(s) or adjuvant(s) (silicone or non-silicone based) as mentioned previously are added in this formulation and dispersed by applying high shear stirrer.

Step 3: The final formulation is checked with specification.

Step 4: The material is packed in its required package sizes when approved.

### B. Lists of Inactive Excipient Used in the Suspension Concentrate (SC) Formulation:

The wetting agent for suspension concentrate (SC) is selected from the group consisting of ethylene oxide/propylene oxide block copolymer, polyarylphenyl ether phosphate, polyalkoxylated butyl ether, ethoxylated fatty alcohol, sodium dioctyl sulfosuccinate, sodium lauryl sulfate and sodium dodecyl benzene sulfonate, alkyl diphenyl sulfonates, sodium isopropyl naphthalene sulfonate, alkyl naphthalene sulfonate, organosilicons surfactants (as a wetting-spreading-penetrating agent); trisiloxane ethoxylate, polydimethylsiloxane, polyoxyethylene methyl polysiloxane, polyoxyalkylene methyl polysiloxane, polyether polymethyl siloxane, heptamethyl trisiloxane, modified form; polyalkyleneoxide modified heptamethyl trisiloxane, polyether modified polysiloxane, polyalkyleneoxide modified trisiloxane, polyalkyleneoxide modified polydimethylsiloxane, trisiloxane ethoxylate, polyoxyethylene methyl polysiloxane, polyether polymethyl siloxane copolymer, polyether modified polysiloxane; may or may not be in modified form, may be liquid or powder form or mixture thereof.

The dispersing agent for suspension concentrate (SC) is from the group consisting of naphthalenesulfonic acid, sodium salt condensated with formaldehyde, alkylated naphthalene sulfonate, sodium salt, sodium salt of naphthalene sulfonate condensate, sodium ligno sulfonate, sodium polycarboxylate, EO/PO based copolymer, phenol sulfonate, sodium methyl oleoyl taurate, styrene acrylic acid copolymer, propylene oxide-ethylene oxide-copolymer, polyethylene glycol 2,4,6-tristyrylphenyl ether, tristyrylphenol-polyglycol ether-phosphate, tristyrylphenole with 16 moles EO, tristyrylphenol-polyglycol ether-phosphate, oleyl-polyglycol ether with ethylene oxide, tallow fatty amine polyethylene oxide, nonylphenol polyglycol ether with 9-10 moles ethylene oxide or mixture thereof.

The suspending agent for suspension concentrate (SC) is selected from the group consisting of aluminum magnesium silicate, bentonite clay, silica, attapulgite clay or mixture thereof.

The antifoaming agent for suspension concentrate (SC) is selected from the group consisting of silicone oil, silicone compound, C₁₀˜C₂₀ saturated fat acid compounds or C₈˜C₁₀ aliphatic alcohols compound, silicone antifoam emulsion, dimethyl siloxane, polydimethyl siloxane, vegetable oil based antifoam, tallow based fatty acids, polyalkyleneoxide modified polydimethylsiloxane or mixture thereof.

The anti-freezing agent for suspension concentrate (SC) is selected from the group consisting of ethylene glycol, propane diols, glycerin or the urea, glycol (monoethylene glycol, diethylene glycol, polypropylene glycol, polyethylene glycol), glycerin, urea, magnesium sulfate heptahydrate, sodium chloride or mixture thereof.

The preservatives for suspension concentrate (SC) are selected from the group consisting of 1,2-benzisothiazolin-3 (2H)-one, sodium salt, sodium benzoate, 2-bromo-2-nitropropane-1,3-diol, formaldehyde, sodium o-phenyl phenate, 5-chloro-2-methyl-4-isothiazolin-3-one and 2-methyl-4-isothiazolin-3-one or mixture thereof.

The thickeners for suspension concentrate (SC) are selected from the group consisting of xanthan gum, PVK, carboxymethyl celluloses, polyvinyl alcohols, gelatin, sodium carboxymethylcellulose, hydroxyethyl cellulose, sodium polyacrylate, modified starch, acacia gum or mixture thereof.

The humectant for suspension concentrate (SC) is selected from the group consisting of urea, humic acid, glycerol, lactose or mixture thereof.

More particularly, the present invention also refers to the method of manufacturing of suspension concentrate formulation as describing the following steps:

### Manufacturing Process for Suspension Concentrate (SC) Formulation:

Step 1: Gel preparation: A required quantity of water is charged to a vessel which is equipped with a high shear stirrer whilst the agitation is initiated. Further, preservative(s) of a required quantity is/are added and mixed to form a homogenous mixture. The thickener(s) of a required amount is/are added and mixed vigorously to achieve wetness.

Step 2: A required quantity of water is charged to a vessel which is equipped with a bulk agitator and a high shear homogenizer. Initiate the agitation. Further, a required amount of anti freezing agent(s) is/are added and mixed to achieve uniformity. The antifoaming agent(s) is/are added and ensured that it is well dispersed. Moreover, the wetting and dispersing agent(s) are mixed to achieve uniformity whilst ensuring that the dispersing agent is fully dispersed.

Step 3: The active ingredients are added while agitating the vessel contents to achieve the dissolution of all components. The pre-mix is milled through sand or a bead mill to achieve the specified particle size.

Step 4: The remaining antifoaming agent(s) is/are added to this pre-milled formulation and mixed uniformly. A required amount of aqueous pre-gel and suspending agent(s) are added and the agitation is continued to achieve a target viscosity and a homogeneous formulation.

Step 5: The final product is submitted for QC approval.

Step 6: The material is packed in required package sizes when received approval.

### C. Lists of Inactive Excipient Used in the Suspo Emulsion (SE) Formulation:

The solvent for suspo emulsion (SE) is selected from the group consisting of water, water soluble alcohols and dihydroxy alcohol ethers. Water soluble alcohol or lower alcohol (1-4 carbon atoms); methanol, ethanol, n-propanol, isopropanol, n-butanol, tert-butanol. Macromolecular alcohol; polyethylene glycol, sorbitol, glucitol. Dihydroxy alcohol ethers include dihydroxy alcohol alkyl ether or dihydroxy alcohol aryl ethers. The examples of dihydroxy alcohol alkyl ether include ethylene glycol methyl ether, diethylene glycol methyl ether, propylene glycol methyl ether, di-propylene glycol methyl ether, ethylene glycol ethyl ether, diethylene glycol ethyl ether, propylene glycol ethyl ether, di-propylene glycol ethyl ether. The examples of dihydroxy alcohol aryl ethers include ethylene glycol phenyl ether, 5 diethylene glycol phenyl ether, propylene glycol phenyl ether, di-propylene glycol phenyl ether, and the like. Any of the mentioned solvent can be used either alone or in combinations thereof.

Hyrdocarbons include n-pentane, hexane(s), cyclohexane, methylcyclohexane, heptane, isooctane, benzene, toluene, xylene(s), isophorone and ester solvents such as methyloleate, dimethylamide and morpholineamide derivatives of C₆-C₁₆ fatty acids, and mono-alkylene carbonates such as ethylene carbonate, propylene carbonate and butylene carbonates, dimethylsulfoxide (DMSO), 2-ethylhexanol and n-butanol, n-alkylpyrrolidones, fatty acid dimethyl esters, fatty acid esters, dibasic esters, aromatic hydrocarbons and/or aliphatic hydrocarbons, one or more dimethylamides, such as C₈-dimethylamide, C₁₀-dimethylamide, C₁₂-dimethylamide, ethylene glycol, propylene glycol, polyalkylene glycols, aromatic hydrocarbons, methylpyrrolidinone (NMP); dimethylformamide (DMF); dimethylisosorbide (DMI); isophorone; acetophenone; 1,3-dimethyl-2-imidazolidonone; lactate esters; dimethyl and diethylcarbonates; alcohols including methanol; ethanol; iso-propanol; n-propanol; n-butanol; iso-butanol; and tert-butanol; methyl L-lactate, 2-ethylhexyl L-lactate, ethyl L-lactate, n-butyl L-lactate, octyl phenol ethoxylates or mixture thereof.

The emulsifier for suspo emulsion (SE) is selected from the group consisting of containing salts of dodecylbenzene sulphonate, e.g. Ca-salts or amine salts, and sulphonates of other C₁₁-C₁₆ alkylbenzenes, alkylether sulphates, alkylphenoletherphosphates and ester phosphates; non-ionic surfactants such as alkoxylated alcohols and alkylphenols, ethoxylated fatty acids, ethoxylated vegetable oils, e.g. ethoxylated castor oil, fatty acid esters, e.g. of sorbitol, and their ethoxylated derivatives, ethoxylated amines, and condensates of glycerol; and catanionic emulsifiers such as a cationic amine, optionally in combination with an alkylsulphonate or ether sulphonate or ether phosphate, alkoxylated alcohols; alkoxylated alkylphenols; ethoxylated fatty acids; ethoxylated vegetable oils; ethoxylated tristyrylphenol (tristyrlphenol with 16 moles EO), tristyrylphenol-polyglycolether-phosphate, fatty acid esters of sorbitol and ethoxylated derivatives thereof; ethoxylated amines and condensates of glycerol; sulfonated alkylbenzenes in the range C₁₁-C₁₆ and salts thereof; alkylether sulphates; alkyletherphosphates; alkylphenoletherphosphates; or combinations thereof; salts of phosphate esters of ethoxylated tristyrylphenol; salts of sulphated ethers of ethoxylated tristyrylphenol; or a catanionic system, wherein a cationic amine is present in combination with an alkylsulphonate, an alkylethersulphonate, an ether sulphate, or an ether phosphate such as an alkyletherphosphate, nonylphenol polyethoxy ethanols, castor oil polyglycol ethers, polyadducts of ethylene oxide and polypropylene, tributyl phenoxy polyethoxy ethanol, octyl phenoxy polyethoxy ethanol or mixture thereof.

The stabilizer for suspo emulsion (SE) is selected from the group consisting of butylated hydroxytoluene (BHT) and epoxidized soybean oil (ESBO), epichlorhydrin or mixture thereof.

The anti-freezing agent for suspo emulsion (SE) is selected from the group consisting of ethylene glycol, propane diols, glycerine or the urea, glycol (monoethylene glycol, diethylene glycol, polypropylene glycol, polyethylene glycol), glycerine, urea, magnesium sulfate heptahydrate, sodium chloride or mixture thereof.

The antifoaming agent for suspo emulsion (SE) is selected from the group consisting of silicone oil, silicone compound, C₁₀˜C₂₀ saturated fat acid compounds or C₈˜C₁₀ aliphatic alcohols compound, silicone antifoam emulsion, dimethylsiloxane, polydimethyl siloxane, vegetable oil based antifoam, tallow based fatty acids, polyalkyleneoxide modified polydimethylsiloxane or mixture thereof.

The suspending agent for suspo emulsion (SE) is selected from the group consisting of aluminum magnesium silicate, bentonite clay, silica, silicone dioxide, attapulgite clay or mixture thereof.

The wetting agent for suspo emulsion (SE) is selected from the group consisting of ethylene oxide/propylene oxide block copolymer, polyarylphenyl ether phosphate, ethoxylated fatty alcohol, sodium dioctyl sulfosuccinate, sodium lauryl sulphate and sodium dodecyl benzene sulfonate, alkyl diphenyl sulfonates, sodium isopropyl naphthalene sulfonate, alkyl naphthalene sulfonate, octyl phenol ethoxylate, alkyl phenol ethoxylate or mixture thereof.

The wetting-spreading-penetrating agent for suspo emulsion (SE) are selected from the group consisting of organosilicone surfactants; trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, polyalkyleneoxide modified heptamethyl trisiloxane, heptamethyl trisiloxane ethoxylate, polyether modified polysiloxane, 10 mole ethylene oxide adduct of octylphenol, may or may not be in modified form, may be liquid or powder form or mixture thereof.

The preservatives for suspo emulsion (SE) are selected from the group consisting of propionic acid and its sodium salt, sorbic acid and its sodium or potassium salt, benzoic acid and its sodium salt, p-hydroxy benzoic acid sodium salt; methyl p-hydroxy benzoate; and biocide such as sodium benzoate, 1,2-benzisothiazoline-3-one, 2-methyl-4-isothiazolin-3-one, 5-chloro-2-methyl-4-isothiazolin-3-one, potassium sorbate, para hydroxy benzoates or mixtures thereof.

The thickeners for suspo emulsion (SE) are selected from the group consisting of thickening, gelling, and anti-settling agents generally fall into two categories, namely water-insoluble particulates and water-soluble polymers. It is possible to produce suspension concentrate formulations using clays and silicas. Examples of these types of materials, include, but are limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and 15 sea weeds are synthetic derivatives of cellulose or mixtures thereof. Examples of these types of materials include, but are not limited to, guar gum; locust bean gum; carrageenam; xanthan gum; alginates; methyl cellulose; sodium carboxymethyl cellulose (SCMC); hydroxyethyl cellulose (HEC) or mixtures thereof. Other types of anti-settling agents are based on modified starches, polyacrylates, polyvinyl 20 alcohol and polyethylene oxide or mixtures thereof.

The dispersing agent for suspo emulsion (SE) is selected from the group consisting of a conventionally available for example polyesters, polyamides, poly-carbonates, polyurea and polyurethanes, acrylic polymers, acrylic graft copolymer, styrene copolymers, butadiene copolymers, polysaccharides such as starch and cellulose derivatives, vinylalcohol, vinylacetate and vinylpyrrolidone polymers and copolymers, polyethers, epoxy, phenolic and melamine resins, polyolefins and define copolymers and mixtures thereof. Examples of preferred polymers are acrylate polymers such as poly(methacrylate), poly(ethyl methacrylate), poly(methylmethacrylate), acrylate copoylmers and styrene-acrylic copolymers as defined herein below, poly(styrene-co maleic anhydride), cellulosic polymers such as ethyl cellulose, cellulose acetate, cellulose acetatebutyrate, acetylated mono, di, and triglycerides, poly(vinylpyrrolidone), vinyl acetate polymers and copolymers, poly(alkylene glycol), styrene butadiene copolymers, poly(orthoesters), alkyd resins, and mixtures of two or more of these. Polymers that are biodegradable are also useful in the present invention. As used herein, a polymer is biodegradable if is not water soluble, but is degraded over a period of several weeks when placed in an application environment. Examples of biodegradable polymers that are useful in the present invention include biodegradable polyesters, starch, polylactic acid starch blends, polylactic acid, poly(lactic acid-glycolic acid) copolymers, polydioxanone, cellulose esters, ethyl cellulose, cellulose acetate butyrate, starch esters, starch esteraliphatic polyester blends, modified corn starch, polycaprolactone, poly(namylmethacrylate), wood rosin, polyanhydrides, polyvinylalcohol, polyhydroxybutyratevalerate, biodegradable aliphatic polyesters, and polyhydroxybutyrate or mixtures thereof. The examples of dispersing agents are alkylated naphthalene sulfonate, sodium salt, sodium salt of naphthalene sulfonate condensate, sodium salt of alkyl naphthalene sulfonate, sodium ligno sulfonate, sodium ploycarboxylate, EO/PO block copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide or mixture thereof.

The buffering agent for suspo emulsion (SE) is selected from the group consisting of calcium hydroxyapatite, potassium dihydrogen phosphate, sodium hydroxide, carbonated apatite, calcium carbonate, sodium bicarbonate, tricalcium phosphate, calcium phosphates, carbonated calcium phosphates, amine monomers, lactate dehydrogenase and magnesium hydroxide or mixture thereof.

The humectant for suspo emulsion (SE) is selected from the group consisting of urea, humic acid, glycerol, lactose or mixture thereof.

The present invention also refers to the method for preparation of suspo emulsion formulation as describing the following steps:

### Manufacturing Process of Suspo Emulsion (SE) Formulation:

Step 1: Gel preparation: A required quantity of water is charged to a vessel which is equipped with a high shear stirrer whilst the agitation is initiated. The required amount of preservative(s) is/are added and mixed to achieve homogeneity. Further, a required amount of thickener(s) is/are added and mixed vigorously to achieve full wetness.

Step 2: Oil phase: The solvent(s) is charged into the vessel and then the active is slowly added and if required, it is heated for 50° C. so that the active ingredients can be dissolved in the solvent and followed by addition of emulsifier(s).

Step 3: The agitation is initiated when a required quantity of water is charged to a vessel which is equipped with a bulk agitator and a high shear homogenizer. A required amount of anti freezing agent(s) is/are added and mixed to achieve a uniform mixture. The antifoaming agent(s) is/are added and ensured that it is well dispersed. The wetting and dispersing agents are added and mixed to achieve uniform mixture and ensured that the dispersing agent is fully dispersed.

Step 4: The active ingredients are added in the vessel and agitated till entire components get dissolved. The pre-mix is milled through a colloid mill and subsequently through a dyno mill to achieve a specified particle size.

Step 5: The remaining antifoaming agent(s) is/are added in the mill base to a vessel which is equipped with bulk agitator and mixed to achieve uniformity.

Step 6: An addition of an oil phase in an aqueous phase is performed and stirred for 30 minutes by using homogenizer.

Step 7: A required amount of aqueous pre-gel and suspending agent(s) are added. A homogenous mixture and a target viscosity are achieved by continuous agitation.

Step 8: The final product is submitted for QC approval.

Step 9: The material is packed in its required package sizes when approved.

### D. Lists of Inactive Excipient Used in the WG (Wettable Granule) Formulation:

The dispersing agents for wettable granule (WG) are selected from the group consisting of sodium polycarboxylate (sodium polyacrylate), naphthalene sulfonic acid, sodium salt condensates with formaldehyde, polyalcoxylated alkylphenol, naphthalene sulfonic acid formaldehyde condensate, methyl naphthalene-formaldehyde-condensate sodium salt, naphthalene condensates, lignosulfonates, calcium lignosulfonate, lignin sulfonate sodium salt, alkyl naphthalene sulfonate, sodium salt. The preferred dispersing agent is alkyl naphthalene sulfonate. It provides an excellent wetting, dispersing, hydrotroping and medium to low foaming. It offers acid and base stability, hard water tolerance and high temperature stability or mixture thereof.

The wetting agents for wettable granule (WG) are selected from the group consisting of sodium N-methyl-N-oleoyl taurate, alkylated naphthalene sulfonate, sodium salt, mixture of isomers of dibutyl naphthalene sulphonic acid sodium salt, sodium di-isopropyl naphthalene sulphonate, sodium lauryl sulfate, dioctyl sulfate, alkyl naphthalene sulfonates, phosphate esters, sulphosuccinates and non-ionic such as tridecyl alcohol ethoxylate, alkyl or alkaryl sulfonates such as alkylbenzene sulfonates, alpha olefin sulfonate and alkyl naphthalene sulfonates, ethoxylated or non-ethoxylated alkyl or alkaryl carboxylates, alkyl or alkaryl phosphate esters, alkyl polysaccharide, di or mono alkyl sulfosuccinate derivatives, alpha olefin sulfonates, alkyl naphthalene sulfonates, dialkyl sulphosuccinates, butyl, dibutyl, isopropyl and di-isopropyl naphthalene sulfonate salts, C₁₂ alkyl benzene sulfonate or C₁₀-C₁₆ alkyl benzene sulfonate, organosilicons surfactants; trisiloxane ethoxylate, polydimethylsiloxane, polyoxyethylene methyl polysiloxane, polyoxyalkylene methyl polysiloxane, polyether polymethyl siloxane copolymer, trisiloxane heptamethyl, polyalkyleneoxide modified heptamethyl trisiloxane, polyether modified polysiloxane, may or may not be in modified form, may be liquid or powder form or mixture thereof.

The antifoaming agent for wettable granule (WG) is selected from the group consisting of polydimethylsiloxane or mixture thereof.

The carrier for wettable granule (WG) is selected from the group consisting of china clay, silica, lactose anhydrous, ammonium sulfate, sodium sulfate anhydrous, corn starch, urea, EDTA, urea formaldehyde resin, diatomaceous earth, kaolin, bentonite, kieselguhr, fuller's earth, attapulgite clay, bole, loess, talc, chalk, dolomite, limestone, lime, calcium carbonate, powdered magnesia, magnesium oxide, magnesium sulphate, sodium chloride, gypsum, calcium sulphate, pyrophyllite, silicates and silica gels; fertilizers such as, for example, ammonium sulphate, ammonium phosphate, ammonium nitrate and urea; natural products of vegetable origin such as, for example, grain meals and flours, bark meals, wood meals, nutshell meals and cellulosic powders; and synthetic polymeric materials such as, for example, ground or powdered plastics and resins, bentonites, zeolites, titanium dioxide, iron oxides and hydroxides, aluminium oxides and hydroxides, or organic materials such as bagasse, charcoal, or synthetic organic polymers or mixture thereof.

The humectant for wettable granule (WG) is selected from the group consisting of humic acid, glycerol, lactose, sodium sulphate anhydrous or mixture thereof.

More particularly, the present invention also refers to the method for preparation of water dispersible granule formulation as describing the following steps:

### Manufacturing Process of WG/WDG (Water Dispersible Granule):

Step 1: A precise weight of active ingredients are taken and added in blender followed by a required quantity of binder(s) and surfactant(s) and mixed to achieve a complete homogenization.

Step 2: The homogenized mixture is milled until required wet sieve is achieved and post blended to attain homogeneity.

Step 3: The above mentioned homogenous material is passed through extruder for granulation.

Step 4: Excess moisture is removed by transferring the granules through fluid bed dryer.

Step 5: The granules are transferred to vibro shifter.

Step 6: The final material is collected from the vibro shifter into the drum.

Step 7: The final product is submitted for QC approval.

Step 8: Once the approval is achieved from QC department, the material is transferred into different size of drums.

### EXAMPLES

The present invention has been described with reference to specific embodiment which is merely illustrative and not intended to limit the scope of the invention as defined in the present complete specification.

### Biological Examples

The synergistic pesticide action of the inventive mixtures is demonstrated by the experiments below. A synergistic effect exists wherever the action of a combination (ready-mix) or tank mix of active ingredient is greater than the sum of the action of each of the components alone. Therefore a synergistically effective amount or an effective amount of a synergistic composition or combination is an amount that exhibits greater pesticide activity than the sum of the pesticide activities of the individual components.

In the field of agriculture, it is often understood that the term “synergy” is as defined by Colby S. R. in an article entitled “Calculation of the synergistic and antagonistic responses of herbicide combinations” published in the journal Weeds, 1967, 15, p. 20-22, incorporated herein by reference in its entirety. The action expected for a given combination of two or three active components can be calculated as follows:

### Colby's Formula for Calculating Synergism Between Two Active Ingredients

$$E = ( X + Y ) - \frac{( X \times Y )}{100}$$

Where, E=Expected/Calculated control by mixture or combination of Compound A and Compound B in a defined dose X=Control Observed by Compound A, Y=Control Observed by Compound B

### Colby's Formula for Calculating Synergism Between Three Active Ingredients

$$E = ( X + Y + Z ) - \frac{( XY + XZ + YZ )}{100} + \frac{( XYZ )}{10000}$$

Where, E=Expected/Calculated control by mixture or combination of Compound A, Compound B and Compound C in a defined dose X=Control Observed by Compound A, Y=Control Observed by Compound B, Z=Control Observed by Compound C

$$Colby ’ s Ratio = \frac{Control Observed}{Expected / Calculated control}$$

If Colby's ratio >1 means synergism observed, <1 means antagonism observed, =1 means simple additive effect Higher the ratio, means stronger the synergism, Lower ratio means weak synergism.

The objective of the present studies is to study the synergism and benefits. The various formulations of fluxametamides, at least diamide insecticides, at least one more compound selected from the group of insecticide, fungicide or plant health additives were analyzed.

More particularly, the study is related to fluxametamide, at least one diamide insecticide and one more insecticide; fluxametamide, at least one diamide insecticide and at least one fungicide; and fluxametamide, at least one diamide insecticide and at least one plant health additive are analyzed.

### Bio-Efficacy of Fluxametamide+at Least One Diamide Insecticide+at Least One Insecticide

### Example 1: Bioefficacy Against Chilli Thrips, Fruit Borer and its Effect on Yield

Crop: Chilli
Location: Umreth, Gujarat
Number of treatments: 28
Plot size: 50 sq·m. (square meter)
Crop stage: 77 days after transplanting.
Method of application: Foliar spray with battery operated back pack sprayer
Water volume: 470 liter per hectare

### Observation Methods:

Thrips (Scirtothrips dorsalis): Count the number of live thrips by shaking the twigs on black piece of paper. Record the observations from 3 twigs per plant and 10 plants per plot on 7 and 14 DAA (days after application). Calculate thrips control (%) as observed control and apply colby's formula to calculate syngergism.

$$Thrips Control ( \% ) = 100 - \frac{number of live thrips in treatment}{number of live thrips in untreated ( UTC )} \times 100$$

Fruit borer (mixed infestation of Helicoverpa armigera and Spodoptera exigua) larval control (%): Count the number of live larvae per plant. Record observations from 10 plants per plot on 14 days after application.

$$\% Larval control = 100 - \frac{Number of live larva in treatment}{Number of live larva in untreated control} \times 100$$

Fruit borer larval control (%) data were used to check the synergism by applying Colby's formula given above.

Healthy Fruit count: Count the number of healthy fruits per plant. Record the observations from 10 plants per plot, and calculate increase (%) in healthy fruits over UTC (untreated check).

$$Increase ( \% ) in fruits over untreated control = \frac{100 \times Number of fruits in treatment}{Number of fruits in untreated control} - 100$$

| | Percent |
|---|---|
| Chemical composition | (w/w) |
| Fluxametamide a.i. | 3.33 |
| Chlorantraniliprole a.i. | 2.40 |
| Tolfenpyrad a.i. | 12.00 |
| Methylated seed oil, polyalkyleneoxide modified trisiloxane | 5.00 |
| (super wetting-spreading-penetrating agent) | |
| Ethylene-propylene oxide block copolymer (dispersing agent I) | 4.75 |
| Sodium naphthalene sulphonate formaldehyde condensates | 1.25 |
| (dispersing agent II) | |
| Aluminum magnesium silicate (suspending agent) | 0.50 |
| Polydimethylsiloxane (anti foaming agent) | 0.30 |
| sodium benzoate (preservative) | 0.20 |
| Polypropylene glycol (anti freezing agent) | 5.00 |
| Xanthan gum (thickner) | 0.20 |
| Diluent water | 65.07 |
| Total | 100.00 |

### Active Ingredient on 100% Purity Basis

Storage Stability: T3 = Fluxametamide 3.33% + Chlorantraniliprole 2.4% + Tolfenpyrad 12% SC
Laboratory storage stability for 14 days

| | Specification | | Stability at | Stability at |
|---|---|---|---|---|
| Parameters | (in house) | Initial | 54 ± 2° C. | 0 ± 2° C. |
| Fluxametamide a.i. | 3.16 to 3.66 | 3.45 | 3.40 | 3.44 |
| Chlorantraniliprole a.i. | 2.28 to 2.64 | 2.50 | 2.45 | 2.50 |
| Tolfenpyrad a.i. | 11.4 to 12.6 | 12.45 | 12.35 | 12.4 |
| Fluxametamide suspensibility (%) | 80 | 98.60 | 98.10 | 98.50 |
| Chlorantraniliprole suspensibility (%) | 80 | 98.50 | 98.30 | 98.50 |
| Tolfenpyrad suspensibility (%) | 80 | 98.70 | 98.20 | 98.45 |
| pH range (1% aq. Suspension) | 5.5 to 8.0 | 7.05 | 7.15 | 7.05 |
| Pourability (%) | 95 | 98.20 | 98.00 | 98.10 |
| Specific gravity | 1.05-1.10 | 1.07 | 1.07 | 1.07 |
| Viscosity at spindle no. 62, 20 rpm | 350-800 cps | 530 | 550 | 550 |
| Particle size (micron) | D50 < 3, D90 < 10 | 2.1, 8.5 | 2.1, 8.7 | 2.1, 8.7 |
| Persistent foam ml (after 1 minute) max. | 60 | nil | nil | nil |

Room temperature storage stability up to 12 months

| | Specification | | 1 | 6 | 12 |
|---|---|---|---|---|---|
| Parameters | (in house) | Initial | month | month | month |
| Fluxametamide a.i. | 3.16 to 3.66 | 3.45 | 3.45 | 3.45 | 3.45 |
| Chlorantraniliprole a.i. | 2.28 to 2.64 | 2.50 | 2.50 | 2.50 | 2.50 |
| Tolfenpyrad a.i. | 11.4 to 12.6 | 12.45 | 12.45 | 12.45 | 12.40 |
| Fluxametamide suspensibility (%) | 80 | 98.60 | 98.50 | 98.50 | 98.40 |
| Chlorantraniliprole suspensibility (%) | 80 | 98.50 | 98.50 | 98.50 | 98.40 |
| Tolfenpyrad suspensibility (%) | 80 | 98.70 | 98.70 | 98.60 | 98.60 |
| pH range (1% aq. Suspension) | 5.5 to 8.0 | 7.05 | 7.05 | 7.05 | 7.10 |
| Pourability (%) | 95 | 98.20 | 98.20 | 98.20 | 98.10 |
| Specific gravity | 1.05-1.10 | 1.07 | 1.07 | 1.07 | 1.07 |
| Viscosity at spindle no. 62, 20 rpm | 350-800 cps | 530 | 530 | 530 | 535 |
| Particle size (micron) | D50 < 3, D90 < 10 | 2.1, 8.5 | 2.1, 8.5 | 2.1, 8.5 | 2.1, 8.6 |
| Persistent foam in ml (after 1 minute) max. | 60 | nil | nil | nil | nil |

The composition of Fluxametamide 3.33% + Chlorantraniliprole 2.4% + Tolfenpyrad 12% SC meets the all in house specifications for storage stability studies in laboratory (at 54 ± 2 C. & At 0 ± 2 C. for 14 days) and room temperature (for 12 months).

### Manufacturing Process for 100 kg Batch of Fluxametamide 3.33%+Chlorantraniliprole 2.4%+Tolfenpyrad 12% SC (T3)

Step 1: 2% Gum Solution: Xanthan gum (2.0 kg) and 1,2-benzisothiazoline-3-one (2.0 kg) were charged into 96.0 kg water and homogenize. It was made 12-18 hour prior to use.

Step 2: DM water (55.07 kg) and 1,2-propylene glycol (5 kg) were charged into designated vessel and mixed thoroughly.

Step 3: Sodium naphthalene sulphonate formaldehyde condensates (1.25 kg), Ethylene-propylene oxide block copolymer (4.75 kg), Dioctyl sulfosuccinate (2.0 kg) and Aluminum magnesium silicate (0.5 kg) were added into the vessel having water and homogenised the contents for 45-60 minutes using high shear homogeniser.

Step 4: Then Fluxametamide (3.33 kg), Chlorantraniliprole (2.40 kg) and Tolfenpyrad (12.0 kg) were added to the premix slowly and homogenised to get uniform slurry ready for grinding.

Step 5: Before grinding half the quantity of Polydimethylsiloxane (0.15 kg) was added and then material was subjected to grinding in Dyno mill till desired particle size was achieved.

Step 6: Remaining Polydimethyl siloxane (0.15 kg) antifoam was added after grinding process completes and before sampling for in process analysis.

Step 7-Finally 10.0 kg of 2% Xanthum gum solution and 5.0 kg of Methylated seed oil, polyalkyleneoxide modified trisiloxane were added to the formulation and homogenized for 30 minutes.

Step 8: QC for quality check was done.

| Chemical composition | Percent (w/w) |
|---|---|
| Fluxametamide a.i. | 5.00 |
| Cyantraniliprole a.I. | 8.00 |
| Lambda cyhalothrin a.i. | 2.00 |
| Mixture of heavy aromatic hydrocarbons | 1.20 |
| 4,4′-diphenylmethane diisocyanate | 0.25 |
| Diethylene triamine | 0.15 |
| Alkylbenzene sulfonate calcium salts (Emulsifier-I) | 0.12 |
| Tristyrylphenol polyethoxyester phosphate (Emulsifier-II) | 3.50 |
| Acrylic graft copolymer (dispersing agent I) | 2.50 |
| Sodium naphthalene sulphonate formaldehyde condensate | 0.16 |
| (dispersing agent II) | |
| Attapulgite clay (suspending agent) | 1.50 |
| Polydimethylsiloxane (anti foaming agent) | 0.30 |
| 1,2-benzisothiazolin-3(2H)-one (preservative) | 0.20 |
| Polypropylene glycol (anti freezing agent) | 5.00 |
| Xanthan gum (thickner) | 0.20 |
| Diluent water | 69.92 |
| Total | 100.00 |
| active ingredient on 100% purity basis | |

Storage stability-T5 = Fluxametamide 5% + Cyantraniliprole 8% + lambda cyhalothrin 2% ZC
Laboratory storage stability for 14 days

| | Specification | | Stability at | Stability at |
|---|---|---|---|---|
| Parameters | (in house) | Initial | 54 ± 2° C. | 0 ± 2° C. |
| Fluxametamide a.i. | 4.75 to 5.50 | 5.30 | 5.15 | 5.30 |
| Cyantraniliprole a.i. | 7.60 to 8.80 | 8.35 | 8.25 | 8.35 |
| Lambda cyhalothrin a.i. | 1.80 to 2.20 | 2.15 | 2.10 | 2.15 |
| Fluxametamide suspensibility (%) | 80 | 98.70 | 97.40 | 98.60 |
| Cyantraniliprole suspensibility (%) | 80 | 98.20 | 97.50 | 98.20 |
| Lambda cyhalothrin suspensibility (%) | 80 | 98.30 | 97.10 | 98.20 |
| pH range (1% aq. Suspension) | 5.5 to 8.0 | 7.10 | 7.20 | 7.10 |
| Pourability (%) | 95 | 98.20 | 98.10 | 98.20 |
| Specific gravity | 1.05-1.10 | 1.07 | 1.07 | 1.07 |
| Viscosity at spindle no. 62, 20 rpm | 350-800 cps | 520 | 540 | 550 |
| Particle size (micron) | D50 < 3, D90 < 10 | 2.1, 8.6 | 2.1, 8.6 | 2.1, 8.7 |
| Persistent foam ml (after 1 minute) max. | 60 | nil | nil | nil |

### Room Temperature Storage Stability Up to 12 Months

| | Specification | | 1 | 6 | 12 |
|---|---|---|---|---|---|
| Parameters | (in house) | Initial | month | months | months |
| Fluxametamide a.i. | 4.75 to 5.50 | 5.30 | 5.30 | 5.30 | 5.28 |
| Cyantraniliprole a.i. | 7.60 to 8.80 | 8.35 | 8.35 | 8.35 | 8.30 |
| Lambda cyhalothrin a.i. | 1.80 to 2.20 | 2.15 | 2.15 | 2.14 | 2.14 |
| Fluxametamide suspensibility (%) | 80 | 98.70 | 98.50 | 98.50 | 98.40 |
| Cyantraniliprole suspensibility (%) | 80 | 98.20 | 98.20 | 98.10 | 98.10 |
| Lambda cyhalothrin suspensibility (%) | 80 | 98.30 | 98.30 | 98.20 | 98.10 |
| pH range (1% aq. Suspension) | 5.5 to 8.0 | 7.10 | 7.10 | 7.15 | 7.15 |
| Pourability (%) | 95 | 98.20 | 98.20 | 98.20 | 98.20 |
| Specific gravity | 1.05-1.10 | 1.07 | 1.07 | 1.07 | 1.07 |
| Viscosity at spindle no. 62, 20 rpm | 350-800 cps | 520 | 520 | 525 | 525 |
| Particle size (micron) | D50 < 3, D90 < 10 | 2.1, 8.6 | 2.1, 8.6 | 2.1, 8.6 | 2.1, 8.6 |
| Persistent foam in ml (after 1 minute) max. | 60 | nil | nil | nil | nil |

The composition of Fluxametamide 5% + Cyantraniliprole 8% + lambda cyhalothrin 2% ZC meets all the criteria for storage stability studies in laboratory (at 54 ± 2 C. & At 0 ± 2 C. for 14 days) and room temperature (for 12 months).

### Manufacturing Process for 100 kg Batch of Fluxametamide 5%+Cyantraniliprole 8%+Lambda Cyhalothrin 2% ZC (T5)

Step 1:—Preparation of 2% Gum Solution: 2 kg Xanthan gum and 2 kg 1,2-benzisothiazoline-3-one were charged into 96 kg water and homogenized and it was made 12-18 hour prior to use.

Step 2: CS premix (20% Lambda cyhalothrin)—12.0 kg of Aromatic solvent was added into other vessel having slow stirring. 20.0 kg of Lambda cyhalothirn, 2.5 kg of 4,4′-diphenylmethane diisocyanate were added and in other vessel 50.70 kg of water, 1.2 kg of Alkylbenzene sulfonate calcium salts, 1.6 kg of Sodium naphthalene sulphonate formaldehyde condensate, 0.5 kg of Polydimethyl siloxane and mixed properly for 30-45 minutes. Lambda cyahlothrin premix was added into this aqueous phase under high shearing to get required particle size and then 1.5 kg of Diethylene triamine was added and heated the formulation under low stirring for 3-4 hours and then cooled down to room temperature and 10 kg of 2% gum solution added.

Step 3:55.35 kg of DM water and 5 kg of 1,2-propylene glycol were charged into designated vessel and mixed thoroughly.

Step 4:2.5 kg of Acrylic graft copolymer, 3.50 kg of Tristyrylphenol polyethoxyester phosphate, 1.50 kg of Attapulgite clay and 0.05 kg of Polydimethylsiloxane were added into the vessel having water and homogenised the contents for 45-60 minutes using high shear homogeniser.

Step 5: Then 8.0 kg of Cyantraniliprole and 5.0 kg of Fluxametamide were added to this premix slowly and homogenised to get uniform slurry ready for grinding.

Step 6: Before grinding half the quantity of antifoam was added and then material was subjected to grinding in Dyno mill till desired particle size is achieved.

Step 7: Remaining 0.10 kg of Polydimethyl siloxane antifoam was added after grinding process completes and before sampling for in process analysis.

Step 8: Now 10% of 20 Lambda CS formulation premix is mixed to this milled slurry under slow stirring and homogenized for 30-45 minutes.

Step 9: Finally 9.0 kg of 2% gum solution was added to this formulation and sent to QC for quality check.

TABLE 1
Treatment details

| Treatment | | Rate (ml or g | gram actives |
|---|---|---|---|
| Number | Treatment compositions | per hectare) | per hectare |
| T1 | Fluxametamide 5% + Chlorantraniliprole | 500 | 25 + 18 + 10 |
| | 3.6% + lambda cyhalothrin 2% ZC | | |
| T2 | Fluxametamide 5% + Chlorantraniliprole | 500 | 25 + 18 + 7.5 |
| | 3.6% + Abamectin 1.5% SC | | |
| T3 | Fluxametamide 3.33% + Chlorantraniliprole | 750 | 25 + 18 + 90 |
| | 2.4% + Tolfenpyrad 12% SC | | |
| T4 | Fluxametamide 10% + Chlorantraniliprole | 250 | 25 + 18 + 40 |
| | 7.2% + Fipronil 16% WG | | |
| T5 | Fluxametamide 5% + Cyantraniliprole | 500 | 25 + 40 + 10 |
| | 8% + lambda cyhalothrin 2% ZC | | |
| T6 | Fluxametamide 5% + Cyantraniliprole | 500 | 25 + 40 + 7.5 |
| | 8% + Abamectin 1.5% SC | | |
| T7 | Fluxametamide 3.33% + Cyantraniliprole | 750 | 25 + 40 + 90 |
| | 5.33% + Tolfenpyrad 12% SC | | |
| T8 | Fluxametamide 5% + Cyantraniliprole | 500 | 25 + 40 + 40 |
| | 8% + Fipronil 8% SC | | |
| T9 | Chlorantraniliprole 3.6% + | 500 | 18 + 10 |
| | lambda cyhalothrin 2% ZC | | |
| T10 | Chlorantraniliprole 3.6% + | 500 | 18 + 7.5 |
| | Abamectin 1.5% SC | | |
| T11 | Chlorantraniliprole 2.4% + | 750 | 18 + 90 |
| | Tolfenpyrad 12% SC | | |
| T12 | Chlorantraniliprole 14.4% + | 125 | 18 + 40 |
| | Fipronil 32% WG | | |
| T13 | Cyantraniliprole 8% + | 500 | 40 + 10 |
| | lambda cyhalothrin 2% ZO | | |
| T14 | Cyantraniliprole 8% + | 500 | 40 + 7.5 |
| | Abamectin 1.5% SC | | |
| T15 | Cyantraniliprole 5.33% + | 750 | 40 + 90 |
| | Tolfenpyrad 12% SC | | |
| T16 | Cyantraniliprole 16% + | 250 | 40 + 40 |
| | Fipronil 16% SC | | |
| T17 | Fluxametamide 5% + | 500 | 25 + 18 |
| | Chlorantraniliprole 3.6% SC | | |
| T18 | Fluxametamide 5% + | 500 | 25 + 40 |
| | Cyantraniliprole 8% SC | | |
| T19 | Fluxametamide 5% + | 500 | 25 + 7.5 |
| | Abamectin 1.5% SC | | |
| T20 | Fluxametamide 3.33% + | 750 | 25 + 90 |
| | Tolfenpyrad 12% SC | | |
| T21 | Fluxametamide 10% EC | 250 | 25 |
| T22 | Chlorantraniliprole | 90 | 18 |
| | 18.5% w/w (20% w/v) SC | | |
| T23 | Cyantraniliprole | 400 | 40 |
| | 10.26% w/w (10% w/v ) OD | | |
| T24 | lambda cyhalothrin 5% EC | 200 | 10 |
| T25 | Abamectin 1.9% EC | 394.7368421 | 7.5 |
| T26 | Tolfenpyrad 15% EC | 600 | 90 |
| T27 | Fipronil 80% WG | 50 | 40 |
| T28 | Untreated Check (UTC) | — | — |

ZC-zeon concentrate, SC-suspension concentrate, EC-emulsifiable concentrate, OD-oil dispersion. T1 to T8 are inventive compositions, T9 to T20 are known compositions, T21 to T27 are market products.

TABLE 2a
Thrips control in chilli crop

| | Thrips control (%) | | | | | | | |
|---|---|---|---|---|---|---|---|---|
| | at 7 DAA | | | | at 14 DAA | | | |
| Treatment | control | control | Colby's | Synergism | control | control | Colby's | Synergism |
| Number | observed | expected | ratio | (Y/N) | observed | expected | ratio | (Y/N) |
| T1 | 100.0 | 90.3 | 1.11 | Y | 86.6 | 77.7 | 1.11 | Y |
| T2 | 100.0 | 93.3 | 1.07 | Y | 93.6 | 83.6 | 1.12 | Y |
| T3 | 100.0 | 93.7 | 1.07 | Y | 94.2 | 83.7 | 1.13 | Y |
| T4 | 100.0 | 92.9 | 1.08 | Y | 92.2 | 81.9 | 1.13 | Y |
| T5 | 100.0 | 95.7 | 1.04 | Y | 97.4 | 88.3 | 1.10 | Y |
| T6 | 100.0 | 97.1 | 1.03 | Y | 98.4 | 91.4 | 1.08 | Y |
| T7 | 100.0 | 97.2 | 1.03 | Y | 98.8 | 91.5 | 1.08 | Y |
| T8 | 100.0 | 96.9 | 1.03 | Y | 98.0 | 90.5 | 1.08 | Y |
| T9 | 63.8 | 64.9 | 0.98 | N | 41.6 | 45.9 | 0.91 | N |
| T10 | 77.2 | 76.0 | 1.02 | Y | 57.8 | 60.1 | 0.96 | N |
| T11 | 78.4 | 77.3 | 1.01 | Y | 58.2 | 60.5 | 0.96 | N |
| T12 | 75.2 | 74.6 | 1.01 | Y | 54.6 | 56.1 | 0.97 | N |
| T13 | 86.8 | 84.7 | 1.03 | Y | 69.8 | 71.6 | 0.97 | N |
| T14 | 90.4 | 89.5 | 1.01 | Y | 77.4 | 79.1 | 0.98 | N |
| T15 | 91.2 | 90.1 | 1.01 | Y | 76.2 | 79.3 | 0.96 | N |
| T16 | 90.8 | 88.9 | 1.02 | Y | 75.0 | 77.0 | 0.97 | N |
| T17 | 78.4 | 77.6 | 1.01 | Y | 56.4 | 61.0 | 0.92 | N |
| T18 | 91.4 | 90.2 | 1.01 | Y | 78.8 | 79.6 | 0.99 | N |
| T19 | 92.2 | 91.7 | 1.01 | Y | 81.2 | 82.6 | 0.98 | N |
| T20 | 92.8 | 92.2 | 1.01 | Y | 80.8 | 82.8 | 0.98 | N |
| T21 | 72.2 | | | | 58.8 | | | |
| T22 | 19.6 | | | | 5.4 | | | |
| T23 | 64.8 | | | | 50.4 | | | |
| T24 | 56.4 | | | | 42.8 | | | |
| T25 | 70.2 | | | | 57.8 | | | |
| T26 | 71.8 | | | | 58.2 | | | |
| T27 | 68.4 | | | | 53.6 | | | |
| T28 | 0.0 | | | | 0.0 | | | |

All the inventive compositions (T1 to T8) showed synergistic control as well as residual control up to 14 days as compared to all know compositions (T9 to T20) and market products (T21 to T27). All the inventive composition (T1 to T8) depicts >1 Colby's ratio which means stronger synergism.

TABLE 2b
Fruit borer larval control and chilli fruit yield

| | Fruit borer | Number of | Increase (%) |
|---|---|---|---|
| Treatment | larval control | healthy fruits | in fruits |
| Number | (%) at 14 DAA | per plant | over UTC |
| T1 | 100.0 | 41.3 | 110.7 |
| T2 | 100.0 | 44.1 | 125.0 |
| T3 | 100.0 | 45.3 | 131.1 |
| T4 | 100.0 | 43.8 | 123.5 |
| T5 | 100.0 | 44.5 | 127.0 |
| T6 | 100.0 | 46.8 | 138.8 |
| T7 | 100.0 | 47.3 | 141.3 |
| T8 | 100.0 | 45.5 | 132.1 |
| T9 | 68.0 | 30.5 | 55.6 |
| T10 | 63.2 | 31.9 | 62.8 |
| T11 | 75.0 | 32.7 | 66.8 |
| T12 | 74.6 | 31.3 | 59.7 |
| T13 | 65.2 | 33.7 | 71.9 |
| T14 | 60.9 | 35.8 | 82.7 |
| T15 | 72.2 | 35.9 | 83.2 |
| T16 | 72.6 | 34.5 | 76.0 |
| T17 | 81.8 | 36.9 | 88.3 |
| T18 | 79.8 | 37.8 | 92.9 |
| T19 | 74.6 | 38.5 | 96.4 |
| T20 | 79.6 | 37.4 | 90.8 |
| T21 | 55.2 | 31.2 | 59.2 |
| T22 | 60.4 | 24.7 | 26.0 |
| T23 | 57.4 | 31.7 | 61.7 |
| T24 | 20.2 | 22.7 | 15.8 |
| T25 | 10.6 | 28.8 | 46.9 |
| T26 | 40.8 | 29.6 | 51.0 |
| T27 | 38.6 | 27.3 | 39.3 |
| T28 | 0.0 | 19.6 | 0.0 |

All the inventive compositions (T1 to T8) provide synergistic control of fruit borer larvae as well as produces highest number of marketable fruits per plant (<110% increase over UTC).

Conclusion: Among the various compositions as shown in Table 1 treatment number T1-T8 are considered to be present compositions which showed excellent synergism and effectiveness against chilli thrips and fruit borer larva on chilli crop. The thrips control observed at 7 DAA (days after application) of T1-T8 were 100% whereas the Colby's ratio was found to be >1 which means strong synergism. Whereas at 14 DAA the thrips control observed was more than 86%. Particularly, T7 (98.8%) followed by T6 (98.4%) and T8 (98.0%) showed highest thrips control at 14 DAA, achieving >1 Colby's ratio depicting effective synergism when compared to other known and market products.

Furthermore, the fruit borer larval control of T1-T8 showed 100% effectiveness at 14 DAA providing with more than 41 healthy fruits per plant from which T7 proved the maximum 47.3 followed by T6 (46.8) and T8 (45.5) of healthy fruits per plant. In addition to that, T1-T8 showed drastic increment >100% in fruits over UTC (untreated check), especially T7 exhibited 141.3% followed by T6 (138.8%) and T8 (132.1%) increase in fruits over UTC as compared to other known and market products.

### Example 2: Red Spider Mite, Shoot and Fruit Borer Control and Yield in Brinjal

Crop: Brinjal
Location: Asodar, Gujarat
Number of Treatments: 26
Plot size: 60 sq·m.
Crop age: 80 days after transplanting.
Method of application: Foliar spray with battery operated back pack sprayer.
Water volume: 500 liter per hectare

### Observation Methods:

Red spider mite (Tetranychus urticae) control (%): Count the number of motile stage of mite per unit area using 10× microscope. Record the observations from 5 spots per plant and 10 plants per plot. Calculate red spider mite control (%) and apply colby's formula.

$$Mite Control ( \% ) = 100 - \frac{number of live / motile stages of mite in treatment}{number of live / motile stages of mite in untreated ( UTC )} \times 100$$

Shoot and Fruit borer (Leucinoides orbonalis) control (%): The larvae of shoot and fruit borer causes damage to shoots and fruits in brinjal crop. Count the number of healthy and infested shoots, healthy and infested fruits per plant. Record the observations from randomly selected 10 plants per plot.

$$Shoot damage ( \% ) = \frac{number of infested shoots per 10 plants}{Total number of shoots observed per 10 plants} \times 100$$

$$Fruit damage ( \% ) = \frac{number of infested fruits per 10 plants}{Total number of fruits observed per plants} \times 100$$

Fruit counts: Count the number of healthy marketable fruits from 5 plants per plot and calculate increase in healthy fruits over UTC.

| Chemical composition | Percent (w/w) |
|---|---|
| Fluxametamide a.i. | 4.00 |
| Chlorantraniliprole a.i. | 5.00 |
| Hexythiazox a.i. | 4.00 |
| Polyoxyethylene | 10.00 |
| sorbitol hexaoleate | |
| (Oil Emulsifier) | |
| Salts of polyolefin | 2.50 |
| condensates (Non- | |
| Aqueous dispersant ) | |
| Ethoxylated | 8.50 |
| sorbitan ester | |
| (Co-Emulsifier) | |
| Bentonite clay | 1.50 |
| (Rheology modifier) | |
| Styrene acrylic polymer | 1.50 |
| (Aqueous dispersant) | |
| Methylated seed oil | 63.00 |
| (Oil continuous phase) | |
| Total | 100.00 |

### Active Ingredient on 100% Purity Basis

Storage Stability: T2 = Fluxametamide 4% +
Chlorantraniliprole 5% + Hexythiazox 4% OD
Laboratory storage stability for 14 days

| | Specification | | Stability at | Stability at |
|---|---|---|---|---|
| Parameters | (in house) | Initial | 54 ± 2° C. | 0 ± 2° C. |
| Fluxametamide a.i. | 3.80 to 4.40 | 4.20 | 4.10 | 4.20 |
| Chlorantraniliprole a.i. | 4.75 to 5.50 | 5.25 | 5.15 | 5.25 |
| Hexythiazox a.i. | 3.80 to 4.40 | 4.20 | 4.15 | 4.20 |
| Fluxametamide | 80 | 98.90 | 98.10 | 98.80 |
| suspensibility (%) | | | | |
| Chlorantraniliprole | 80 | 99.00 | 98.50 | 98.90 |
| suspensibility (%) | | | | |
| Hexythiazox | 80 | 98.80 | 98.10 | 98.80 |
| suspensibility (%) | | | | |
| pH range | 5.5 to 8.0 | 6.90 | 7.05 | 6.90 |
| (1% aq. Suspension) | | | | |
| Pourability (%) | 95 | 98.20 | 98.10 | 98.20 |
| Specific gravity | 1.00-1.10 | 1.03 | 1.03 | 1.03 |
| Viscosity at spindle | 350-800 cps | 510 | 520 | 510 |
| no. 62, 20 rpm | | | | |
| Particle size (micron) | D 50 < 3, | 2.1, 8.0 | 2.1, 8.2 | 2.1, 8.1 |
| | D 90 < 10 | | | |
| Persistent foam ml | 60 | nil | nil | nil |
| (after 1 minute) max. | | | | |

### Room Temperature Storage Stability Up to 12 Months

| | Specification | | 1 | 6 | 12 |
|---|---|---|---|---|---|
| Parameters | (in house) | Initial | month | month | month |
| Fluxametamide a.i. | 3.80 to 4.40 | 4.20 | 4.20 | 4.20 | 4.18 |
| Chlorantraniliprole | 4.75 to 5.50 | 5.25 | 5.25 | 5.25 | 5.20 |
| a.i. | | | | | |
| Hexythiazox a.i. | 3.80 to 4.40 | 4.20 | 4.20 | 4.20 | 4.19 |
| Fluxametamide | 80 | 98.90 | 98.90 | 98.80 | 98.80 |
| suspensibility (%) | | | | | |
| Chlorantraniliprole | 80 | 99.00 | 98.90 | 98.90 | 98.80 |
| suspensibility (%) | | | | | |
| Hexythiazox | 80 | 98.80 | 98.80 | 98.70 | 98.70 |
| suspensibility (%) | | | | | |
| pH range | 5.5 to 8.0 | 6.90 | 6.90 | 6.90 | 6.95 |
| (1% aq. Suspension) | | | | | |
| Pourability (%) | 95 | 98.20 | 98.20 | 98.20 | 98.20 |
| Specific gravity | 1.00-1.10 | 1.03 | 1.03 | 1.03 | 1.03 |
| Viscosity at spindle | 350-800 cps | 510 | 510 | 510 | 515 |
| no. 62, 20 rpm | | | | | |
| Particle size | D 50 < 3, | 2.1, 8.0 | 2.1, 8.1 | 2.1, 8.1 | 2.1, 8.1 |
| (micron) | D 90 < 10 | | | | |
| Persistent foam | 60 | nil | nil | nil | nil |
| in ml (after 1 | | | | | |
| minute) max. | | | | | |

The composition of Fluxametamide 4% + Chlorantraniliprole 5% + Hexythiazox 4% OD meets all inhouse specifications for storage stability studies in laboratory (at 54 ± 2 C. & At 0 ± 2 C. for 14 days) and room temperature (for 12 months).

### Manufacturing Process for 100 kg Batch of Fluxametamide 4%+Chlorantraniliprole 5%+Hexythiazox 4% OD=(T2)

### Step 1: 15% Bentonite Clay Solution Preparation:

15 kg of Precipitated Silica was added in to 85 kg of Methylated seed oil and also and homogenized till it gets completely dissolved. It must be kept for 12-18 hour prior to use.

### Step 2: OD Premix:

53.0 kg of Methylated seed oil charged into a designated vessel for OD production.

Now 10.0 kf of Polyoxyethylene sorbitol hexaoleate, 1.50 kg of Styrene acrylic polymer, 8.50 kg of Ethoxylated sorbitan ester, 2.50 kg of Salts of polyolefin condensates and 0.15 kg of Polydimethyl siloxane were added and homogenised the contents for 45-60 minutes using high shear homogeniser. 4.0 kg of Fluxametamide, 5.0 kg of Chlorantraniliprole and 4.0 kg of Hexythiazox were added into this premix and homogenized for 30-45 minutes. Remaining 0.15 kg of Silicon antifoam and 10 kg of 15% Silica solution were added after milling to avoid foaming and sent for QC for quality check.

| Chemical composition | Percent (w/w) |
|---|---|
| Fluxametamide a.i. | 2.00 |
| Cyantraniliprole a.i. | 4.50 |
| Diafenthiuron a.i. | 20.00 |
| Methylated seed oil, | 5.00 |
| polyalkyleneoxide modified | |
| trisiloxane (super wetting- | |
| spreading-penetrating agent) | |
| Tristyryl phenol ethoxylate | 3.50 |
| phosphate esters | |
| (dispersing agent I) | |
| Sodium salt of polycarboxylate | 1.50 |
| (dispersing agent II) | |
| Aluminum magnesium | 0.50 |
| silicate (suspending agent) | |
| Polydimethylsiloxane | 0.30 |
| (anti foaming agent) | |
| sodium benzoate (preservative) | 0.15 |
| Polypropylene glycol | 5.00 |
| (anti freezing agent) | |
| Xanthan gum (thickner) | 0.15 |
| Diluent water | 57.35 |
| Total | 100.00 |

### Active Ingredient on 100% Purity Basis

Storage stability of composition of T8 = Fluxametamide
2% + Cyantraniliprole 4.5% + Diafenthiuron 20% SC
Laboratory storage stability for 14 days

| | Specification | | Stability at | Stability at |
|---|---|---|---|---|
| Parameters | (in house) | Initial | 54 ± 2° C | 0 ± 2° C. |
| Fluxametamide a.i. | 1.90 to 2.20 | 2.15 | 2.11 | 2.14 |
| Cyantraniliprole a.i. | 4.23 to 4.95 | 4.70 | 4.60 | 4.70 |
| Diafenthiuron a.i. | 19.0 to 21.0 | 20.40 | 20.30 | 20.39 |
| Fluxametamide | 80 | 98.75 | 98.30 | 98.50 |
| suspensibility (%) | | | | |
| Cyantraniliprole | 80 | 98.95 | 98.50 | 98.60 |
| suspensibility (%) | | | | |
| Diafenthiuron | 80 | 98.70 | 98.10 | 98.65 |
| suspensibility (%) | | | | |
| pH range | 4.5 to 7.0 | 5.50 | 5.50 | 5.50 |
| (1% aq. Suspension) | | | | |
| Pourability (%) | 95 | 98.20 | 98.00 | 97.60 |
| Specific gravity | 1.05-1.10 | 1.08 | 1.08 | 1.08 |
| Viscosity at spindle | 350-800 cps | 540 | 555 | 550 |
| no. 62, 20 rpm | | | | |
| Particle size (micron) | D 50 < 3, | 2.1, 8.4 | 2.2, 8.5 | 2.2, 8.5 |
| | D 90 < 10 | | | |
| Persistent foam ml | 60 | nil | nil | nil |
| (after 1 minute) max. | | | | |

Room temperature storage stability up to 12 months

| | Specification | | 1 | 6 | 12 |
|---|---|---|---|---|---|
| Parameters | (in house) | Initial | month | month | month |
| Fluxametamide a.i. | 1.90 to 2.20 | 2.15 | 2.15 | 2.14 | 2.14 |
| Cyantraniliprole a.i. | 4.23 to 4.95 | 4.70 | 4.70 | 4.70 | 4.65 |
| Diafenthiuron a.i. | 19.0 to 21.0 | 20.40 | 20.40 | 20.40 | 20.35 |
| Fluxametamide | 80 | 98.75 | 98.75 | 98.70 | 98.65 |
| suspensibility (%) | | | | | |
| Cyantraniliprole | 80 | 98.95 | 98.90 | 98.85 | 98.80 |
| suspensibility (%) | | | | | |
| Diafenthiuron | 80 | 98.70 | 98.70 | 98.70 | 98.65 |
| suspensibility (%) | | | | | |
| pH range | 4.5 to 7.0 | 5.50 | 5.50 | 5.50 | 5.65 |
| (1% aq. Suspension) | | | | | |
| Pourability (%) | 95 | 98.20 | 98.20 | 98.20 | 98.10 |
| Specific gravity | 1.05-1.10 | 1.08 | 1.08 | 1.08 | 1.08 |
| Viscosity at spindle | 350-800 cps | 540 | 540 | 540 | 545 |
| no. 62, 20 rpm | | | | | |
| Particle size | D 50 < 3, | 2.1, 8.4 | 2.1, 8.4 | 2.1, 8.4 | 2.1, 8.4 |
| (micron) | D 90 < 10 | | | | |
| Persistent foam | 60 | nil | nil | nil | nil |
| in ml (after 1 | | | | | |
| minute) max. | | | | | |

The composition of Fluxametamide 2% + Cyantraniliprole 4.5% + Diafenthiuron 20% SC meets the all in house specifications for storage stability studies in laboratory (at 54 ± 2 C. & At 0 ± 2 C. for 14 days) and room temperature (for 12 months).

### Manufacturing Process for 100 kg Batch of Fluxametamide 2%+Cyantraniliprole 4.5%+Diafenthiuron 20% SC (T8)

Step 1: 2% Gum Solution: Xanthan gum (2.0 kg) and sodium benzoate (2.0 kg) were charged into 96.0 kg water and homogenized. It was made 12-18 hour prior to use.

Step 2: DM water (49.80 kg) and 1,2-propylene glycol (5 kg) were charged into designated vessel and mixed thoroughly.

Step 3: Sodium salt of polycarboxylate (1.5 kg), Tristyryl phenol ethoxylate phosphate esters (3.5 kg), Dioctyl sulfosuccinate (2.0 kg) and Aluminum magnesium silicate (0.5 kg) were added into the vessel having water and homogenised the contents for 45-60 minutes using high shear homogeniser.

Step 4: Then Fluxametamide (2.0 kg), Cyantraniliprole (4.50 kg) and Diafenthiuron (20.0 kg) were added to this premix slowly and homogenised to get uniform slurry ready for grinding.

Step 5: Before grinding half the quantity of Polydimethylsiloxane (0.15 kg) was added and then material was subjected to grinding in Dyno mill till desired particle size is achieved.

Step 6: Remaining Polydimethyl siloxane (0.15 kg) antifoam was added after grinding process completes and before sampling for in process analysis.

Step 7: Finally 7.5 kg of 2% Xanthum gum solution and 5.0 kg of Methylated seed oil, polyalkyleneoxide modified trisiloxaneto were added to the formulation and homogenized for 30 minutes.

Step 8: QC for quality check was done.

TABLE 3
Treatment details

| | | Rate (ml | |
|---|---|---|---|
| Treatment | | or g per | gram actives |
| Number | Treatment compositions | hectare) | per hectare |
| T1 | Fluxametamide 4% + | 500 | 20 + 25 + 20 |
| | Chlorantraniliprole 5% + | | |
| | Fenpyroximate 4% OD | | |
| T2 | Fluxametamide 4% + | 500 | 20 + 25 + 20 |
| | Chlorantraniliprole 5% + | | |
| | Hexythiazox 4% OD | | |
| T3 | Fluxametamide 4% + | 500 | 20 + 25 + 20 |
| | Chlorantraniliprole 5% + | | |
| | Etoxazole 5% SC | | |
| T4 | Fluxametamide 2% + | 1000 | 20 + 25 + 200 |
| | Chlorantraniliprole 2.5% + | | |
| | Diafenthiuron 20% SC | | |
| T5 | Fluxametamide 4% + | 500 | 20 + 45 + 20 |
| | Cyantraniliprole 9% + | | |
| | Fenpyroximate 4% OD | | |
| T6 | Fluxametamide 4% + | 500 | 20 + 45 + 20 |
| | Cyantraniliprole 9% + | | |
| | Hexythiazox 4% OD | | |
| T7 | Fluxametamide 4% + | 500 | 20 + 45 + 20 |
| | Cyantraniliprole 9% + | | |
| | Etoxazole 5% SC | | |
| T8 | Fluxametamide 2% + | 1000 | 20 + 45 + 200 |
| | Cyantraniliprole 4.5% + | | |
| | Diafenthiuron 20% SC | | |
| T9 | Chlorantraniliprole 10% + | 250 | 25 + 20 |
| | Fenpyroximate 8% OD | | |
| T10 | Chlorantraniliprole 10% + | 250 | 25 + 20 |
| | Hexythiazox 8% OD | | |
| T11 | Chlorantraniliprole 10% + | 250 | 25 + 20 |
| | Etoxazole 8% SC | | |
| T12 | Chlorantraniliprole 5% + | 500 | 25 + 200 |
| | Diafenthiuron 40% SC | | |
| T13 | Cyantraniliprole 9% + | 500 | 45 + 20 |
| | Fenpyroximate 4% OD | | |
| T14 | Cyantraniliprole 9% + | 500 | 45 + 20 |
| | Hexythiazox 4% OD | | |
| T15 | Cyantraniliprole 9% + | 500 | 45 + 20 |
| | Etoxazole 5% SC | | |
| T16 | Cyantraniliprole 9% + | 500 | 45 + 200 |
| | Diafenthiuron 40% SC | | |
| T17 | Fluxametamide 8% + | 250 | 20 + 25 |
| | Chlorantraniliprole 10% OD | | |
| T18 | Fluxametamide 4% + | 500 | 20 + 45 |
| | Cyantraniliprole 9% OD | | |
| T19 | Fluxametamide 10% EC | 200 | 20 |
| T20 | Chlorantraniliprole | 125 | 25 |
| | 18.5% w/w (20% w/v) SC | | |
| T21 | Cyantraniliprole | 450 | 45 |
| | 10.26% w/w (10% w/v ) SC | | |
| T22 | Fenpyroximate 5% EC | 400 | 20 |
| T23 | Hexythiazox 5% SC | 400 | 20 |
| T24 | Etoxazole 10% SC | 200 | 20 |
| T25 | Diafenthiuron 50% WP | 400 | 200 |
| T26 | Untreated Check (UTC) | — | — |

WG-wettable granule, WP-wettable powder. T1 to T8 are inventive compositions, T9 to T18 are known compositions, T19 to T25 are market products.

TABLE 4a
Control of red spider mite control in brinjal

Red spider mite control(%) at 7 DAA

| Treatment | | Expected/ | Colby's | Synergism |
|---|---|---|---|---|
| Number | Observed | Calculated | ratio | (Y/N) |
| T1 | 95.2 | 87.6 | 1.09 | Y |
| T2 | 96.4 | 87.8 | 1.10 | Y |
| T3 | 95.4 | 87.7 | 1.09 | Y |
| T4 | 92.2 | 85.5 | 1.08 | Y |
| T5 | 98.4 | 88.7 | 1.11 | Y |
| T6 | 99.2 | 88.9 | 1.12 | Y |
| T7 | 98.8 | 88.8 | 1.11 | Y |
| T8 | 94.6 | 86.8 | 1.09 | Y |
| T9 | 67.6 | 68.4 | 0.99 | |
| T10 | 68.2 | 69.0 | 0.99 | |
| T11 | 66.6 | 68.6 | 0.97 | |
| T12 | 62.4 | 63.1 | 0.99 | |
| T13 | 70.8 | 71.2 | 0.99 | |
| T14 | 71.2 | 71.7 | 0.99 | |
| T15 | 70.6 | 71.3 | 0.99 | |
| T16 | 65.4 | 66.3 | 0.99 | |
| T17 | 64.8 | 65.0 | 1.00 | |
| T18 | 67.8 | 68.1 | 1.00 | |
| T19 | 60.8 | | | |
| T20 | 10.8 | | | |
| T21 | 18.6 | | | |
| T22 | 64.6 | | | |
| T23 | 65.2 | | | |
| T24 | 64.8 | | | |
| T25 | 58.6 | | | |
| T26 | 0.0 | | | |

All the inventive compositions (T1 to T8) provide synergistic control of red spider mite in brinjal crop.

TABLE 4b
Efficacy against shoot and fruit borer
damage and yield in brinjal corp

| | | | Number of | |
|---|---|---|---|---|
| | | | healthy | Increase (%) |
| Treatment | Shoot | Fruit | fruits per | in fruits |
| Number | damage (%) | damage (%) | five plants | over UTC |
| T1 | 0.0 | 0.0 | 82.5 | 93.7 |
| T2 | 0.0 | 0.0 | 81.7 | 91.8 |
| T3 | 0.0 | 0.0 | 80.9 | 89.9 |
| T4 | 0.0 | 0.0 | 83.2 | 95.3 |
| T5 | 0.0 | 0.0 | 79.8 | 87.3 |
| T6 | 0.0 | 0.0 | 78.7 | 84.7 |
| T7 | 0.0 | 0.0 | 80.3 | 88.5 |
| T8 | 0.0 | 0.0 | 81.1 | 90.4 |
| T9 | 0.86 | 0.77 | 71.6 | 68.1 |
| T10 | 0.88 | 0.72 | 70.4 | 65.3 |
| T11 | 0.83 | 0.75 | 69.7 | 63.6 |
| T12 | 0.91 | 0.80 | 72.1 | 69.2 |
| T13 | 1.13 | 0.96 | 68.4 | 60.6 |
| T14 | 1.17 | 0.98 | 67.5 | 58.5 |
| T15 | 1.22 | 1.10 | 66.9 | 57.0 |
| T16 | 1.10 | 0.95 | 68.9 | 61.7 |
| T17 | 0.43 | 0.24 | 74.8 | 75.6 |
| T18 | 0.52 | 0.30 | 72.7 | 70.7 |
| T19 | 2.15 | 1.97 | 58.7 | 37.8 |
| T20 | 1.46 | 1.25 | 62.4 | 46.5 |
| T21 | 1.96 | 1.73 | 60.5 | 42.0 |
| T22 | 7.94 | 6.85 | 47.8 | 12.2 |
| T23 | 8.12 | 7.17 | 48.6 | 14.1 |
| T24 | 7.82 | 6.88 | 47.9 | 12.4 |
| T25 | 6.82 | 5.84 | 50.2 | 17.8 |
| T26 | 11.83 | 12.26 | 42.6 | 0.0 |

All the inventive compositions (T1 to T8) provided excellent control of shoot and fruit borer and also produced highest number of marketable fruits per plant.

Conclusion: Among the various compositions as shown in Table 3, T1-T8 are the present compositions which showed excellent synergism and effectiveness against red spider mite, shoot and fruit borer in brinjal crop. The control of red spider mite at 7 DAA (days after application) was observed more than 92% among T1-T8 compositions. Moreover, T6 proved the maximum control which is 99.2% followed by T7 (98.8%) and T5 (98.4%) against red spiter mite as well as depicting >1 Colby's ratio proving effective synergism when compared with the known and market products.

Furthermore, T1-T8 showed excellent control against shoot and fruit borer which turned out to be 0% shoot and fruit damage as compared to other known and market products. In addition to that, T1-T8 depicted more than 78 healthy fruits per five plants from which T4 proved 83.2 of healthy fruits per five plants followed by T1 (82.5) and T2 (81.7). Moreover, T1-T8 showed maximum number of increment (>80%) in fruits over UTC (untreated check). Especially, T4 showed 95.3% followed by T1 (93.7%) and T2 (91.8%) increase in fruits over UTC when compared to other known and market products.

### Example 3: Pod Borer Larval Control and Yield in Red Gram

Crop: Redgram
Location: Sinor, Gujarat
Treatments: 26
Crop age: 110 days after sowing.
Spray water volume: 500 liter per hectare
Method of application: Foliar spray with battery operated knapsack sprayer fitted with hollow cone nozzle.

### Observation Methods:

Pod borer (Helicoverpa armigera) larval control (%): Count the number of live larvae per plant. Record observations from 10 plants per plot on 14^{th} days after application.

$$\% Larval control = 100 - \frac{Number of live larva in treatment}{Number of live larva in untreated control} \times 100$$

Pod count: Count the number of healthy pods of redgram per plant. Record the observations form 10 plants per plot.

### T4 Composition for Fluxametamide 4%+Chlorantraniliprole 4%+Indoxacarb 8% SE

| Chemical composition | Percent (w/w) |
|---|---|
| Fluxametamide a.i. | 4.00 |
| Chlorantraniliprole a.i. | 4.00 |
| Indoxacarb a.i. | 8.00 |
| Polyarylphenyl anionic ether | 1.50 |
| sulfate, ammonium salt | |
| (Emulsifier-2) | |
| Aromatic solvent C-9 | 15.00 |
| Acrylic graft copolymer | 3.00 |
| (dispersing agent I) | |
| Butyl Polyalkylene Oxide block | 4.50 |
| copolymer (dispersing agent II) | |
| Aluminum magnesium silicate | 0.50 |
| (suspending agent) | |
| Polydimethylsiloxane | 0.20 |
| (anti foaming agent) | |
| 1,2-benzisothiazolin-3(2H)-one | 0.15 |
| (preservative) | |
| Polypropylene glycol | 5.00 |
| (anti freezing agent) | |
| Xanthan gum (thickner) | 0.15 |
| Diluent water | 54.00 |
| Total | 100.00 |

Active ingredient on 100% purity basis

Storage stability-T4 = Fluxametamide
4% + Chlorantraniliprole 4% + Indoxacarb 8% SE
Laboratory storage stability for 14 days

| | Specification | | Stability at | Stability at |
|---|---|---|---|---|
| Parameters | (in house) | Initial | 54 ± 2° C. | 0 ± 2° C. |
| Fluxametamide a.i. | 3.80 to 4.40 | 4.25 | 4.20 | 4.25 |
| Chlorantraniliprole a.i. | 3.80 to 4.40 | 4.30 | 4.25 | 4.30 |
| Indoxacarb a.i. | 7.60 to 8.80 | 8.40 | 8.30 | 8.40 |
| Fluxametamide | 80 | 98.90 | 97.50 | 98.50 |
| suspensibility (%) | | | | |
| Chlorantraniliprole | 80 | 99.00 | 97.90 | 98.60 |
| suspensibility (%) | | | | |
| Indoxacarb | 80 | 98.50 | 97.60 | 98.30 |
| suspensibility (%) | | | | |
| pH range | 5.5 to 8.0 | 7.10 | 7.00 | 7.10 |
| (1% aq. Suspension) | | | | |
| Pourability (%) | 95 | 98.20 | 98.20 | 97.80 |
| Specific gravity | 1.05-1.10 | 1.07 | 1.07 | 1.07 |
| Viscosity at spindle | 350-800 cps | 550 | 560 | 560 |
| no. 62, 20 rpm | | | | |
| Particle size (micron) | D 50 < 3, | 2.1, 8.2 | 2.2, 8.5 | 2.1, 8.2 |
| | D 90 < 10 | | | |
| Persistent foam ml | 60 | nil | nil | nil |
| (after 1 minute) max. | | | | |

### Room Temperature Storage Stability Up to 12 Months

| | Specification | | 1 | 6 | 12 |
|---|---|---|---|---|---|
| Parameters | (in house) | Initial | month | month | month |
| Fluxametamide a.i. | 3.80 to 4.40 | 4.25 | 4.25 | 4.24 | 4.24 |
| Chlorantraniliprole | 3.80 to 4.40 | 4.30 | 4.30 | 4.30 | 4.29 |
| a.i. | | | | | |
| Indoxacarb a.i. | 7.60 to 8.80 | 8.40 | 8.40 | 8.40 | 8.38 |
| Fluxametamide | 80 | 98.90 | 98.70 | 98.70 | 98.50 |
| suspensibility (%) | | | | | |
| Chlorantraniliprole | 80 | 99.00 | 98.90 | 98.80 | 98.70 |
| suspensibility (%) | | | | | |
| Indoxacarb | 80 | 98.50 | 98.40 | 98.40 | 98.40 |
| suspensibility (%) | | | | | |
| pH range | 5.5 to 8.0 | 7.10 | 7.10 | 7.10 | 7.08 |
| (1% aq. Suspension) | | | | | |
| Pourability (%) | 95 | 98.20 | 98.20 | 98.20 | 98.20 |
| Specific gravity | 1.05-1.10 | 1.07 | 1.07 | 1.07 | 1.07 |
| Viscosity at spindle | 350-800 cps | 550 | 550 | 550 | 555 |
| no. 62, 20 rpm | | | | | |
| Particle size | D 50 < 3, | 2.1, 8.2 | 2.1, 8.2 | 2.1, 8.2 | 2.1, 8.2 |
| (micron) | D 90 < 10 | | | | |
| Persistent foam | 60 | nil | nil | nil | nil |
| in ml (after 1 | | | | | |
| minute) max. | | | | | |

The composition of Fluxametamide 4% + Chlorantraniliprole 4% + Indoxacarb 8% SE meets all inhouse specifications for storage stability studies in laboratory (at 54 ± 2° C. & At 0 ± 2 C. for 14 days) and room temperature (for 12 months).

### Manufacturing Process for 100 kg Batch of Fluxametamide 4%+Chlorantraniliprole 4%+Indoxacarb 8% SE (T4)

Step 1-2% Gum Solution: 2 kg Xanthan gum and 2 kg 1,2-benzisothiazoline-3-one were charged into 96 kg water and homogenized and it made 12-18 hour prior to use.

Step 2: EC premix-15.0 kg of Aromatic solvent was added into other vessel having slow stirring. Now 4.0 kg of Fluxametamide 8.0 kg of Indoxacarb and 4.5 kg of Butyl Polyalkylene Oxide block copolymer were added and mixed properly for 30-45 minutes

Step 3—46.5 kg of DM water and 5 kg of 1,2-propylene glycol were charged into designated vessel and mixed thoroughly.

Step 4—0.5 kg of Aluminum magnesium silicate, 3.0 kg of Acrylic graft copolymer, 1.50 kg of Polyarylphenyl anionic ether sulfate, ammonium salt and 0.10 kg of Polydimethylsiloxane were added into the vessel having water and homogenised the contents for 45-60 minutes using high shear homogeniser.

Step 5—Then 4.0 kg of Chlorantraniliprole was added to this premix slowly and homogenised to get uniform slurry ready for grinding.

Step 6—Before grinding half the quantity of antifoam was added and then material was subjected to grinding in Dyno mill till desired particle size was achieved.

Step 7—Remaining 0.10 kg of Polydimethyl siloxane antifoam was added after grinding process completes and before sampling for in process analysis.

Step 8: Now EC premix was mixed to this milled slurry under slow stirring and homogenize for 30-45 minutes

Step 7—Finally 7.5 kg of 2% gum solution was added to this formulation and sent to QC for quality check.

T5 composition for Fluxametamide 10%+Cyantraniliprole 20%+Emamectin benzoate 3.75% WG

| Chemical composition | Percent (w/w) |
|---|---|
| Fluxametamide a.i. | 10.00 |
| Cyantraniliprole a.i. | 20.00 |
| Emamectin Benzoate a.i. | 3.75 |
| Sodium naphthalene sulphonate | 6.00 |
| formaldehyde condensate | |
| (dispersing agent I) | |
| Sodium Polycarboxylate | 5.00 |
| (dispersing agent II) | |
| Sodium lauryl sulfate | 5.00 |
| (wetting Agent) | |
| Polydimethylsiloxane | 1.00 |
| (antifoaming Agent) | |
| Corn Starch | 20.00 |
| China Clay | 29.25 |
| Total | 100.00 |

Active ingredient on 100% purity basis

Storage Stability: T5 = Fluxametamide 10% +
Cyantraniliprole 20% + Emamectin benzoate 3.75% WG
Laboratory storage stability for 14 days

| | Specification | | Stability at | Stability at |
|---|---|---|---|---|
| Parameters | (in house) | Initial | 54 ± 2° C. | 0 ± 2° C. |
| Fluxametamide a.i. | 9.5 to 10.5 | 10.30 | 10.15 | 10.30 |
| Cyantraniliprole a.i. | 19.0 to 21.0 | 20.45 | 20.30 | 20.45 |
| Emamectin Benzoate a.i. | 3.56 to 4.13 | 3.90 | 3.85 | 3.90 |
| Fluxametamide | 70 | 98.30 | 97.50 | 98.10 |
| suspensibility (%) | | | | |
| Cyantraniliprole | 70 | 98.20 | 97.40 | 98.20 |
| suspensibility (%) | | | | |
| Emamectin Benzoate | 70 | 99.00 | 98.10 | 99.00 |
| suspensibility (%) | | | | |
| pH range (1% aq. | 5 to 9 | 7.10 | 7.00 | 7.10 |
| Suspension) | | | | |
| Wettability | Max 30 s | 10 | 13 | 12 |
| Wet Sieve(45 micron) | Mini 98.5% | 99.6 | 99.2 | 99.5 |
| Bulk Density | 0.45-0.85 | 0.5 | 0.5 | 0.5 |
| Moisture Content | Max 2.0% | 1.5 | 1.2 | 1.2 |
| Persistent foam ml (after 1 | 60 | nil | 2 ml | nil |
| minute) max. | | | | |

Room temperature storage stability up to 12 months

| | Specification | | 1 | 6 | 12 |
|---|---|---|---|---|---|
| Parameters | (in house) | Initial | month | month | month |
| Fluxametamide a.i. | 9.5 to | 10.30 | 10.30 | 10.30 | 10.25 |
| | 10.5 | | | | |
| Cyantraniliprole a.i. | 19.0 to | 20.45 | 20.45 | 20.40 | 20.40 |
| | 21.0 | | | | |
| Emamectin Benzoate | 3.56 to | 3.90 | 3.90 | 3.90 | 3.90 |
| a.i. | 4.13 | | | | |
| Fluxametamide | 70 | 98.30 | 98.30 | 98.30 | 98.20 |
| suspensibility (%) | | | | | |
| Cyantraniliprole | 70 | 98.20 | 98.20 | 98.10 | 98.10 |
| suspensibility (%) | | | | | |
| Emamectin Benzoate | 70 | 99.00 | 98.90 | 98.90 | 98.90 |
| suspensibility (%) | | | | | |
| pH range (1% aq. | 5 to | 7.10 | 7.10 | 7.10 | 7.10 |
| Suspension) | 9 | | | | |
| Wettability | Max 30 s | 10 | 10 | 10 | 11 |
| Wet Sieve(45 micron) | Mini | 99.6 | 99.6 | 99.6 | 99.5 |
| | 98.5% | | | | |
| Bulk Density | 0.45-0.85 | 0.5 | 0.5 | 0.5 | 0.5 |
| Moisture Content | Max 2.0% | 1.5 | 1.5 | 1.5 | 1.5 |
| Persistent foam ml | 60 | nil | nil | nil | nil |
| (after 1 minute) max. | | | | | |

The composition of Fluxametamide 10% + Cyantraniliprole 20% + Emamectin benzoate 3.75% WG meets all inhouse specifications for storage stability studies in laboratory (at 54 ± 2 C. & At 0 ± 2 C. for 14 days) and room temperature (for 12 months).

### Manufacturing Process for 100 kg Batch of Fluxametamide 10%+Cyantraniliprole 20%+Emamectin Benzoate 3.75% WG (T5)

Step 1—29.25 kg China clay, 20.0 kg Corn starch, 0.5 kg silicone antifoam, 6 kg Sodium naphthalene sulphonate formaldehyde condensate, 5 kg Sodium Polycarboxylate were charged and 5.0 kg of Sodium lauryl sulfate was blended into a ribbon or premix blender and homogenization for 30 minutes.

Step 2—Now 10.0 kg Fluxametamide 1, 20 kg Cyantraniliprole and 3.75 kg Emamectin Benzoate were charged and again homogenized for 30 minutes and now this Pre-blended material was then grinded through Jet mill/air classifier mills. Finely grinded material was blended in post blender till it became homogeneous. (For approx 1.5 hr)

Step 3—Finely grinded powder was mixed with 10 kg of water having 0.5 kg silicone antifoam to form extrudable dough.

Step 4—Dough was passed through extruder to get granules of required size.

Step 5—Wet granules were passed through Fluidized bed drier to remove 10 kg extra water added and further graded using vibrating screens.

Step 6—Final product was sent for QC approval.

Step 7—After approval material was packed in required pack sizes.

TABLE 5
Treatment details

| | | Rate (ml | gram |
|---|---|---|---|
| Sr. | | or g per | actives per |
| No. | Treatment compositions | hectare) | hectare |
| T1 | Fluxametamide 10% + Chlorantraniliprole | 200 | 20 + 20 + 7.5 |
| | 10% + Emamectin benzoate 3.75% WG | | |
| T2 | Fluxametamide 4% + Chlorantraniliprole | 500 | 20 + 20 + 90 |
| | 4% + Methoxyfenozide 18% SC | | |
| T3 | Fluxametamide 4% + Chlorantraniliprole | 500 | 20 + 20 + 40 |
| | 4% + Spinosad 8% SC | | |
| T4 | Fluxametamide 4% + Chlorantraniliprole | 500 | 20 + 20 + 40 |
| | 4% + Indoxacarb 8% SE | | |
| T5 | Fluxametamide 10% + Cyantraniliprole | 200 | 20 + 40 + 7.5 |
| | 20% + Emamectin benzoate 3.75% WG | | |
| T6 | Fluxametamide 4% + Cyantraniliprole | 500 | 20 + 40 + 90 |
| | 8% + Methoxyfenozide 18% SC | | |
| T7 | Fluxametamide 4% + Cyantraniliprole | 500 | 20 + 40 + 40 |
| | 8% + Spinosad 8% SC | | |
| T8 | Fluxametamide 4% + Cyantraniliprole | 500 | 20 + 40 + 40 |
| | 4% + Indoxacarb 8% SE | | |
| T9 | Chlorantraniliprole 10% + Emamectin benzoate | 200 | 20 + 7.5 |
| | 3.75% WG | | |
| T10 | Chlorantraniliprole 4% + Methoxyfenozide 18% | 500 | 20 + 90 |
| | SC | | |
| T11 | Chlorantraniliprole 4% + Spinosad 8% SC | 500 | 20 + 40 |
| T12 | Chlorantraniliprole 4% + Indoxacarb 8% SE | 500 | 20 + 40 |
| T13 | Cyantraniliprole 20% + Emamectin benzoate | 200 | 40 + 7.5 |
| | 3.75% WG | | |
| T14 | Cyantraniliprole 8% + Methoxyfenozide 18% SC | 500 | 40 + 90 |
| T15 | Cyantraniliprole 8% + Spinosad 8% SC | 500 | 40 + 40 |
| T16 | Cyantraniliprole 4% + Indoxacarb 8% SE | 500 | 40 + 40 |
| T17 | Fluxametamide 10% EC + Chlorantraniliprole | 200 + 100 | 20 + 20 |
| | 20% SC | | |
| T18 | Fluxametamide 10% EC + Cyantraniliprole 10% | 200 + 400 | 20 + 40 |
| | SC | | |
| T19 | Fluxametamide 10% EC | 200 | 20 |
| T20 | Chlorantraniliprole 18.5% w/w (20% w/v) SC | 100 | 20 |
| T21 | Cyantraniliprole 10.26% w/w (10% w/v) SC | 400 | 40 |
| T22 | Emamectin benzoate 1.9% EC | 394.74 | 7.5 |
| T23 | Methoxyfenozide 24% SC | 375 | 90 |
| T24 | Spinosad 45% SC | 88.89 | 40 |
| T25 | Indoxacarb 15% SC | 266.67 | 40 |
| T26 | Untreated Check (UTC) | — | — |

WG-wettable granule. T1 to T8 are inventive compositions, T9 to T16 are known compositions, T17 and T18 are on farm tank mixes, T19 to T25 are market products.

TABLE 6
Pod borer larval control and pod yield in red gram

| | Pod borer larval control (%) at 14 DAA | | | | | |
|---|---|---|---|---|---|---|
| Sr. | | | Colby's | Synergism | Number of healthy | Increase (%) in |
| No. | Observed | Expected | ratio | (Y/N) | pods per plants | healthy pods over UTC |
| T1 | 100.0 | 84.7 | 1.18 | Y | 112.7 | 69.0 |
| T2 | 100.0 | 85.1 | 1.18 | Y | 113.2 | 69.7 |
| T3 | 100.0 | 85.9 | 1.16 | Y | 110.7 | 66.0 |
| T4 | 100.0 | 87.6 | 1.14 | Y | 115.3 | 72.9 |
| T5 | 100.0 | 82.1 | 1.22 | Y | 111.8 | 67.6 |
| T6 | 100.0 | 82.5 | 1.21 | Y | 110.5 | 65.7 |
| T7 | 100.0 | 83.5 | 1.20 | Y | 112.2 | 68.2 |
| T8 | 100.0 | 85.5 | 1.17 | Y | 113.1 | 69.6 |
| T9 | 69.8 | 70.5 | 0.99 | N | 92.7 | 39.0 |
| T10 | 70.2 | 71.2 | 0.99 | N | 93.2 | 39.7 |
| T11 | 70.4 | 72.7 | 0.97 | N | 94.1 | 41.1 |
| T12 | 73.4 | 76.1 | 0.96 | N | 92.7 | 39.0 |
| T13 | 63.2 | 65.4 | 0.97 | N | 89.7 | 34.5 |
| T14 | 60.8 | 66.2 | 0.92 | N | 92.5 | 38.7 |
| T15 | 66.8 | 68.1 | 0.98 | N | 90.7 | 36.0 |
| T16 | 71.4 | 72.0 | 0.99 | N | 93.7 | 40.5 |
| T17 | 72.4 | 74.4 | 0.97 | N | 94.3 | 41.4 |
| T18 | 68.6 | 70.1 | 0.98 | N | 92.7 | 39.0 |
| T19 | 48.2 | | | | 84.6 | 26.8 |
| T20 | 50.6 | | | | 83.9 | 25.8 |
| T21 | 42.2 | | | | 84.2 | 26.2 |
| T22 | 40.2 | | | | 81.2 | 21.7 |
| T23 | 41.6 | | | | 77.6 | 16.3 |
| T24 | 44.8 | | | | 82.3 | 23.4 |
| T25 | 51.6 | | | | 84.1 | 26.1 |
| T26 | 0.0 | | | | 66.7 | 0.0 |

All the inventive compositions (T1 to T8) provided synergistic and residual control of pod borer larvae and also yielded higher number of healthy pods per plant as compared to all known compositions, farm tank mixes and market products.

Conclusion: Among the various compositions as shown in Table 5 treatment number T1-T8 are considered to be present compositions which showed excellent synergism and effectiveness against pod borer larva control in red gram. Moreover, the control of pod borer at 14 DAA (days after application) showed 100% as compared to other known, farm tank mix and market products.

In addition to that, T1-T8 received more than 110 numbers of healthy pods per plants. Particularly, T4 received maximum 115.3 healthy pods per plants followed by T2 (113.2) and T8 (113.1). Furthermore, T1-T8 showed more than 65% of increment in healthy pods over UTC (untreated check). Especially, T4 exhibited 72.9% followed by T2 (69.7%) and T8 (69.6%) increase in healthy pods over UTC when compared to other known, farm tank mix and market products.

### Example 4: Whitefly and Fruit Borer Larval Control and Yield in Tomato

Crop: Tomato
Location: Dholka, Gujarat
Treatments: 26
Crop age: 96 days after transplanting.
Spray water volume: 510 liter per hectare
Method of application: Foliar spray with battery operated knapsack sprayer fitted with hollow cone nozzle.

### Observation Methods:

Whitefly (Bemesia tabaci) control (%): Count the number of live whitefly (nymphs and adults) per trifoliate leaves, record the observations from 3 leaves per plant and 10 plants per plot.

$$\% Whitefly control = 100 - \frac{Number of live whitefly in treated plot}{Number of live whitefly in untreated ( UTC ) plot} \times 100$$

Fruit borer larval control (%): same as given in example 1.
Healthy fruit count: count the number of healthy fruits per plant. Record the observations form 10 plants per plot.

TABLE 7
Treatment details

| | | Rate (ml | gram |
|---|---|---|---|
| Sr. | | or g per | actives per |
| No. | Treatment compositions | hectare) | hectare |
| T1 | Fluxametamide 4.5% + Chlorantraniliprole | 500 | 22.5 + 22.5 + 75 |
| | 4.5% + Pyrifluquinazon 15% WG | | |
| T2 | Fluxametamide 4.5% + Chlorantraniliprole | 500 | 22.5 + 22.5 + 40 |
| | 4.5% + Afidopyropen 8% OD | | |
| T3 | Fluxametamide 4.5% + Chlorantraniliprole | 500 | 22.5 + 22.5 + 60 |
| | 4.5% + Flonicamid 12% WG | | |
| T4 | Fluxametamide 2.25% + Chlorantraniliprole | 1000 | 22.5 + 22.5 + 60 |
| | 2.25% + Pyriproxyfen 6% SC | | |
| T5 | Fluxametamide 4.5% + Cyantraniliprole | 500 | 22.5 + 45 + 75 |
| | 9% + Pyrifluquinazon 15% WG | | |
| T6 | Fluxametamide 4.5% + Cyantraniliprole | 500 | 22.5 + 45 + 40 |
| | 4.5% + Afidopyropen 8% OD | | |
| T7 | Fluxametamide 4.5% + Cyantraniliprole | 500 | 22.5 + 45 + 60 |
| | 4.5% + Flonicamid 12% WG | | |
| T8 | Fluxametamide 2.25% + Cyantraniliprole | 1000 | 22.5 + 45 + 60 |
| | 4.5% + Pyriproxyfen 6% SC | | |
| T9 | Chlorantraniliprole 4.5% + Pyrifluquinazon | 500 | 22.5 + 75 |
| | 15% WG | | |
| T10 | Chlorantraniliprole 4.5% + Afidopyropen | 500 | 22.5 + 40 |
| | 8% OD | | |
| T11 | Chlorantraniliprole 4.5% + Flonicamid 12% | 500 | 22.5 + 60 |
| | WG | | |
| T12 | Chlorantraniliprole 2.25% + Pyriproxyfen | 1000 | 22.5 + 60 |
| | 6% SC | | |
| T13 | Cyantraniliprole 9% + Pyrifluquinazon 15% | 500 | 45 + 75 |
| | WG | | |
| T14 | Cyantraniliprole 4.5% + Afidopyropen 8% | 500 | 45 + 40 |
| | OD | | |
| T15 | Cyantraniliprole 4.5% + Flonicamid 12% | 500 | 45 + 60 |
| | WG | | |
| T16 | Cyantraniliprole 4.5% + Pyriproxyfen 6% | 1000 | 45 + 60 |
| | SC | | |
| T17 | Fluxametamide 22.5% + Chlorantraniliprole | 100 | 22.5 + 22.5 |
| | 22.5% WG | | |
| T18 | Fluxametamide 20% + Cyantraniliprole 40% | 100 | 20 + 40 |
| | WG | | |
| T19 | Fluxametamide 10% EC | 225 | 22.5 |
| T20 | Chlorantraniliprole 18.5% w/w (20% w/v) | 112.5 | 22.5 |
| | SC | | |
| T21 | Cyantraniliprole 10.26% w/w (10% w/v) | 400 | 40 |
| | SC | | |
| T22 | Pyrifluquinazon 20% WG | 375 | 75 |
| T23 | Afidopyropen 5% DC | 800 | 40 |
| T24 | Flonicamid 50% WG | 120 | 60 |
| T25 | Pyriproxyfen 10% EC | 600 | 60 |
| T26 | Untreated Check (UTC) | — | — |

DC-dispersible concentrate. T1 to T8 are inventive compositions, T9 to T18 are known compositions, T19 to T25 are market products.

TABLE 8
Whitefly, fruit borer larval control and yield in tomato

| | Whitefly control (%) | | | Fruit borer | | |
|---|---|---|---|---|---|---|
| Sr. | | | Colby's | larval | Number of healthy | Increase (%) in |
| No. | Observed | Expected | ratio | control (%) | fruits per plants | healthy fruits over UTC |
| T1 | 99.7 | 87.9 | 1.13 | 98.60 | 36.4 | 184.4 |
| T2 | 97.3 | 86.6 | 1.12 | 97.40 | 35.9 | 180.5 |
| T3 | 93.4 | 84.3 | 1.11 | 99.20 | 36.0 | 181.3 |
| T4 | 98.5 | 89.2 | 1.10 | 98.20 | 35.4 | 176.6 |
| T5 | 99.2 | 93.6 | 1.06 | 96.40 | 35.3 | 175.8 |
| T6 | 97.8 | 92.9 | 1.05 | 95.80 | 33.8 | 164.1 |
| T7 | 95.6 | 91.7 | 1.04 | 96.20 | 34.4 | 168.8 |
| T8 | 98.6 | 94.3 | 1.05 | 93.40 | 32.6 | 154.7 |
| T9 | 68.4 | 69.6 | 0.98 | 63.6 | 26.7 | 108.6 |
| T10 | 65.2 | 66.1 | 0.99 | 62.8 | 25.4 | 98.4 |
| T11 | 58.6 | 60.3 | 0.97 | 62.6 | 26.3 | 105.5 |
| T12 | 71.4 | 72.6 | 0.98 | 62.2 | 24.9 | 94.5 |
| T13 | 81.6 | 83.8 | 0.97 | 61.4 | 23.9 | 86.7 |
| T14 | 80.8 | 82.0 | 0.99 | 61.0 | 24.3 | 89.8 |
| T15 | 77.4 | 78.9 | 0.98 | 59.4 | 22.1 | 72.7 |
| T16 | 83.4 | 85.5 | 0.98 | 59.6 | 23.7 | 85.2 |
| T17 | 66.8 | 67.8 | 0.99 | 81.2 | 22.3 | 74.2 |
| T18 | 81.2 | 82.9 | 0.98 | 79.4 | 23.1 | 80.5 |
| T19 | 60.4 | | | 52.6 | 20.9 | 63.3 |
| T20 | 18.6 | | | 60.8 | 19.8 | 54.7 |
| T21 | 56.8 | | | 58.4 | 18.5 | 44.5 |
| T22 | 62.6 | | | 8.4 | 16.8 | 31.3 |
| T23 | 58.4 | | | 7.6 | 15.7 | 22.7 |
| T24 | 51.2 | | | 7.4 | 16.1 | 25.8 |
| T25 | 66.4 | | | 5.6 | 14.9 | 16.4 |
| T26 | 0.0 | | | 0.0 | 12.8 | 0.0 |

All the inventive compositions (T1 to T8) provided synergistic control of whitefly and fruit borer and also produced higher number of healthy fruits per plant in tomato.

Conclusion: Among the various compositions as shown in Table 7 treatment number T1-T8 are considered to be present compositions which showed excellent synergism and effectiveness against whitefly and fruit borer larva in tomato. The whitefly control was observed more than 93% for T1-T8. Particularly, T1 gave the maximum control 99.7% followed by T5 (99.2%) and T8 (98.6%) as well as the Colby's ratio was >1 showing effective synergism as compared with other known and market products. Furthermore, T1-T8 exhibited more than 93% of control on the fruit borer larva. Particularly, T3 showed 99.20% followed by T1 (98.60%) and T4 (98.20%) as compared to other known and market products. In addition to that, T1-T8 achieved more than 32 number of healthy fruits per plants whereas T1 exhibited 36.4 followed by T3 (36) and T2 (35.9) number of healthy fruits per plants. Furthermore, T1-T8 showed more than 154% of increment in healthy fruits over UTC (untreated check). Especially, T1 (184.4%) followed by T3 (181.3%) and T2 (180.5%) increase in healthy fruits over UTC when compared with the other known and market products.

### Example 5: Fruit Borer Larval Control in Okra

Crop: Okra
Location: Raipur, Chhattishgarh
Treatments: 26
Crop age: 64 days after sowing.
Spray water volume: 420 liter per hectare
Method of application: Foliar spray with battery operated knapsack sprayer fitted with hollow cone nozzle.

### Observation Methods:

Fruit borer (mixed infestation of Helicoverpa armigera and Spodoptera exigua) larval control (%): same as given in example 1.

TABLE 9
Treatment details

| | | Rate (ml | gram |
|---|---|---|---|
| Sr. | | or g per | actives per |
| No. | Treatment compositions | hectare) | hectare |
| T1 | Fluxametamide 5% + Tetraniliprole 4.5% + Bifenthrin | 500 | 25 + 22.5 + 40 |
| | 8% SC | | |
| T2 | Fluxametamide 5% + Tetraniliprole | 500 | 25 + 22.5 + 10 |
| | 4.5% + Deltamethrin 2% SC | | |
| T3 | Fluxametamide 5% + Tetraniliprole | 500 | 25 + 22.5 + 40 |
| | 4.5% + Thiamethoxam 8% SC | | |
| T4 | Fluxametamide 5% + Tetraniliprole 4.5% + Dinotefuran | 500 | 25 + 22.5 + 20 |
| | 4% SC | | |
| T5 | Fluxametamide 5% + Flubendiamide 4% + Bifenthrin | 500 | 25 + 20 + 40 |
| | 8% SC | | |
| T6 | Fluxametamide 5% + Flubendiamide | 500 | 25 + 20 + 10 |
| | 4% + Deltamethrin 2% SC | | |
| T7 | Fluxametamide 5% + Flubendiamide | 500 | 25 + 20 + 40 |
| | 4% + Thiamethoxam 8% SC | | |
| T8 | Fluxametamide 5% + Flubendiamide 4% + Dinotefuran | 500 | 25 + 20 + 20 |
| | 4% SC | | |
| T9 | Tetraniliprole 4.5% + Bifenthrin 8% SC | 500 | 22.5 + 40 |
| T10 | Tetraniliprole 4.5% + Deltamethrin 2% SC | 500 | 22.5 + 10 |
| T11 | Tetraniliprole 4.5% + Thiamethoxam 8% SC | 500 | 22.5 + 40 |
| T12 | Tetraniliprole 4.5% + Dinotefuran 4% SC | 500 | 22.5 + 20 |
| T13 | Flubendiamide 4% + Bifenthrin 8% SC | 500 | 20 + 40 |
| T14 | Flubendiamide 4% + Deltamethrin 2% SC | 500 | 20 + 10 |
| T15 | Flubendiamide 4% + Thiamethoxam 8% SC | 500 | 20 + 40 |
| T16 | Flubendiamide 4% + Dinotefuran 4% SC | 500 | 20 + 20 |
| T17 | Fluxametamide 5% + Chlorantraniliprole 3.6% SC | 500 | 25 + 18 |
| T18 | Fluxametamide 5% + Cyantraniliprole 8% SC | 500 | 25 + 40 |
| T19 | Fluxametamide 10% EC | 250 | 25 |
| T20 | Chlorantraniliprole 18.5% w/w (20% w/v) SC | 90 | 18 |
| T21 | Cyantraniliprole 10.26% w/w (10% w/v) SC | 400 | 40 |
| T22 | lambda cyhalothrin 5% EC | 200 | 10 |
| T23 | Abamectin 1.9% EC | 394.7 | 7.5 |
| T24 | Tolfenpyrad 15% EC | 600 | 90 |
| T25 | Fipronil 80% WG | 50 | 40 |
| T26 | Untreated Check (UTC) | — | — |

T1 to T8 are inventive compositions, T9 to T18 are known compositions, T19 to T25 are market products.

TABLE 10
Fruit borer larval control

Fruit borer larval control (%)

| Treatment | Control | Control | Colby's | Synergism |
|---|---|---|---|---|
| Number | observed | Expected | ratio | (Y/N) |
| T1 | 100.0 | 88.4 | 1.13 | Y |
| T2 | 100.0 | 86.0 | 1.16 | Y |
| T3 | 100.0 | 91.2 | 1.10 | Y |
| T4 | 100.0 | 88.4 | 1.13 | Y |
| T5 | 100.0 | 87.7 | 1.14 | Y |
| T6 | 100.0 | 85.2 | 1.17 | Y |
| T7 | 100.0 | 90.7 | 1.10 | Y |
| T8 | 100.0 | 87.7 | 1.14 | Y |
| T9 | 71.4 | 74.2 | 0.96 | N |
| T10 | 66.8 | 68.8 | 0.97 | N |
| T11 | 78.4 | 80.4 | 0.98 | N |
| T12 | 72.2 | 74.2 | 0.97 | N |
| T13 | 70.6 | 72.6 | 0.97 | N |
| T14 | 64.8 | 66.9 | 0.97 | N |
| T15 | 77.8 | 79.1 | 0.98 | N |
| T16 | 70.6 | 72.6 | 0.97 | N |
| T17 | 80.8 | 82.9 | 0.97 | N |
| T18 | 80.2 | 81.8 | 0.98 | N |
| T19 | 55.2 | | | |
| T20 | 61.8 | | | |
| T21 | 59.4 | | | |
| T22 | 32.4 | | | |
| T23 | 18.4 | | | |
| T24 | 48.6 | | | |
| T25 | 32.4 | | | |
| T26 | 0.0 | | | |

All the inventive compositions (T1 to T8) provided synergistic larval control in okra crop.

Conclusion: Among the various compositions as shown in Table 9 treatment number T1-T8 are considered to be present compositions which showed excellent synergism and effectiveness against fruit borer larva in okra. Moreover, T1-T8 showed excellent fruit borer control of 100% and achieved the Colby's ratio >1 depicting effective synergism when compared to other known and market products.

### Bio-Efficacy of Fluxametamide+at Least One Diamide Insecticide+at Least One Fungicide

### Example 6: Helicoverpa Larval, Leaf Spot Disease Control in Marigold

Crop: Marigold
Location: Umreth, Gujarat
Treatments: 16
Crop age: 60 days after transplanting.
Spray water volume: 440 liter per hectare
Method of application: Foliar spray with battery operated knapsack sprayer fitted with hollow cone nozzle.

### Observation Methods:

Larval control (%): as given in example 1.

Leaf and flower spot (Alternaria spp.): The observation on severity of Leaf and flower spot was recorded by observing 100 leaflet (plant) per plot (0 to 10 rating, 0-means no disease, 10-means plant completely damaged due to disease), and disease severity (PDI percent disease index) was calculated and disease control (%) or reduction over UTC plot were re-calculated. Observations recorded on 7 days after application.

$$Disease Severity ( \% ) or ( PDI ) = \frac{Sum of total rating \times 100}{Total number of leaflet / plants observed \times Maximum disease rating}$$

$$\% Disease control = 100 - \frac{PDI ( \% Disease severity ) in treatment}{PDI ( \% Disease severity ) in untreated} \times 100$$

Foliage feeder larval control (%): Count the number of live larvae per plant, record

TABLE 11
Treatment details

| | | Rate (ml | gram |
|---|---|---|---|
| Sr. | | or g per | actives per |
| No. | Treatment compositions | hectare) | hectare |
| T1 | Fluxametamide 5.5% + Chlorantraniliprole | 500 | 27.5 + 20 + 80 |
| | 4% + Pyraclostrobin 16% SC | | |
| T2 | Fluxametamide 5.5% + Cyantraniliprole | 500 | 27.5 + 40 + 80 |
| | 8% + Pyraclostrobin 16% SC | | |
| T3 | Fluxametamide 3.67% + Tetraniliprole | 750 | 27.5 + 25 + 80 |
| | 3.33% + Pyraclostrobin 10.67% SC | | |
| T4 | Fluxametamide 5.5% + Flubendiamide | 500 | 27.5 + 25 + 80 |
| | 5% + Pyraclostrobin 16% WG | | |
| T5 | Fluxametamide 4.4% + Chlorantraniliprole | 625 | 27.5 + 20 + 112.5 |
| | 3.2% + Azoxystrobin 18% SC | | |
| T6 | Fluxametamide 4.4% + Cyantraniliprole | 625 | 27.5 + 40 + 112.5 |
| | 6.4% + Azoxystrobin 18% SC | | |
| T7 | Fluxametamide 4.4% + Tetraniliprole | 625 | 27.5 + 25 + 112.5 |
| | 4% + Azoxystrobin 18% SC | | |
| T8 | Fluxametamide 4.4% + Flubendiamide | 625 | 27.5 + 25 + 112.5 |
| | 4% + Azoxystrobin 18% SC | | |
| T9 | Fluxametamide 10% EC | 275 | 27.5 |
| T10 | Pyraclostrobin 20% WG | 400 | 80 |
| T11 | Azoxystrobin 25% SC | 450 | 112.5 |
| T12 | Chlorantraniliprole 20% SC | 100 | 20 |
| T13 | Cyantraniliprole 10% OD | 400 | 40 |
| T14 | Tetraniliprole 20% SC | 125 | 25 |
| T15 | Flubendiamide 20% WG | 125 | 25 |
| T16 | Untreated Check (UTC) | — | — |

T1 to T8 are inventive compositions and T9-T15 is market products.

TABLE 12
Larval control and leaf and flower spot disease control in marigold

| | Helicoverpa | | Leaf and flower | Number of |
|---|---|---|---|---|
| | larval | | spot disease | marketable |
| Treatment | control (%) | Synergism | control (%) | flower per |
| number | observed | (Y/N) | observed | plant |
| T1 | 98.6 | Y | 92.4 | 25.7 |
| T2 | 95.2 | Y | 91.8 | 24.9 |
| T3 | 97.4 | Y | 93.4 | 25.3 |
| T4 | 93.2 | Y | 91.6 | 23.6 |
| T5 | 99.2 | Y | 92.2 | 25.3 |
| T6 | 96.4 | Y | 93.4 | 24.1 |
| T7 | 98.0 | Y | 91.8 | 23.2 |
| T8 | 94.4 | Y | 91.6 | 22.8 |
| T9 | 44.8 | | 6.8 | 12.7 |
| T10 | 4.6 | | 88.4 | 15.6 |
| T11 | 6.2 | | 89.6 | 16.1 |
| T12 | 66.4 | | 4.2 | 13.9 |
| T13 | 63.8 | | 3.8 | 14.2 |
| T14 | 65.2 | | 4.6 | 11.8 |
| T15 | 60.2 | | 3.2 | 12.3 |
| T16 | 0.0 | | 0.0 | 9.3 |

All the inventive compositions (T1 to T8) provided excellent synergistic control of Helicoverpa larvae and leaf and flower spot diseases and also produce highest number of marketable flowers per plant.

Conclusion: Among the various compositions as shown in Table 11 treatment number T1-T8 are considered to be present compositions which showed excellent synergism and effectiveness against helicoverpa larva and leaf and flower spot disease in marigold. Furthermore, T1-T8 showed more than 93% control on helicoverpa larva in marigold. Particularly, T5 depicted 99.2% followed by T1 (98.6%) and T7 (98.0%) control on helicoverpa larva in marigold as compared to other compositions mentioned in Table 12.

In addition to that, T1-T8 pointed more than 91% of leaf and flower spot disease control. Particularly, T3 and T6 proved 93.4% and T1 showed 92.4% of control on leaf and flower spot disease on marigold whereas the number of marketable flower per plant for T1-T8 were between 22-26 from which T1 depicted 25.7 followed by T3 and T5 both showing 25.3 number of marketable flower per plant when compared with other T9-T16 compositions as shown in Table 12.

### Example 7: Pod Borer and Leaf Spot Disease in Green Gram

Crop: Green gram
Location: Karjan, Gujarat
Treatments: 16
Crop age: 60 days after transplanting.
Spray water volume: 400 liter per hectare
Method of application: Foliar spray with battery operated knapsack sprayer fitted with hollow cone nozzle.

### Observation Methods:

Spodoptera exigua Larval control (%): as given in example 1.
Leaf spot (Cercospora spp.) control: as given in example 6.

T4 composition for Fluxametamide 11% + Flubendiamide
10% + Fluxapyroxad 30% WG

| Chemical composition | Percent (w/w) |
|---|---|
| Fluxametamide a.i. | 11.00 |
| Flubendiamide a.i. | 10.00 |
| Fluxapyroxad a.i. | 30.00 |
| Modified Sodium lignosulphonate (dispersing agent | 7.00 |
| I) | |
| Modified polyacrylate copolymer (dispersing agent | 3.00 |
| II) | |
| Sodium isopropyl naphthalene sulfonate (wetting | 5.00 |
| agent) | |
| Polydimethylsiloxane (Antifoaming Agent) | 1.00 |
| Corn Starch | 15.00 |
| China clay | 18.00 |
| Total | 100.00 |

active ingredient on 100% purity basis

Storage Stability: T4 = Fluxametamide 11% +
Flubendiamide 10% + Fluxapyroxad 30% WG
Laboratory storage stability for 14 days

| | | | Stability | Stability |
|---|---|---|---|---|
| | Specification | | at 54 ± | at 0 ± |
| Parameters | (in house) | Initial | 2° C. | 2° C. |
| Fluxametamide a.i. | 10.45 to 11.55 | 11.25 | 11.10 | 11.25 |
| Flubendiamide a.i. | 9.50 to 10.50 | 10.40 | 10.30 | 10.40 |
| Fluxapyroxad a.i. | 28.50 to 31.50 | 30.35 | 30.20 | 30.35 |
| Fluxametamide | 70 | 98.40 | 97.30 | 98.20 |
| suspensibility (%) | | | | |
| Flubendiamide | 70 | 98.20 | 97.50 | 98.20 |
| suspensibility (%) | | | | |
| Fluxapyroxad suspensibility | 70 | 98.80 | 97.40 | 98.60 |
| (%) | | | | |
| pH range (1% aq. Suspension) | 5 to 9 | 7.50 | 7.60 | 7.50 |
| Wettability | Max 30 s | 10 | 12 | 10 |
| Wet Sieve(45 micron) | Mini 98.5% | 99.5 | 99.4 | 99.5 |
| Bulk Density | 0.45-0.85 | 0.5 | 0.5 | 0.5 |
| Moisture Content | Max 2.0% | 1.4 | 1.2 | 1.4 |
| Persistent foam ml (after 1 | 60 | nil | nil | nil |
| minute) max. | | | | |

Room temperature storage stability up to 12 months

| | Specification | | 1 | 6 | 12 |
|---|---|---|---|---|---|
| Parameters | (in house) | Initial | month | month | month |
| Fluxametamide a.i. | 10.45 to | 11.25 | 11.25 | 11.25 | 11.20 |
| | 11.55 | | | | |
| Flubendiamide a.i. | 9.50 to | 10.40 | 10.40 | 10.40 | 10.40 |
| | 10.50 | | | | |
| Fluxapyroxad a.i. | 28.50 to | 30.35 | 30.35 | 30.35 | 30.30 |
| | 31.50 | | | | |
| Fluxametamide | 70 | 98.40 | 98.40 | 98.40 | 98.30 |
| suspensibility (%) | | | | | |
| Flubendiamide | 70 | 98.20 | 98.20 | 98.10 | 98.10 |
| suspensibility (%) | | | | | |
| Fluxapyroxad | 70 | 98.80 | 98.80 | 98.80 | 98.70 |
| suspensibility (%) | | | | | |
| pH range (1% aq. | 5 to | 7.50 | 7.50 | 7.50 | 7.55 |
| Suspension) | 9 | | | | |
| Wettability | Max 30 s | 10 | 10 | 10 | 11 |
| Wet Sieve(45 micron) | Mini | 99.5 | 99.5 | 99.5 | 99.5 |
| | 98.5% | | | | |
| Bulk Density | 0.45-0.85 | 0.5 | 0.5 | 0.5 | 0.5 |
| Moisture Content | Max 2.0% | 1.4 | 1.4 | 1.4 | 1.3 |
| Persistent foam ml | 60 | nil | nil | nil | nil |
| (after 1 minute) max. | | | | | |

The composition of Fluxametamide 11% + Flubendiamide 10% + Fluxapyroxad 30% WG meets all inhouse specifications for storage stability studies in laboratory (at 54 ± 2 C. & At 0 ± 2 C. for 14 days) and room temperature (for 12 months).

### Manufacturing Process for 100 kg Batch of Fluxametamide 11%+Flubendiamide 10%+Fluxapyroxad 30% WG (T4)

Step 1—C 18.0 kg China clay, 15.0 kg Corn starch, 0.5 kg silicone antifoam, 5 kg of Sodium isopropyl naphthalene sulfonate, 3 kg Modified polyacrylate copolymer were charged and 7.0 kg of Modified Sodium lignosulphonate was blended into a ribbon or premix blender and homogenization for 30 minutes.

Step 2—Now 11.0 kg Fluxametamide, 10 kg Flubendiamide and 30.0 kg Fluxapyroxad were charged and again homogenized for 30 minutes and now this Pre-blended material was then grinded through Jet mill/air classifier mills. Finely grinded material was blended in post blender till it became homogeneous. (for approx 1.5 hr)

Step 3—Finely grinded powder was mixed with 10 kg of water having 0.5 kg silicone antifoam to form extrudable dough.

Step 4—Dough was passed through extruder to get granules of required size.

Step 5—Wet granules were passed through Fluidized bed drier to remove 10 kg extra water added and further graded using vibrating screens.

Step 6—Final product was sent for QC approval.

Step 7—After approval material was packed in required pack sizes.

TABLE 13
Treatment details

| | | | gram |
|---|---|---|---|
| | | Rate (ml | actives |
| Sr. | | or g per | per |
| No. | Treatment compositions | hectare) | hectare |
| T1 | Fluxametamide 5.5% + Chlorantraniliprole | 500 | 27.5 + |
| | 4% + Fluxapyroxad 15% SC | | 20 + 75 |
| T2 | Fluxametamide 5.5% + Cyantraniliprole | 500 | 27.5 + |
| | 8% + Fluxapyroxad 15% SC | | 40 + 75 |
| T3 | Fluxametamide 3.67% + Tetraniliprole | 750 | 27.5 + |
| | 3.33% + Fluxapyroxad 10% SC | | 25 + 75 |
| T4 | Fluxametamide 11% + Flubendiamide | 250 | 27.5 + |
| | 10% + Fluxapyroxad 30% WG | | 25 + 75 |
| T5 | Fluxametamide 5.5% + Chlorantraniliprole | 500 | 27.5 + |
| | 4% + Difenoconazole 10% SC | | 20 + 50 |
| T6 | Fluxametamide 5.5% + Cyantraniliprole | 500 | 27.5 + |
| | 8% + Difenoconazole 10% SC | | 40 + 50 |
| T7 | Fluxametamide 5.5% + Tetraniliprole | 500 | 27.5 + |
| | 5% + Difenoconazole 10% SC | | 25 + 50 |
| T8 | Fluxametamide 5.5% + Flubendiamide | 500 | 27.5 + |
| | 5% + Difenoconazole 10% SC | | 25 + 50 |
| T9 | Fluxametamide 10% EC | 275 | 27.5 |
| T10 | Fluxapyroxad 33.3% SC | 225.2 | 75 |
| T11 | Difenoconazole 25% EC | 200 | 50 |
| T12 | Chlorantraniliprole 20% SC | 100 | 20 |
| T13 | Cyantraniliprole 10% OD | 400 | 40 |
| T14 | Tetraniliprole 20% SC | 125 | 25 |
| T15 | Flubendiamide 20% WG | 125 | 25 |
| T16 | Untreated Check (UTC) | — | — |

T1 to T8 are inventive compositions and T9-T15 is market products.

TABLE 14
Control of Spodoptera larvae and leaf spot disease in green gram

| | | | | | Leaf spot |
|---|---|---|---|---|---|
| | Spdoptera exigua larval control (%) | | | | disease |
| Treatment | | | Colby's | Synergism | control |
| Number | Observed | Expected | ratio | (Y/N) | (%) |
| T1 | 98.8 | 86.5 | 1.14 | Y | 91.2 |
| T2 | 97.8 | 85.3 | 1.15 | Y | 90.2 |
| T3 | 97.0 | 84.9 | 1.14 | Y | 90.4 |
| T4 | 92.6 | 82.9 | 1.12 | Y | 89.0 |
| T5 | 99.2 | 86.7 | 1.14 | Y | 91.6 |
| T6 | 98.2 | 85.5 | 1.15 | Y | 89.6 |
| T7 | 97.4 | 85.2 | 1.14 | Y | 90.8 |
| T8 | 94.2 | 83.1 | 1.13 | Y | 89.2 |
| T9 | 54.8 | | | | 8.4 |
| T10 | 5.8 | | | | 84.6 |
| T11 | 7.2 | | | | 86.2 |
| T12 | 68.2 | | | | 6.4 |
| T13 | 65.4 | | | | 5.8 |
| T14 | 64.6 | | | | 6.0 |
| T15 | 59.8 | | | | 5.2 |
| T16 | 0.0 | | | | 0.0 |

All the inventive compositions (T1 to T8) provided excellent synergistic larval control and leaf spot disease in green gram.

Conclusion: Among the various compositions as shown in Table 13 treatment numbers T1-T8 are considered to be present compositions which showed excellent synergism and effectiveness against Spodoptera larvae and leaf spot disease in green gram. The spodoptera larvae was controlled by T1-T8 compositions showing more than 94%. Particularly, T5 showed 99.2% followed by T1 (98.8%) and T6 (98.2%) control of Spodoptera exigua larva. Whereas, the Colby's ratio was found >1 proving an effective synergism of the compositions. In addition to that, the leaf spot disease control was observed more than 89% for T1-T8 compositions. Particularly, T5 showed 91.6% followed by T1 (91.2%) and T7 (90.8%) when compared with other compositions as shown in table 14.

### Bio-Efficacy of Fluxametamide+at Least One Diamide Insecticide+at Least One Plant Health Additive

### Example 8: Helicoverpa Larval Control in Marigold

Crop: Marigold
Location: Umreth, Gujarat
Treatments: 26
Crop age: 50 days after transplanting.
Spray water volume: 400 liter per hectare

Method of application: Foliar spray with battery operated knapsack sprayer fitted with hollow cone nozzle.

### Observation Methods:

Larval (Helicoverpa armigera) control (%): as given in example 1.
Flower count: Count the number of marketable flower per plant. Record the observations from 5 plants per plot.

T2 composition for Fluxametamide 10% + Chlorantraniliprole
6.67% + Ascophyllum nodosum extract 10% SC

| Chemical composition | Percent (w/w) |
|---|---|
| Fluxametamide a.i. (100%) | 10.00 |
| Chlorantraniliprole a.i. (100%) | 6.67 |
| Ascophyllum nodosum extract a.i. (90%) | 11.10 |
| Methylated seed oil, polyalkyleneoxide | 5.00 |
| modified trisiloxane (super wetting-spreading- | |
| penetrating agent) | |
| Ethylene-propylene oxide block copolymer | 4.50 |
| (dispersing agent I) | |
| Sodium | 1.00 |
| naphthalene sulphonate formaldehyde | |
| condensates (dispersing agent II) | |
| Aluminum magnesium silicate (suspending | 0.50 |
| agent) | |
| Polydimethylsiloxane (anti foaming agent) | 0.30 |
| sodium benzoate (preservative) | 0.15 |
| Polypropylene glycol (anti freezing agent) | 5.00 |
| Xanthan gum (thickner) | 0.15 |
| Diluent water | 55.63 |
| Total | 100.00 |

Storage stability-T2 Fluxametamide 10% + Chlorantraniliprole
6.67% + Ascophyllum nodosum extract 10% SC
Laboratory storage stability for 14 days

| | | | Stability | Stability |
|---|---|---|---|---|
| | Specification | | at 54 ± | at 0 ± |
| Parameters | (in house) | Initial | 2° C. | 2° C. |
| Fluxametamide a.i. (% w/w) | 9.5 to10.5 | 10.30 | 10.20 | 10.28 |
| Chlorantraniliprole a.i. (% | 6.34 to 7.27 | 6.80 | 6.75 | 6.79 |
| w/w) | | | | |
| Ascophyllum nodosum extract | 9.5 to10.5 | 10.25 | 10.20 | 10.25 |
| a.i. (% w/w) | | | | |
| Fluxametamide suspensibility | 80 | 98.50 | 98.50 | 98.30 |
| (%) | | | | |
| Chlorantraniliprole | 80 | 98.60 | 98.60 | 98.40 |
| suspensibility (%) | | | | |
| Ascophyllum nodosum extract | 80 | 98.00 | 98.00 | 97.60 |
| suspensibility (%) | | | | |
| pH range (1% aq. Suspension) | 5.5 to 8.0 | 7.00 | 7.00 | 7.20 |
| Pourability (%) | 95 | 98.20 | 98.20 | 97.80 |
| Specific gravity | 1.05-1.10 | 1.08 | 1.08 | 1.08 |
| Viscosity at spindle no. 62, 20 | 350-800 cps | 550 | 550 | 550 |
| rpm | | | | |
| Particle size (micron) | D50 < 3, | 2.1, 8.6 | 2.1, 8.6 | 2.1, 8.7 |
| | D90 < 10 | | | |
| Persistent foam ml (after 1 | 60 | nil | nil | nil |
| minute) max. | | | | |

Room temperature storage stability up to 12 months

| | Specification | | 1 | 6 | 12 |
|---|---|---|---|---|---|
| Parameters | (in house) | Initial | month | month | month |
| Fluxametamide a.i. | 9.5 to10.5 | 10.30 | 10.30 | 10.30 | 10.28 |
| (% w/w) | | | | | |
| Chlorantraniliprole | 6.34 to 7.27 | 6.80 | 6.80 | 6.79 | 6.79 |
| a.i. (% w/w) | | | | | |
| Ascophyllum | 9.5 to10.5 | 10.25 | 10.25 | 10.25 | 10.23 |
| nodosum extract | | | | | |
| a.i. (% w/w) | | | | | |
| Fluxametamide | 80 | 98.50 | 98.50 | 98.30 | 98.30 |
| suspensibility (%) | | | | | |
| Chlorantraniliprole | 80 | 98.60 | 98.60 | 98.40 | 98.40 |
| suspensibility (%) | | | | | |
| Ascophyllum | 80 | 98.00 | 98.00 | 97.60 | 97.60 |
| nodosum extract | | | | | |
| suspensibility (%) | | | | | |
| pH range (1% aq. | 5.5 to 8.0 | 7.00 | 7.00 | 7.20 | 7.20 |
| Suspension) | | | | | |
| Pourability (%) | 95 | 98.20 | 98.20 | 97.80 | 97.80 |
| Specific gravity | 1.05-1.10 | 1.08 | 1.08 | 1.08 | 1.08 |
| Viscosity at spindle | 350-800 cps | 550 | 550 | 550 | 550 |
| no. 62, 20 rpm | | | | | |
| Particle size | D50 < 3, | 2.1, 8.6 | 2.1, 8.6 | 2.1, 8.7 | 2.1, 8.7 |
| (micron) | D90 < 10 | | | | |
| Persistent foam in | 60 | nil | nil | nil | 2 |
| ml (after 1 minute) | | | | | |
| max. | | | | | |

The composition of Fluxametamide 10%+Chlorantraniliprole 6.67%+Ascophyllum nodosum extract 10% SC meets all inhouse specifications for storage stability studies in laboratory (at 54±2 C & At 0±2 C for 14 days) and room temperature (for 12 months).

Manufacturing Process for 100 kg Batch of Fluxametamide 10%+Chlorantraniliprole 6.67%+Ascophyllum nodosum Extract 10% SC T2

Step 1—2% Gum Solution: Xanthan gum (2.0 kg) and sodium benzoate (2.0 kg) were charged into 96.0 kg water and homogenize. It was made 12-18 hour prior to use.

Step 2—DM water (48.13 kg) and 1,2-propylene glycol (5 kg) were charged into designated vessel and mixed thoroughly.

Step 3—Sodium naphthalene sulphonate formaldehyde condensates (1.0 kg), Ethylene-propylene oxide block copolymer (4.5 kg) and Aluminum magnesium silicate (0.5 kg) were added into the vessel having water and homogenised the contents for 45-60 minutes using high shear homogeniser.

Step 4—Then Fluxametamide (10.0 kg), Chlorantraniliprole (6.67 kg) and Ascophyllum nodosum extract (10.0 kg) were added to this premix slowly and homogenised to get uniform slurry ready for grinding.

Step 5—Before grinding half the quantity of Polydimethylsiloxane (0.15 kg) was added and then material was subjected to grinding in Dyno mill till desired particle size is achieved.

Step 6—Remaining Polydimethyl siloxane (0.15 kg) antifoam was added after grinding process completes and before sampling for in process analysis.

Step 7—Finally 7.5 kg of 2% Xanthum gum solution and 5.0 kg of Methylated seed oil, polyalkyleneoxide modified trisiloxane (super wetting-spreading-penetrating agent) were added to this formulation and homogenized for 30 minutes.

Step 8—Now sent this final formulation to QC for quality check.

T6 composition for Fluxametamide 10% + Chlorantraniliprole
6.67% + Amino acid (Glycine) 3% SC

| Chemical composition | Percent (w/w) |
|---|---|
| Fluxametamide a.i. (100%) | 10.00 |
| Chlorantraniliprole a.i. (100%) | 6.67 |
| Amino acid (Glycine) a.i. (100%) | 3.00 |
| Polyalkyleneoxide Modified | 5.00 |
| Heptamethyltrisiloxane (super wetting- | |
| spreading-penetrating agent) | |
| Acrylic Graft copolymers (dispersing agent I) | 4.50 |
| Sodium salt of polycarboxylate (dispersing | 1.00 |
| agent II) | |
| Bentonite clay (suspending agent) | 0.50 |
| Polydimethylsiloxane (anti foaming agent) | 0.30 |
| 1,2-benzisothiazolin-3(2H)-one (preservative) | 0.15 |
| Polyethylene glycols, (anti freezing agent) | 5.00 |
| Xanthan gum (thickner) | 0.15 |
| Diluent water | 63.73 |
| Total | 100.00 |

Storage stability-Fluxametamide 10% + Chlorantraniliprole
6.67% + Amino acid (Glycine) 3% SC
Laboratory storage stability for 14 days

| | | | Stability | Stability |
|---|---|---|---|---|
| | Specification | | at 54 ± | at 0 ± |
| Parameters | (in house) | Initial | 2° C. | 2° C. |
| Fluxametamide a.i. (% w/w) | 9.5 to10.5 | 10.30 | 10.20 | 10.28 |
| Chlorantraniliprole a.i. (% | 6.34 to 7.27 | 6.80 | 6.75 | 6.79 |
| w/w) | | | | |
| Amino acid (Glycine) a.i. (% | 2.85 to 3.3 | 3.25 | 3.19 | 3.23 |
| w/w) | | | | |
| Fluxametamide suspensibility | 80 | 98.50 | 98.50 | 98.30 |
| (%) | | | | |
| Chlorantraniliprole | 80 | 98.60 | 98.60 | 98.40 |
| suspensibility (%) | | | | |
| Amino acid (Glycine) extract | 80 | 98.00 | 98.00 | 97.60 |
| suspensibility (%) | | | | |
| pH range (1% aq. Suspension) | 5.5 to 8.0 | 7.00 | 7.00 | 7.20 |
| Pourability (%) | 95 | 98.20 | 98.20 | 97.80 |
| Specific gravity | 1.05-1.10 | 1.08 | 1.08 | 1.08 |
| Viscosity at spindle no. 62, 20 | 350-800 cps | 550 | 550 | 550 |
| rpm | | | | |
| Particle size (micron) | D50 < 3, | 2.1, 8.6 | 2.1, 8.6 | 2.1, 8.7 |
| | D90 < 10 | | | |
| Persistent foam ml (after 1 | 60 | nil | nil | nil |
| minute) max. | | | | |

Room temperature storage stability up to 12 months

| | Specification | | 1 | 6 | 12 |
|---|---|---|---|---|---|
| Parameters | (in house) | Initial | month | month | month |
| Fluxametamide a.i. | 9.5 to10.5 | 10.30 | 10.30 | 10.30 | 10.28 |
| (% w/w) | | | | | |
| Chlorantraniliprole | 6.34 to 7.27 | 6.80 | 6.80 | 6.80 | 6.79 |
| a.i. (% w/w) | | | | | |
| Amino acid | 2.85 to 3.3 | 3.25 | 3.25 | 3.25 | 3.23 |
| (Glycine) a.i. (% | | | | | |
| w/w) | | | | | |
| Fluxametamide | 80 | 98.50 | 98.50 | 98.30 | 98.30 |
| suspensibility (%) | | | | | |
| Chlorantraniliprole | 80 | 98.60 | 98.60 | 98.40 | 98.40 |
| suspensibility (%) | | | | | |
| Amino acid | 80 | 98.00 | 98.00 | 97.60 | 97.60 |
| (Glycine) | | | | | |
| suspensibility (%) | | | | | |
| pH range (1% aq. | 5.5 to 8.0 | 7.00 | 7.00 | 7.10 | 7.20 |
| Suspension) | | | | | |
| Pourability (%) | 95 | 98.20 | 98.20 | 97.80 | 97.80 |
| Specific gravity | 1.05-1.10 | 1.08 | 1.08 | 1.08 | 1.08 |
| Viscosity at spindle | 350-800 cps | 550 | 550 | 550 | 550 |
| no. 62, 20 rpm | | | | | |
| Particle size | D50 < 3, | 2.1, 8.6 | 2.1, 8.6 | 2.1, 8.7 | 2.1, 8.7 |
| (micron) | D90 < 10 | | | | |
| Persistent foam in | 60 | nil | nil | nil | nil |
| ml (after 1 minute) | | | | | |
| max. | | | | | |

The composition of Fluxametamide 10% + Chlorantraniliprole 6.67% + Amino acid (Glycine) 3% SC meets all inhouse specifications for storage stability studies in laboratory (at 54 ± 2 C. & At 0 ± 2 C. for 14 days) and room temperature (for 12 months).

### Manufacturing Process for 100 kg Batch of Fluxametamide 10%+Chlorantraniliprole 6.67%+Amino Acid (Glycine) 3% SC (T6)

Step 1—2% Gum Solution: Xanthan gum (2.0 kg) and 1,2-benzisothiazoline-3-one (2.0 kg) were into 96.0 kg water and homogenized. It was made 12-18 hour prior to use.

Step 2—DM water (56.18 kg) and 1,2-propylene glycol (5 kg) were charged into designated vessel and mixed thoroughly.

Step 3—Sodium salt of polycarboxylate (1.0 kg), Acrylic graft copolymer (4.5 kg) and Bentonite clay (0.5 kg) were added into the vessel having water and homogenised the contents for 45-60 minutes using high shear homogeniser.

Step 4—Then Fluxametamide (10.0 kg), Chlorantraniliprole (6.67 kg) and Amino acid (3.0 kg) were added to this premix slowly and homogenised to get uniform slurry ready for grinding.

Step 5—Before grinding half the quantity of Polydimethylsiloxane (0.15 kg) was added and then material was subjected to grinding in Dyno mill till desired particle size is achieved.

Step 6—Remaining Polydimethyl siloxane (0.15 kg) antifoam was added after grinding process completes and before sampling for in process analysis.

Step 7—Finally 7.5 kg of 2% Xanthum gum solution and 5.0 kg of Polyalkyleneoxide Modified Heptamethyltrisiloxane (super wetting-spreading-penetrating agent) were added to this formulation and homogenized for 30 minutes.

Step 8—Now sent this final formulation to QC for quality check.

TABLE 15
Treatment details

| | | Rate (ml | gram |
|---|---|---|---|
| Treatment | | or g per | actives per |
| Number | Treatment compositions | hectar) | hectare |
| T1 | Fluxametamide 10% + Chlorantraniliprole | 300 | 30 + 20 + 0.12 |
| | 6.67% + Campesterol 0.04% SC | | |
| T2 | Fluxametamide 10% + Chlorantraniliprole | 300 | 30 + 20 + 30 |
| | 6.67% + Ascophyllum nodosum extract 10% SC | | |
| T3 | Fluxametamide 10% + Chlorantraniliprole | 300 | 30 + 20 + 12 |
| | 6.67% + Salicylic acid 4% SC | | |
| T4 | Fluxametamide 10% + Chlorantraniliprole | 300 | 30 + 20 + 6 |
| | 6.67% + Ortho silicic acid 2% SC | | |
| T5 | Fluxametamide 10% + Chlorantraniliprole | 300 | 30 + 20 + 12 |
| | 6.67% + Limanarin 4% SC | | |
| T6 | Fluxametamide 10% + Chlorantraniliprole | 300 | 30 + 20 + 9 |
| | 6.67% + Amino acid (Glycine) 3% SC | | |
| T7 | Fluxametamide 10% + Chlorantraniliprole | 300 | 30 + 20 + 9 |
| | 6.67% + Fulvic acid 3% SC | | |
| T8 | Fluxametamide 3.33% + Chlorantraniliprole | 300 | 30 + 20 + 9 |
| | 2.22% + Humic acid 3% SC | | |
| T9 | Fluxametamide 10% + Chlorantraniliprole | 300 | 30 + 20 + 1.2 |
| | 6.67% + Gibberellic acid 0.4% SC | | |
| T10 | Fluxametamide 3.33% + Chlorantraniliprole | 900 | 30 + 20 + 45 |
| | 2.22% + Mepiquate chloride 5% SC | | |
| T11 | Fluxametamide 10% + Chlorantraniliprole | 300 | 30 + 20 + 30 |
| | 6.67% + Paclobutrazol 10% SC | | |
| T12 | Fluxametamide 10% EC | 300 | 30 |
| T13 | Chlorantraniliprole 18.5% w/w (20% w/v) SC | 100 | 20 |
| T14 | Campesterol 1% SL | 12 | 0.12 |
| T15 | Ascophyllum nodosum extract 96% L | 31.25 | 30 |
| T16 | Salicyclic acid 5% L | 240 | 12 |
| T17 | Ortho silicic acid 2% L | 300 | 6 |
| T18 | Limanarin 2% L | 600 | 12 |
| T19 | Amino acid 50% WP | 18 | 9 |
| T20 | Fulvic acid 80% WP | 11.25 | 9 |
| T21 | Humic acid 80% WP | 11.25 | 9 |
| T22 | Gibberellic acid 40% WSG | 3 | 1.2 |
| T23 | Mepiquat Chloride 5% AS | 900 | 45 |
| T24 | Paclobutrazol 23% w/w (25% w/v) SC | 120 | 30 |
| T25 | Fluxametamide 10% + Chlorantraniliprole 6.67% SC | 300 | 30 + 20 |
| T26 | Untreated Check (UTC) | — | — |

T1 to T11 are inventive compositions. T12 to T25 are market products.

TABLE 16
Larval control and flower yield in marigold

| | | | Number of | Increase (%) |
|---|---|---|---|---|
| | Larval | | marketable | in marketable |
| Treatment | control (%) | Synergism | flowers per | flowers over |
| Number | observed | (Y/N) | 5 plants | UTC |
| T1 | 94.8 | Y | 82.2 | 68.4 |
| T2 | 97.2 | Y | 87.8 | 79.9 |
| T3 | 95.6 | Y | 81.4 | 66.8 |
| T4 | 94.8 | Y | 83.6 | 71.3 |
| T5 | 96.2 | Y | 81.8 | 67.6 |
| T6 | 97.2 | Y | 83.8 | 71.7 |
| T7 | 96.2 | Y | 86.4 | 77.0 |
| T8 | 94.6 | Y | 85.2 | 74.6 |
| T9 | 97.2 | Y | 84.6 | 73.4 |
| T10 | 96.8 | Y | 84.2 | 72.5 |
| T11 | 93.2 | Y | 86.2 | 76.6 |
| T12 | 67.6 | | 68.6 | 40.6 |
| T13 | 70.4 | | 70.2 | 43.9 |
| T14 | 2.2 | | 60.2 | 23.4 |
| T15 | 7.6 | | 66.8 | 36.9 |
| T16 | 3.2 | | 61.2 | 25.4 |
| T17 | 3.2 | | 61.6 | 26.2 |
| T18 | 1.8 | | 60.4 | 23.8 |
| T19 | 2.6 | | 63.6 | 30.3 |
| T20 | 2.4 | | 65.4 | 34.0 |
| T21 | 2.8 | | 65.0 | 33.2 |
| T22 | 10.8 | | 67.2 | 37.7 |
| T23 | 4.2 | | 65.4 | 34.0 |
| T24 | 4.6 | | 66.8 | 36.9 |
| T25 | 90.8 | Additive | 71.6 | 46.7 |
| | | effect | | |
| T26 | 0.0 | | 48.8 | 0.0 |

All the inventive composition (T1 to T11) provided synergistic control of Helicoverpa larvae which feeds on flowers and foliage, and also yielded higher number of marketable flowers.

Conclusion: Among the various compositions as shown in Table 16 treatment number T1-T11 are considered to be present compositions which showed excellent synergism and effectiveness against Helicoverpa armigera larva on marigold. T1-T11 showed more than 93% of larval control. Particularly, T2, T6 and T9 showed 97.2% of larval control on marigold. Further, T1-T11 depicted more than 81 numbers of marketable flowers per five plants. Particularly, T2 provided 87.8 followed by T7 86.4 and T11 86.2 numbers of marketable flowers per five plants. In addition to that, T1-T11 showed more than 66% of increment in marketable flowers over UTC (untreated check). Especially, T2 exhibiting (79.9%) followed by T7 (77.0%) and T11 (76.6%) increase in marketable flowers over UTC when compared with other market products.

### Example 9: Thrips Control in Rose

Crop: Rose
Location: Umreth, Gujarat
Treatments: 16
Crop age: 108 days after transplanting.
Spray water volume: 460 liter per hectare
Method of application: Foliar spray with battery operated knapsack sprayer fitted with hollow cone nozzle.

### Observation Methods:

Thrips (Thrips tabaci) control (%): as given in example 1.

Flower count: count the number of marketable flower per plant. Record the observations from 5 plants per plot.

T5 composition for Fluxametamide 8.33% + Cyantraniliprole
16.67% + Gibberellic acid 0.4% SC

| Chemical composition | Percent (w/w) |
|---|---|
| Fluxametamide a.i. | 8.33 |
| Cyantraniliprole a.i. | 16.67 |
| Gibberellic acid a.i. | 0.40 |
| Polyalkyleneoxide Modified Heptamethyltrisiloxane | 5.00 |
| (super wetting-spreading-penetrating agent) | |
| Tristyryl phenol ethoxylate phosphate esters (dispersing | 4.50 |
| agent I) | |
| Sodium salt of polycarboxylate (dispersing agent II) | 1.00 |
| Magnesium aluminum silicate (suspending agent) | 0.50 |
| Polydimethylsiloxane (anti foaming agent) | 0.30 |
| 1,2-benzisothiazolin-3(2H)-one (preservative) | 0.20 |
| Glycerin (anti freezing agent) | 5.00 |
| Xanthan gum (thickner) | 0.20 |
| Water (diluent) | 57.90 |
| Total | 100.00 |

Storage stability-T5 = Fluxametamide 8.33% +
Cyantraniliprole 16.67% + Gibberellic acid 0.4% SC
Laboratory storage stability for 14 days

| | | | Stability | Stability |
|---|---|---|---|---|
| | Specification | | at 54 ± | at 0 ± |
| Parameters | (in house) | Initial | 2° C. | 2° C. |
| Fluxametamide a.i. | 7.91 to 9.16 | 8.50 | 8.45 | 8.5 |
| Cyantraniliprole a.i. | 15.83 to 17.50 | 16.80 | 16.71 | 16.8 |
| Gibberellic acid a.i. | 0.38 to 0.44 | 0.42 | 0.41 | 0.42 |
| Fluxametamide | 80 | 98.50 | 98.50 | 98.30 |
| suspensibility (%) | | | | |
| Cyantraniliprole | 80 | 98.60 | 98.60 | 98.40 |
| suspensibility (%) | | | | |
| Gibberellic acid | 80 | 98.00 | 98.00 | 97.60 |
| suspensibility (%) | | | | |
| pH range (1% aq. | 4.5 to 7.0 | 5.50 | 5.50 | 5.50 |
| Suspension) | | | | |
| Pourability (%) | 95 | 98.20 | 98.20 | 97.80 |
| Specific gravity | 1.05-1.10 | 1.07 | 1.07 | 1.07 |
| Viscosity at spindle no. 62, | 350-800 cps | 550 | 550 | 550 |
| 20 rpm | | | | |
| Particle size (micron) | D50 < 3, | 2.1, 8.6 | 2.1, 8.6 | 2.1, 8.7 |
| | D90 < 10 | | | |
| Persistent foam ml (after 1 | 60 | nil | nil | nil |
| minute) max. | | | | |

Room temperature storage stability up to 12 months

| | Specification | | 1 | 6 | 12 |
|---|---|---|---|---|---|
| Parameters | (in house) | Initial | month | months | months |
| Fluxametamide a.i. | 7.91 to | 8.50 | 8.50 | 8.5 | 8.48 |
| | 9.16 | | | | |
| Cyantraniliprole a.i. | 15.83 to | 16.80 | 16.80 | 16.8 | 16.75 |
| | 17.50 | | | | |
| Gibberellic acid a.i. | 0.38 to | 0.42 | 0.42 | 0.42 | 0.42 |
| | 0.44 | | | | |
| Fluxametamide | 80 | 98.50 | 98.50 | 98.30 | 98.50 |
| suspensibility (%) | | | | | |
| Cyantraniliprole | 80 | 98.60 | 98.60 | 98.40 | 98.60 |
| suspensibility (%) | | | | | |
| Gibberellic acid | 80 | 98.00 | 98.00 | 97.60 | 98.00 |
| suspensibility (%) | | | | | |
| pH range (1% aq. | 4.5 to | 5.50 | 5.50 | 5.50 | 5.65 |
| Suspension) | 7.0 | | | | |
| Pourability (%) | 95 | 98.20 | 98.20 | 97.80 | 98.20 |
| Specific gravity | 1.05-1.10 | 1.07 | 1.07 | 1.07 | 1.07 |
| Viscosity at spindle | 350-800 cps | 550 | 550 | 550 | 550 |
| no. 62, 20 rpm | | | | | |
| Particle size | D50 < 3, | 2.1, 8.6 | 2.1, 8.6 | 2.1, 8.7 | 2.1, 8.6 |
| (micron) | D90 < 10 | | | | |
| Persistent foam in | 60 | nil | nil | nil | nil |
| ml (after 1 minute) | | | | | |
| max. | | | | | |

The composition of Fluxametamide 8.33%+Cyantraniliprole 16.67%+Gibberellic acid 0.4% SC meets all the criteria for storage stability studies in laboratory (at 54±2 C & At 0±2 C for 14 days) and room temperature (for 12 months).

### Manufacturing Process for 100 kg Batch of Fluxametamide 8.33%+Cyantraniliprole 16.67%+Gibberellic Acid 0.4% SC T5

Step 1—2% Gum Solution: Xanthan gum (2.0 kg) and 1,2-benzisothiazoline-3-one (2.0 kg) were charged into 96.0 kg water and homogenized. It was made 12-18 hour prior to use.

Step 2—DM water (47.90 kg) and 1,2-propylene glycol (5 kg) were charged into designated vessel and mixed thoroughly.

Step 3—Sodium salt of polycarboxylate (1.5 kg), Tristyryl phenol ethoxylate phosphate esters (4.5 kg) and Aluminum magnesium silicate (0.5 kg) were added into the vessel having water and homogenised the contents for 45-60 minutes using high shear homogeniser.

Step 4—Then Fluxametamide (8.33 kg), Cyantraniliprole (16.67 kg) and Gibberellic acid (0.40 kg) were added to this premix slowly and homogenised to get uniform slurry ready for grinding.

Step 5—Before grinding half the quantity of Polydimethylsiloxane (0.15 kg) was added and then material was subjected to grinding in Dyno mill till desired particle size is achieved.

Step 6—Remaining Polydimethyl siloxane (0.15 kg) antifoam was added after grinding process completes and before sampling for in process analysis.

Step 7—Finally 10.0 kg of 2% Xanthum gum solution and 5.0 kg of Polyalkyleneoxide Modified Heptamethyltrisiloxane were added to this formulation and homogenized for 30 minutes.

Step 8—Now sent this final formulation to QC for quality check.

TABLE 17
Treatment details

| | | Rate (ml | gram |
|---|---|---|---|
| Treatment | | or g per | actives per |
| Number | Treatment compositions | hectare) | hectare |
| T1 | Fluxametamide 5% + Cyantraniliprole | 500 | 25 + 50 + 0.1 |
| | 10% + Stigmasterol 0.02% SC | | |
| T2 | Fluxametamide 5% + Cyantraniliprole | 500 | 25 + 50 + 50 |
| | 10% + Ascophyllum nodosum extract 10% SC | | |
| T3 | Fluxametamide 5% + Cyantraniliprole | 500 | 25 + 50 + 10 |
| | 10% + Salicylic acid 2% SC | | |
| T4 | Fluxametamide 5% + Cyantraniliprole 10% + Fulvic | 500 | 25 + 50 + 7.5 |
| | acid 1.5% SC | | |
| T5 | Fluxametamide 8.33% + Cyantraniliprole | 300 | 25 + 50 + 1.2 |
| | 16.67% + Gibberellic acid 0.4% SC | | |
| T6 | Fluxametamide 5% + Cyantraniliprole | 500 | 25 + 50 + 25 |
| | 10% + Paclobutrazol 5% SC | | |
| T7 | Fluxametamide 10% EC | 250 | 25 |
| T8 | Cyantraniliprole 10.26% w/w (10% w/v) OD | 500 | 50 |
| T9 | Stigmasterol 1% SL | 10 | 0.1 |
| T10 | Ascophyllum nodosum extract 96% L | 52.08 | 50 |
| T11 | Salicyclic acid 5% L | 200 | 10 |
| T12 | Fulvic acid 80% WP | 9.38 | 7.5 |
| T13 | Gibberellic acid 40% WSG | 3 | 1.2 |
| T14 | Paclobutrazol 23% w/w (25% w/v) SC | 100 | 25 |
| T15 | Fluxametamide 5% + Cyantraniliprole 10% SC | 500 | 25 + 50 |
| T16 | Untreated Check (UTC) | — | — |

T1 to T6 are inventive compositions, T7 to T14 are market products, T15 is the known composition.

TABLE 18
Thrips control and rose flower yield

| | Thrips control (%) | | | | | | Number of | Increase (%) |
|---|---|---|---|---|---|---|---|---|
| | 3 DAA | | | | | | marketable | in marketable |
| Sr. | | | Colby's | Synergism | | | flowers per | flowers over |
| No. | Observed | Expected | ratio | (Y/N) | 7 DAA | 14 DAA | 5 plants | UTC |
| T1 | 100.0 | 87.91 | 1.14 | Yes | 99.2 | 92.8 | 72.4 | 75.3 |
| T2 | 100.0 | 87.99 | 1.14 | Yes | 98.8 | 93.6 | 71.9 | 74.1 |
| T3 | 100.0 | 88.09 | 1.14 | Yes | 99.4 | 91.6 | 72.7 | 76.0 |
| T4 | 100.0 | 87.78 | 1.14 | Yes | 98.6 | 92.4 | 73.4 | 77.7 |
| T5 | 100.0 | 87.86 | 1.14 | Yes | 97.8 | 93.2 | 72.3 | 75.1 |
| T6 | 100.0 | 87.76 | 1.14 | Yes | 98.2 | 91.6 | 73.8 | 78.7 |
| T7 | 66.4 | | | | 61.8 | 52.8 | 62.5 | 51.3 |
| T8 | 62.2 | | | | 56.4 | 44.8 | 61.3 | 48.4 |
| T9 | 4.8 | | | | 2.6 | 0.8 | 55.7 | 34.9 |
| T10 | 5.4 | | | | 3.8 | 1.2 | 54.3 | 31.5 |
| T11 | 6.2 | | | | 4.2 | 2.0 | 54.8 | 32.7 |
| T12 | 3.8 | | | | 2.2 | 0.8 | 51.8 | 25.4 |
| T13 | 4.4 | | | | 2.6 | 1.4 | 56.8 | 37.5 |
| T14 | 3.6 | | | | 3.2 | 1.0 | 55.4 | 34.1 |
| T15 | 89.2 | 87.30 | 1.02 | | 84.8 | 76.6 | 64.5 | 56.2 |
| T16 | 0.0 | | | | 0.0 | 0.0 | 41.3 | 0.0 |

All the inventive composition (T1 to T6) provided synergistic and residual (>14 days) control of thrips infesting rose, and also yielded higher number of marketable flowers.

Conclusion: Among the various compositions as shown in Table 17 treatment number T1-T6 are considered to be present compositions which showed excellent synergism and effectiveness against thrips on rose plant. Further, T1-T6 depicted 100% thrips control on 3 DAA (days after application) whereas, it showed more than 97% control on thrips at 7 DAA and more than 91% control in 14 DAA as well as it achieved >1 Colby's ratio depicting effective synergism when compared to other products as mentioned in Table 17.

In addition to that, T1-T6 showed 71-73 numbers of marketable flowers per five plants. Particularly, T6 showed 73.8 followed by T4 (73.4) and T3 (72.7) depicting highest number of marketable flowers per five plants. In addition to that, T1-T6 showed more than 74% of increment in marketable flowers over UTC (untreated check). Especially, T6 depicted (78.7%) followed by T4 (77.7%) and T3 (76.0%) increase in marketable flowers over UTC when compared with other T7-T16 composition as showed in Table 18.

### Example 10: Control of Stem Borer and Leaf Folder in Rice

Crop: Rice
Location: Rajim, Chhattishgarh
Treatments: 24
Spray water volume: 500 liter per hectare
Method of application: Foliar spray with battery operated knapsack sprayer fitted with hollow cone nozzle.

### Observation Methods:

### Leaf Folder, Stem Borer Control:

The infestation by stem borer and leaf folder was observed as dead heart (DH), white ear (WE), and leaf folder damaged leaves (LFD) appeared during vegetative stage and reproductive stages from 10 hills per plot. The observation on percent dead hearts at vegetative stage and the leaf damage as percent damaged leaves were recorded at 15 DAA (days after application) and white ear was recorded before harvest of the crop. The leaf was considered to be damaged by the leaf folder if at least ⅓ of its area showed symptoms.

The percentage of DH, WE and LFD in each individual plot was calculated by using formulae described below:

$$Dead Heart ( DH \% ) = \frac{Number of dead heart per 10 hills}{Total number of tillers per 10 hills} \times 100$$

$$White ear ( WE \% ) = \frac{Number of white ear per 10 hills}{Total number bearing panicle per 10 hills} \times 100$$

$$Leaf folder damage ( LFD \% ) = \frac{Number of infested leaves per 10 hills}{Total number of leaves per 10 hills} \times 100$$

Productive tiller count: Count the number of productive tillers per hill.
Record observations from 10 hills per plot at the time of harvesting.

T2 Composition for Fluxametamide 4.4% + Cyantraniliprole
7.2% + Zinc oxide 2% SC

| Chemical composition | Percent (w/w) |
|---|---|
| Fluxametamide a.i. (100%) | 4.40 |
| Cyantraniliprole a.i. (100%) | 7.20 |
| Zinc oxide a.i. (100%) | 2.00 |
| Dioctyl sulfosuccinate (wetting agent) | 2.00 |
| Ethylene-propylene oxide block copolymer | 4.50 |
| (dispersing agent I) | |
| Sodium salt of polycarboxylate (dispersing agent II) | 1.50 |
| Aluminum magnesium silicate (suspending agent) | 1.00 |
| Polydimethylsiloxane (antifoaming agent) | 0.30 |
| 1,2-benzisothiazolin-3(2H)-one (preservative) | 0.15 |
| Polypropylene glycol (antifreezing agent) | 5.00 |
| Xanthan gum (thickner) | 0.15 |
| Water (diluent) | 71.80 |
| Total | 100.00 |

Storage stability-T3 = Fluxametamide 4.4% +
Cyantraniliprole 7.2% + Zinc oxide 2% SC
Laboratory storage stability for 14 days

| | | | Stability | Stability |
|---|---|---|---|---|
| | Specification | | at 54 ± | at 0 ± |
| Parameters | (in house) | Initial | 2° C. | 2° C. |
| Fluxametamide a.i. (% w/w) | 4.18 to | 4.60 | 4.50 | 4.60 |
| | 4.84 | | | |
| Cyantraniliprole a.i. (% w/w) | 6.84 to | 7.35 | 7.25 | 7.35 |
| | 7.92 | | | |
| Zinc oxide a.i. (% w/w) | 1.90 to | 2.25 | 2.18 | 2.25 |
| | 2.2 | | | |
| Fluxametamide | 80 | 98.50 | 98.50 | 98.30 |
| suspensibility (%) | | | | |
| Cyantraniliprole | 80 | 98.60 | 98.50 | 98.40 |
| suspensibility (%) | | | | |
| Zinc oxide suspensibility (%) | 80 | 98.00 | 98.00 | 97.60 |
| pH range (1% aq. Suspension) | 4.5 to | 5.50 | 5.65 | 5.50 |
| | 7.0 | | | |
| Pourability (%) | 95 | 98.20 | 98.20 | 97.80 |
| Specific gravity | 1.00-1.10 | 1.05 | 1.05 | 1.05 |
| Viscosity at spindle no. 62, | 350-800 cps | 550 | 550 | 560 |
| 20 rpm | | | | |
| Particle size (micron) | D50 < 3, | 2.1, 8.6 | 2.1, 8.6 | 2.1, 8.7 |
| | D90 < 10 | | | |
| Persistent foam ml (after 1 | 60 | nil | nil | nil |
| minute) max. | | | | |

Room temperature storage stability up to 12 months

| | Specification | | 1 | 6 | 12 |
|---|---|---|---|---|---|
| Parameters | (in house) | Initial | month | months | months |
| Fluxametamide | 4.18 to4.84 | 4.60 | 4.60 | 4.60 | 4.55 |
| a.i. (% w/w) | | | | | |
| Cyantraniliprole | 6.84 to 7.92 | 7.35 | 7.35 | 7.35 | 7.3 |
| a.i. (% w/w) | | | | | |
| Zinc oxide a.i. | 1.90 to 2.2 | 2.25 | 2.25 | 2.25 | 2.21 |
| (% w/w) | | | | | |
| Fluxametamide | 80 | 98.50 | 98.50 | 98.30 | 98.50 |
| suspensibility (%) | | | | | |
| Cyantraniliprole | 80 | 98.60 | 98.50 | 98.40 | 98.50 |
| suspensibility (%) | | | | | |
| Zinc oxide | 80 | 98.00 | 98.00 | 97.60 | 98.00 |
| suspensibility (%) | | | | | |
| pH range (1% aq. | 4.5 to 7.0 | 5.50 | 5.50 | 5.50 | 5.65 |
| Suspension) | | | | | |
| Pourability (%) | 95 | 98.20 | 98.20 | 97.80 | 98.20 |
| Specific gravity | 1.00-1.10 | 1.05 | 1.05 | 1.05 | 1.05 |
| Viscosity at | 350-800 cps | 550 | 550 | 560 | 560 |
| spindle no. 62, 20 | | | | | |
| rpm | | | | | |
| Particle size | D50 < 3, | 2.1, 8.6 | 2.1, 8.6 | 2.1, 8.7 | 2.1, 8.65 |
| (micron) | D90 < 10 | | | | |
| Persistent foam in | 60 | nil | nil | nil | nil |
| ml (after 1 | | | | | |
| minute) max. | | | | | |

The composition of Fluxametamide 4.4%+Cyantraniliprole 7.2%+Zinc oxide 2% SC meets all the criteria for storage stability studies in laboratory (at 54±2 C & At 0±2 C for 14 days) and room temperature (for 12 months).

### Manufacturing Process for 100 kg Batch of Fluxametamide 4.4%+Cyantraniliprole 7.2%+Zinc Oxide 2% SC T2

Step 1—2% Gum Solution: Xanthan gum (2.0 kg) and 1,2-benzisothiazoline-3-one (2.0 kg) were charged into 96.0 kg water and homogenize. It was made 12-18 hour prior to use.

Step 2 DM water (64.30 kg) and 1,2-propylene glycol (5 kg) were into designated vessel and ix thoroughly.

Step 3—Sodium salt of polycarboxylate (1.5 kg), Ethylene-propylene oxide block copolymer (4.5 kg), Dioctyl sulfosuccinate (2.0 kg) and Aluminum magnesium silicate (1.0 kg) were added into the vessel having water and homogenise the contents for 45-60 minutes using high shear homogeniser.

Step 4—Then Fluxametamide (4.40 kg), Cyantraniliprole (7.20 kg) and Zinc oxide (2.0 kg) were added to this premix slowly and homogenised to get uniform slurry ready for grinding.

Step 5—Before grinding half the quantity of Polydimethylsiloxane (0.15 kg) was added and then material was subjected to grinding in Dyno mill till desired particle size was achieved.

Step 6—Remaining Polydimethyl siloxane (0.15 kg) antifoam was added after grinding process completes and before sampling for in process analysis.

Step 7—Finally 7.5 kg of 2% Xanthum gum solution was added to this formulation and homogenized for 30 minutes.

Step 8—Now sent this final formulation to QC for quality check.

TABLE 19
Treatment details

| | | Composition | gram |
|---|---|---|---|
| Sr. | Treatment details with application Rate | per | actives per |
| No. | (ml or g per Hectare) | hectare | hectare |
| T1 | Fluxametamide | 625 | 27.5 + 22.5 + 12.5 |
| | 4.4% + Chlorantraniliprole 3.6% + Zinc | | |
| | oxide 2% SC | | |
| T2 | Fluxametamide 4.4% + Cyantraniliprole | 625 | 27.5 + 45 + 12.5 |
| | 7.2% + Zinc oxide 2% SC | | |
| T3 | Fluxametamide 4.4% + Tetraniliprole | 625 | 27.5 + 27.5 + 12.5 |
| | 3.6% + Zinc oxide 2% SC | | |
| T4 | Fluxametamide 4.4% + Cyclaniliprole | 625 | 27.5 + 27.5 + 12.5 |
| | 3.6% + Zinc oxide 2% SC | | |
| T5 | Fluxametamide 4.4% + Flubendiamide | 625 | 27.5 + 20 + 12.5 |
| | 3.2% + Zinc oxide 2% SC | | |
| T6 | Fluxametamide | 625 | 27.5 + 22.5 |
| | 4.4% + Chlorantraniliprole 3.6% SC | | |
| T7 | Fluxametamide 4.4% + Cyantraniliprole | 625 | 27.5 + 45 |
| | 7.2% OD | | |
| T8 | Fluxametamide 4.4% + Tetraniliprole 3.6% | 625 | 27.5 + 27.5 |
| | SC | | |
| T9 | Fluxametamide 4.4% + Cyclaniliprole | 625 | 27.5 + 27.5 |
| | 3.6% EC | | |
| T10 | Fluxametamide 4.4% + Flubendiamide | 625 | 27.5 + 20 |
| | 3.2% SC | | |
| T11 | Chlorantraniliprole 20% SC + Zinc oxide | 112.5 + 62.5 | 22.5 + 12.5 |
| | 2% SC | | |
| T12 | Cyantraniliprole 10% OD + Zinc oxide 2% | 450 + 62.5 | 45 + 12.5 |
| | SC | | |
| T13 | Tetraniliprole 20% SC + Zinc oxide 2% SC | 137.5 + 62.5 | 27.5 + 12.5 |
| T14 | Cyclaniliprole 5% SL + Zinc oxide 2% SC | 550 + 62.5 | 27.5 + 12.5 |
| T15 | Flubendiamide 48% SC + Zinc oxide 2% | 41.67 + 62.5 | 20 + 12.5 |
| | SC | | |
| T16 | Fluxametamide 10% EC + Zinc oxide 20% | 275 + 62.5 | 27.5 + 12.5 |
| | WP | | |
| T17 | Chlorantraniliprole 20% SC | 112.5 | 22.5 |
| T18 | Cyantraniliprole 10% OD | 450 | 45 |
| T19 | Tetraniliprole 20% SC | 137.5 | 27.5 |
| T20 | Cyclaniliprole 5% SL | 550 | 27.5 |
| T21 | Flubendiamide 48% SC | 41.67 | 20 |
| T22 | Fluxametamide 10% EC | 275 | 27.5 |
| T23 | Zinc oxide 20% WP | 62.5 | 12.5 |
| T24 | Untreated Check (UTC) | — | — |

T1 to T5 are inventive compositions, T6 to T10 are known compositions, T11 to T16 are on farm tank mixes, T17 to T23 are marketable products.

TABLE 20
Control of stem borer, leaf folder and productive tillers in rice crop

| | | | | | Increase (%) |
|---|---|---|---|---|---|
| | | | Leaf | Number of | in productive |
| | Stem borer incidence (%) | | folder | Productive | tillers over |
| Sr. | Dead | White | control | tillers | T24 |
| No. | Heart | Ear | (%) | per hill | (UTC) |
| T1 | 0.00 | 0.00 | 100.0 | 33.2 | 110.1 |
| T2 | 0.00 | 0.00 | 100.0 | 34.4 | 117.7 |
| T3 | 0.00 | 0.00 | 100.0 | 31.2 | 97.5 |
| T4 | 0.00 | 0.00 | 100.0 | 31.0 | 96.2 |
| T5 | 0.00 | 0.00 | 100.0 | 30.6 | 93.7 |
| T6 | 0.15 | 0.54 | 96.8 | 27.4 | 73.4 |
| T7 | 0.19 | 0.48 | 96.4 | 28.2 | 78.5 |
| T8 | 0.12 | 0.62 | 96.2 | 25.8 | 63.3 |
| T9 | 0.17 | 0.67 | 96.4 | 25.2 | 59.5 |
| T10 | 0.18 | 0.71 | 96.6 | 24.6 | 55.7 |
| T11 | 0.16 | 1.73 | 84.6 | 22.6 | 43.0 |
| T12 | 0.14 | 1.52 | 86.2 | 23.0 | 45.6 |
| T13 | 0.19 | 1.87 | 82.8 | 21.8 | 38.0 |
| T14 | 0.18 | 1.95 | 82.6 | 21.2 | 34.2 |
| T15 | 0.16 | 1.86 | 84.0 | 20.8 | 31.6 |
| T16 | 0.22 | 2.36 | 76.8 | 19.8 | 25.3 |
| T17 | 0.42 | 0.75 | 82.6 | 18.6 | 17.7 |
| T18 | 0.40 | 0.68 | 84.2 | 20.2 | 27.8 |
| T19 | 0.45 | 0.83 | 81.6 | 19.6 | 24.1 |
| T20 | 0.67 | 0.94 | 80.8 | 19.4 | 22.8 |
| T21 | 0.71 | 0.98 | 82.8 | 19.2 | 21.5 |
| T22 | 0.89 | 1.42 | 74.6 | 18.2 | 15.2 |
| T23 | 1.86 | 4.72 | 5.4 | 16.8 | 6.3 |
| T24 | 2.36 | 6.73 | 0.0 | 15.8 | 0.0 |

All the inventive compositions (T1 to T5) provided complete protection against rice stem borer (in terms of dead heart and white ear) and leaf folder, also produces higher number of productive tillers per hill, which are directly contributing to the grain yield.

Conclusion: Among the various compositions as shown in Table 18 treatment number T1-T5 are considered to be present compositions which showed excellent synergism and effectiveness against stem borer (dead heart and white ear) and leaf folder in rice plant. Further, T1-T5 indicated 0% stem borer incident (dead heart and white ear) whereas 100% control of leaf folder as compared to other known, farm tank mix and market products. In addition to that, the numbers of productive tillers per hill for T1-T5 were between 30-34. Particularly, T2 depicted 34.4 followed by T1 (33.2) and T3 (31.2) numbers of productive tillers per hill when compared to other known, farm tank mix and market products. Further increase % in productive tillers over T4 was between 93 to 117.

### Overall Field Trials Summery

The present compositions of fluxametamide, at least one diamide insecticide and one more insecticide; fluxametamide, at least one diamide insecticide and at least one fungicide; and fluxametamide, at least one diamide insecticide and at least one plant health additives show synergism in terms of insect-pests and diseases control and also produces more fruits, flowers and grains, increases spectrum of control, reduces number of pesticidal applications under field conditions.

The process for preparing the present novel synergistic composition can be modified accordingly by any person skilled in the art based on the knowledge of the manufacturing the formulation. However, all such variation and modification is still covered by the scope of present invention.

Application to the seeds is carried out before sowing, either directly on the seeds or after having pregerminated the latter. Suitable application methods include inter alia soil treatment, seed treatment, in furrow application, and foliar application. Soil treatment methods include drenching the soil, drip irrigation (drip application onto the soil), dipping roots, tubers or bulbs, or soil injection. Seed treatment techniques include seed dressing, seed coating, seed dusting, seed soaking, and seed pelleting. In furrow applications typically include the steps of making a furrow in cultivated land, seeding the furrow with seeds, applying the pesticidally active composition to the furrow, and closing the furrow. Foliar application refers to the application of the pesticidally active composition to plant foliage, e.g. through spray equipment.

The rates of application vary within wide limits and depend on the nature of the soil, the method of application, the crop plant, the pest to be controlled, the prevailing climatic conditions, and other factors governed by the method of application, the time of application and the target crop.

The present invention is suitable for use in protecting crops, plants, plant propagation materials, such as seeds, or sailor water, in which the plants are growing, from attack or infestation by animal pests. Therefore, the present invention also relates to a plant protection method, which comprises contacting crops, plants, plant propagation materials, such as seeds, or soil or water, in which the plants are growing, to be protected from attack or infestation by animal pests, with a pesticidally effective amount of the present invention.

The present invention is also suitable for use in combating or controlling animal pests. Therefore, the present invention also relates to a method of combating or controlling animal pests, which comprises contacting the animal pests, their habitat, breeding ground, or food supply, or the crops, plants, plant propagation materials, such as seeds, or soil, or the area, material or environment in which the animal pests grow, with a pesticidally effective amount of the present invention.

The lists of crops on which the pesticidal composition of the present invention is used include, but not limited to GMO (Genetically Modified Organism) and Non GMO traits, hybrids and conventional varieties of Cotton (Gossypium spp.), Paddy (Oryza sativa), Wheat (Triticum aestavum), Barley (Hordeum vulgare), Maize (Zea mays), Sorghum (Sorghum bicolor), Oat (Avena sativa), Pearl millet (Pennisetum glaucum), Sugarcane (Saccharum officinarum), Sugarbeet (Beta vulgaris), Soybean (Glycin max), Groundnut/Peanut (Arachis hypogaea), Sunflower (Helianthus annuus), Mustard (Brassica juncea), Rape seed (Brassica napus), Sesame (Sesamum indicum), Green gram (Vigna radiata), Black gram (Vigna mungo), Chickpea (Cicer aritinum), Cowpea (Vigna unguiculata), Red gram (Cajanus cajan), French bean (Phaseolus vulgaris), Indian bean (Lablab purpureus), Horse gram (Macrotyloma uniflorum), Field pea (Pisum sativum), Cluster bean (Cyamopsis tetragonoloba), Lentils (Lens culinaris), Brinjal (Solanum melongena), Cabbage (Brassica oleracea var. capitata), Cauliflower (Brassica oleracea var. botrytis), Okra (Abelmoschus esculentus), Onion (Allium cepa L.), Tomato (Solanum lycopersicun), Potato (Solanum tuberosum), Sweet potato (Ipomoea batatas), Chilly (Capsicum annum), Bell pepper (Capsicum annum), Garlic (Allium sativum), Cucumber (Cucumis sativus), Muskmelons (Cucumis melo), Watermelon (Citrullus lanatus), Bottle gourd (Lagenaria siceraria), Bitter gourd (Momordica charantia), Radish (Raphanus sativus), Carrot (Dacus carota subsp. sativus), Turnip (Brassica rapa rapa), Apple (Melus domestica), Banana (Musa spp.), Citrus groups (Citrus spp.), Grape (Vitis vinifera), Guava (Psidium guajava), Mango (Mangifera indica), Papaya (Carica papaya), Pineapple (Ananas comosus), Pomegranate (Punica granatum), Sapota (Manilkara zapota), Tea (Camellia sinensis), Coffea (Coffea Arabica), Turmeric (Curcuma longa), Ginger (Zingiber officinale), Cumin (Cuminum cyminum), Black Pepper (Piper nigrum), Mentha (Mentha spp.), Rose (Rosa spp.), Jasmine (Jasminum spp.), Marigold (Tagetes spp.), Common daisy (Bellis perennis), Dahlia (Dahlia hortnesis), Gerbera (Gerbera jamesonii), Carnation (Dianthus caryophyllus).

Crops are to be understood as also including those crops which have been rendered tolerant to herbicides or classes of herbicides (e.g. ALS-, GS-, EPSPS-, PPO-, ACCase- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Crops that have been rendered tolerant to herbicides by genetic engineering methods include, but not limited to, glyphosate- and glufosinate-resistant maize varieties commercially available under the trade names RoundupReady® and LibertyLink®.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Bt maize incudes Bt 176 maize hybrids of NK® (Syngenta Seeds). The Bt toxin is a protein that is formed naturally by Bacillus thuringiensis soil bacteria. EP-A-451 878, EP-A-374 753, WO 93/07278, WO 95/34656, WO 03/052073 and EP-A-427 529 describe such toxins or transgenic plants able to synthesize such toxins. Transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Crops are also to be understood to include those which are obtained by conventional methods of breeding or genetic engineering and contain so-called output traits (e.g. improved storage stability, higher nutritional value and improved flavor).

Other useful plants include turf grass for example in golf-courses, lawns, parks and roadsides, or grown commercially for sod and ornamental plants such as flowers or bushes.

The pesticidal composition of the present invention can be used to control the insects-pests and plant parasitic nematode. The major insects-pests belong to the order Hemiptera, for example, but not limited to rice leafhopper/green leaf hopper (GLH) (Nephotettix nigropictus), rice brown plant hopper (BPH) (Nilaparvata lugen), rice backed plant hopper (WBPH) (Sogatella furcifera), Apple Mealy bug (Phenococcus aceris), bean aphid (Aphis fabae), black citrus aphid (Toxoptera aurantii), citrus black scale (Saissetia oleae), cabbage aphid (Brevicoryne brassicae), (Lipaphis erysimi), citrus red scale (Aonidiella aurantii), yellow scale (Aonidiella citrine), citrus mealybug (Planococcus citri), corn leaf aphid (Rhopalosiphum maidis), aphid (Aphis gossypii), jassid (Amrasca biguttula), mealy bug (Planococcus spp. and Pseudococcus spp.), cotton stainer (Dysdercus suturellus), whitefly (Bemisia tabaci), cowpea aphid (Aphis crassivora), grain aphid (Sitobion avenae), golden glow aphid (Uroleucon spp.), grape mealybug (Pseudococcus maritimus), green peach aphid (Myzus persicae), greenhouse whitefly (Trialeurodes vaporariorum), papaya mealy bug (Pracoccus marginatus), pea aphid (Acyrthosiphon pisum), sugarcane mealybug (Saccharicoccus sacchari), potato aphid (Myzus persicae), potato leaf hopper (Empoasca fabae), cotton whitefly (Bemisia tabaci), tarnished plant bug (Lygus lineolaris), wooly apple aphid (Eriosoma lanigerum), and mango hopper (Amritodus atkinsoni, Idioscopus spp.); order Lepidoptera, for example, but not limited to army worm (Mythimna unipuncta), asiatic rice borer (Chilo suppressalis), bean pod borer (Maruca vitrata), beet armyworm (Spodoptera exigua), black cutworm (Agrotis ipsilon), bollworm (Helicoverpa armigera), cabbage looper (Trichoplusia ni), codling moth (Cydia pomonella), croton caterpillar (Achea janata), diamond backmoth (Plutella xylostella), cabbage worm (Pieris rapae), pink bollworm (Pectinophora gossypiella), sugarcane borer (Diatraea saccharalis), sugarcane early shoot borer (Chilo infuscatellus) tobacco budworm (Heliothis virescens), tomato fruitworm (Helicoverpa zea), velvet bean caterpillar (Anticarsia gemmatalis), yellow stem borer (Scirpophaga incertulas), spotted bollworm (Earias vittella), rice leaf-folder (Cnaphalocrocis medinalis), pink stem borer (Sesamia spp.), tobacco leaf-eating caterpillar (Spodoptera litura); brinjal fruit and shoot borer (Leucinodes orbonalis), bean pod borer (Maruca vitrata, Maruca testulalis), armyworm (Mythimna separata), citrus leaf-miner (Phyllocnistis citrella), cabbage butterfly (Pieris brassicae), paddy stem borer (Scirpophaga excerptallis, Scirpophaga incertulas, Scirpophaga innotata), wheat stem borer (Sesamia inferens, Sitotroga cerealella, Spilosoma obliqua), and fall armyworm (Spodoptera frugiperda, Spodoptera littoralis, Spodoptera litura, Tryporyza nivella, Tryporyza incertulas, Tuta absoluta); to the order Coleoptera, for example, but not limited to apple twig borer (Amphicerus spp.), corn root worm (Diabrotica virgifera), cucumber beetle (Diabrotica balteata), boll weevil (Anthonomus grandis), grape flea beetle (Altica chalybea), grape root worm (Fidia viticola), grape trunk borer (Clytoleptus albofasciatus), radish flea beetle (Phyllotreta armoraciae), maize weevil (Sitophilus zeamais), northern corn rootworm (Diabrotica barberi), rice water weevil (Lissorhoptrus oryzophilus, Anthonomus grandis, Bruchus lentis, Diabrotica semipunctata, Diabrotica virgifera, Dicladispa armigera, Epilachna varivestis), and various species of white grubs (Holotrichia bicolor, Holotrichia consanguinea, Holotrichia serrata, Leptinotarsa decemlineata, Phyllotreta chrysocephala, Popillia japonica); to the order Orthoptera, for example, but not limited to Gryllotalpa spp., Locusta spp., and Schistocerca spp.; to the order Thysanoptera, for example, but not limited to Frankliniella spp., Thrips palmi, Thrips tabaci and Scirtothrips dorsalis; termites (Isoptera), for example, but not limited to Calotermes flavicollis, Coptotermes formosanus, Heterotermes aureus, Leucotermes flavipes, Microtermes obesi, Odontotermes obesus, Reticulitermes flavipes, and Termes natalensis; to the order Heteroptera, for example, but not limited to Dysdercus spp., and Leptocorisa spp., to the order Hymenoptera, for example, but not limited to Solenopsis spp.; to the order Diptera, for example, but not limited to Antherigona soccata, Dacus spp., Liriomyza spp., and Melanagromyza spp., to the order Acarina, for example, Aceria mangiferae, Brevipalpus spp., Eriophyes spp., Oligonychus mangiferus, Oligonychus punicae, Panonychus citri, Panonychus ulmi, Polyphagotarsonemus latus, Tarsonemus spp., Tetranychus urticae, and Tetranychus cinnabarinus; plant parasitic nematodes for example, but not limited to root-knot nematodes (Meloidogyne incognita, Meloidogyne javanica and other Meloidogyne species); cyst nematodes (Globodera rostochiensis, Globodera pallida, Globodera tabacum and other Globodera species), (Heterodera avenae, Heterodera glycines, Heterodera schachtii, Heterodera trifolii, and other Heterodera species); seed gall nematodes (Anguina funesta, Anguina tritici and other Anguina species); stem and foliar nematodes (Aphelenchoides besseyi, Aphelen-choides fragariae, Aphelenchoides ritzemabosi and other Aphelenchoides species); sting nematodes (Belonolaimus longicaudatus and other Belonolaimus species); pine nematodes (Bursaphelenchus xylophilus and other Bursaphelenchus species); ring nematodes (Criconema species, Criconemella species, Criconemoides species, and Mesocriconema species); stem and bulb nematodes (Ditylenchus destructor, Ditylenchus dipsaci, Ditylenchus myceliophagus and other Ditylenchus species); awl nematodes (Dolichodorus species); spiral nematodes (Helicotylenchus dihystera, Helicotylenchus multicinctus and other Helicotylenchus species), (Rotylenchus robustus and other Rotylenchus species); sheath nematodes (Hemicycliophora species and Hemicriconemoides species; Hirshmanniella species; lance nematodes, Hoplolaimus columbus, Hoplolaimus galeatus and other Hoplolaimus species); false root-knot nematodes (Nacobbus aberrans and other Nacobbus species); needle nematodes (Longidorus elongates and other Longidorus species); pin nematodes (Paratylenchus species); lesion nematodes (Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species), (Radinaphelenchus cocophilus and other Radinaphelenchus species); burrowing nematodes (Radopholus similis and other Radopholus species); reniform nematodes (Rotylenchulus reniformis and other Rotylenchulus species), (Scutellonema species); stubby root nematodes (Trichodorus primitivus and other Trichodorus species, Paratrichodorus minor and other Paratrichodorus species); stunt nematodes (Tylenchorhynchus claytoni, Tylenchorhynchus dubius and other Tylenchorhynchus species and Merlinius species); citrus nematodes (Tylenchulus semipenetrans and other Tylenchulus species); dagger nematodes (Xiphinema americanum, Xiphinema index, Xiphinema diversicaudatum and other Xiphinema species); and other plant parasitic nematode species.

The pesticidal composition of the present invention have very good fungicidal properties and can be employed for controlling phytopathogenic fungi such as Ascomycetes, Basidiomycetes, Chytridiomycetes, Deuteromycetes, Oomycetes, Plasmodiophoromycetes, Zygomycetes, and the like.

Examples of some pathogens of fungal diseases which come under the above generic terms, include, but not limited to diseases caused by pathogens causing powdery mildew such as, but not limited to, Blumeria species for example, but not limited to Blumeria graminis; Podosphaera species for example, but not limited to Podosphaera leucotricha; Oidium species for example, but not limited to Oidium mangiferae; Sphaerotheca species for example, but not limited to Sphaerotheca fuliginea; Uncinula species for example, but not limited to Uncinula necator; Leveillula species for example, but not limited to Leveillula taurica; Erysiphe species for example, but not limited to Erysiphe polygoni; diseases caused by pathogens of rust such as, but not limited to Gymnosporangium species for example, but not limited to Gymnosporangium sabinae; Hemileia species for example, but not limited to Hemileia vastatrix; Phakopsora species for example, but not limited to Phakopsora pachyrhizi and Phakopsora meibomiae; Puccinia species for example, but not limited to Puccinia graminis, Puccinia recondita or Puccinia triticina, and Puccinia striiformis; Uromyces species for example, but not limited to Uromyces phaseoli; diseases caused by pathogens of smut diseases such as, but not limited to Sporisorium species for example, but not limited to Sporisorium scitamineum; Ustilago species for example, but not limited to Ustilago maydis, Tilletia species for example, but not limited to Tilletia tritici, Ustilaginoidea species for example, but not limited to Ustilaginoidea virens, diseases caused by pathogens of ergot diseases for example, but not limited to Claviceps species, and Claviceps purpurea; diseases caused by pathogens from the group of the Oomycetes such as, but not limited to Bremia species for example, but not limited to Bremia lactucae; Peronospora species for example, but not limited to Peronospora pisi or P. brassicae; Phytophthora species for example, but not limited to Phytophthora infestans; Plasmopara species for example, but not limited to Plasmopara viticola; Pseudoperonospora species for example, but not limited to Pseudoperonospora humuli or Pseudoperonospora cubensis; Pythium species for example, but not limited to Pythium ultimum; leaf spot diseases and leaf wilt caused by, for example, but not limited to Alternaria species for example, but not limited to Alternaria solani, Alternaria alternata, and Alternaria porii; Cercospora species for example, but not limited to Cercospora arachidicola; Cladiosporum species for example, but not limited to Cladiosporium cucumerinum; Cochliobolus species for example, but not limited to Cochliobolus sativus (conidial form: Drechslera, syn: Helminthosporium); Colletotrichum species for example, but not limited to Colletotrichum capsici; Cycloconium species for example, but not limited to Cycloconium oleaginum; Diaporthe species for example, but not limited to Diaporthe citri; Elsinoe species for example, but not limited to Elsinoe fawcettii; Gloeosporium species for example, but not limited to Gloeosporium laeticolor; Glomerella species for example, but not limited to Glomerella cingulata; Guignardia species for example, but not limited to Guignardia bidwelli; Leptosphaeria species for example, but not limited to Leptosphaeria maculans; Magnaporthe species for example, but not limited to Magnaporthe grisea; Mycosphaerella species for example, but not limited to Mycosphaerella graminicola; Phaeosphaeria species for example, but not limited to Phaeosphaeria nodorum; Pyrenophora species for example, but not limited to Pyrenophora teres; Ramularia species for example, but not limited to Ramularia collocygni; Rhynchosporium species for example, but not limited to Rhynchosporium secalis; Septoria species for example, but not limited to Septoria apii; Typhula species for example, but not limited to Typhula incarnata; Venturia species for example, but not limited to Venturia inaequalis; root and stalk diseases, caused by, for example, but not limited to, Corticium species for example, but not limited to Corticium graminearum; Fusarium species for example, but not limited to Fusarium oxysporum; Gaeumannomyces species for example, but not limited to Gaeumannomyces graminis; Rhizoctonia species for example, but not limited to Rhizoctonia solani; Tapesia species for example, but not limited to Tapesia acuformis; Thielaviopsis species for example, but not limited to Thielaviopsis basicola; ear and panicle diseases (including maize cobs), caused by, for example, but not limited to Alternaria species for example, but not limited to Alternaria spp.; Aspergillus species for example, but not limited to Aspergillus flavus; Cladosporium species for example, but not limited to Cladosporium spp.; Claviceps species for example, but not limited to Claviceps purpurea; Fusarium species for example, but not limited to Fusarium culmorum; Gibberella species for example, but not limited to Gibberella zeae; Monographella species for example, but not limited to Monographella nivalis; diseases caused by smuts for example, but not limited to Sphacelotheca species for example, but not limited to Sphacelotheca reiliana; Tilletia species for example, but not limited to Tilletia caries; Urocystis species for example, but not limited to Urocystis occulta; Ustilago species for example, but not limited to Ustilago nuda; fruit rot caused by, for example, but not limited to Aspergillus species for example, but not limited to Aspergillus flavus; Botrytis species for example, but not limited to Botrytis cinerea; Penicillium species for example, but not limited to Penicillium expansum; Sclerotinia species for example, but not limited to Sclerotinia sclerotiorum; Verticilium species for example, but not limited to Verticilium alboatrum; seed- and soil-borne rots and wilts, and seedling diseases, caused by, for example, but not limited to Fusarium species for example, but not limited to Fusarium culmorum; Phytophthora species for example, but not limited to Phytophthora cactorum; Pythium species for example, but not limited to Pythium ultimum; Rhizoctonia species for example, but not limited to Rhizoctonia solani; Sclerotium species for example, but not limited to Sclerotium rolfsii; cankers, galls and witches' broom diseases, caused by, for example, but not limited to Nectria species for example, but not limited to Nectria galligena; wilts caused by, for example, but not limited to Monilinia species for example, but not limited to Monilinia laxa; deformations of leaves, flowers and fruits, caused by, for example, but not limited to Taphrina species for example, but not limited to Taphrina deformans; degenerative diseases of woody species, caused by, for example, but not limited to Esca species for example, but not limited to Phaemoniella clamydospora; flower and seed diseases, caused by, for example, but not limited to Botrytis species for example, but not limited to Botrytis cinerea; diseases of plant tubers caused by, for example, but not limited to Rhizoctonia species for example, but not limited to Rhizoctonia solani; diseases caused by bacterial pathogens for example, but not limited to Xanthomonas species for example, but not limited to Xanthomonas campestris pv. oryzae; Pseudomonas species for example, but not limited to Pseudomonas syringae pv. lachrymans; and Erwinia species for example, but not limited to Erwinia amylovora.

We claim:

1. A fluxametamide composition comprising:
A) fluxametamide or its agrochemically acceptable salts in an amount of 1 to 20 w/w %;
B) at least one or more insecticide(s) selected from class of diamides in an amount of 1 to 20 w/w %; and
C) at least one or more compound selected from insecticide(s), fungicide(s), plant health additive(s) in an amount of 0.001 to 60 w/w % and agrochemically acceptable excipients.

1. The fluxametamide composition as claimed in claim 1 wherein, B) insecticide(s) is selected from group consisting of chlorantraniliprole, cyantraniliprole, cyclaniliprole, tetraniliprole, tetrachlorantraniliprole, tyclopyrazoflor, cyhalodiamide, flubendiamide, fluchlordiniliprole and tiorantraniliprole.

2. The fluxametamide composition as claimed in claim 3 wherein, the insecticides of compound B are present in the range of 2% to 20%.

3. The fluxametamide composition as claimed in claim 1 wherein, the insecticide for compound C is selected from group consisting of abamectin, emamectin benzoate, tolfenpyrad, pyrifluquinazon, lambda cyhalothrin, fipronil, fenpyroximate, hexythiazox, etoxazole, diafenthiuron, methoxyfenozide, spinosad, indoxacarb, afidopyropen, flonicamid, pyriproxyfen, bifenthrin, deltamethrin, thiamethoxam and dinotefuran.

4. The fluxametamide composition as claimed in claim 5 wherein, the insecticides of compound C are present in the range of 1.5% to 20%.

5. The fluxametamide composition as claimed in claim 1 wherein, the fungicides for compound C is selected from group consisting of pyraclostrobin, fluxapyroxad, azoxystrobin and difenoconazole.

6. The fluxametamide composition as claimed in claim 7 wherein, the fungicides of compound C are present in the range of 10% to 30%.

7. The fluxametamide composition as claimed in claim 1 wherein, the plant health additive is selected from the group consisting of zinc oxide, campesterol, Ascophyllum nodosum, salicylic acid, ortho silicic acid, limanarin, amino acid, fulvic acid, humic acid, gibberellic acid, mepiquate chloride, paclobutrazol and stigmasterol.

8. The fluxametamide composition as claimed in claim 9 wherein, the amino acid is glycine.

9. The fluxametamide composition as claimed in claim 9 wherein, the plant health additive is present in the range of 0.04-10%.

10. The fluxametamide composition as claimed in claim 1, wherein the agrochemically acceptable excipients are selected from the group consisting of dispersing agents, anti-freezing agents, anti-foam agents, wetting agents, suspension aid and carriers, anti-microbial agents, thickeners, colorants, quick coating agents or sticking agents, polymers, disintegrating agents, oil additives, buffering agents, and solvents.

11. The fluxametamide composition as claimed in claim 12, wherein the agrochemically acceptable excipients are present in the range from 0.1% to 99% of the total weight of the composition.

12. The fluxametamide composition as claimed in claim 1, wherein the composition is in the form of oil dispersion (OD), suspension concentrate (SC), suspo-emulsion (SE), water dispersible granule (WG or WDG) and a mixed formulation of capsule suspension CS and SC (ZC).

13. The fluxametamide composition as claimed in claim 1 or 14, wherein the wetting agent for oil dispersion (OD) is selected from the group consisting of ethylene oxide/propylene oxide block copolymer, polyarylphenyl ether phosphate, ethoxylated fatty alcohol, sodium dioctyl sulfosuccinate, sodium lauryl sulfate and sodium dodecyl benzene sulfonate, alkyldiphenyl sulfonates, sodium isopropyl naphthalene sulfonate, alkylnaphthalene sulfonate and mixture thereof.

14. The fluxametamide composition as claimed in claim 1 or 14, wherein the wetting-spreading-penetrating agent for oil dispersion (OD) is selected from the group consisting of organosilicone surfactants; trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, polyalkyleneoxide modified heptamethyl trisiloxane, polyether modified polysiloxane, may or may not be in modified form, may be liquid or powder form and mixture thereof.

15. The fluxametamide composition as claimed in claim 1 or 14, wherein the emulsifying agent for oil dispersion (OD) is selected from the group consisting of castor oil ethoxylates, alcohol ethoxylates, fatty acid ethoxylates, sorbitan ester ethoxylates, sulphosuccinate, calcium salts of dodecylbenzene sulphonate, alkylammonium salts of alkylbenzene sulphonate, alkylsulphosuccinate salts, ethylene oxide-propylene oxide block copolymers, ethoxylated alkylamines, ethoxylated alkyl phenols, polyoxyethylene sorbitan monolaurate and mixture thereof.

16. The fluxametamide composition as claimed in claim 1 or 14, wherein the dispersing agent for oil dispersion (OD) is selected from the group consisting of alkyl sulfonates, alkyl benzene sulfonates, alkyl aryl sulfonates, alkylphenolalkoxylates, tristyrylphenol ethoxylates, natural or synthetic fatty ethoxylate alcohols, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers), fatty acid-polyalkylene glycol condensates, polyamine-fatty acid condensates, polyester condensates, salts of polyolefin condensates, sodium ligno sulfonate, sodium ploycarboxylate, EO/PO based copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide and mixture thereof.

17. The fluxametamide composition as claimed in claim 1 or 14, wherein the stabilizer for oil dispersion (OD) is selected from the group consisting of hectorite clay, aluminium magnesium silicate, bentonite clay, silica, attapulgite clay and mixture thereof.

18. The fluxametamide composition as claimed in claim 1 or 14, wherein the antifoaming agent for oil dispersion (OD) is selected from the group consisting of silicone oil, silicone compound, C₁₀˜C₂₀ saturated fat acid compounds or C₈˜C₁₀ aliphatic alcohols compound, silicone antifoam emulsion, dimethylsiloxane, polydimethyl siloxane, vegetable oil based antifoam, tallow based fatty acids, polyalkyleneoxide modified polydimethylsiloxane and mixture thereof.

19. The fluxametamide composition as claimed in claim 1 or 14, wherein the anti-freezing agent for oil dispersion (OD) is selected from the group consisting of ethylene glycol, propane diols, glycerine or the urea, glycol (monoethylene glycol, diethylene glycol, polypropylene glycol, polyethylene glycol), glycerine, urea, magnesium sulfate heptahydrate, sodium chloride; preservative-1,2-benzisothiazolin-3 (2H)-one, sodium salt, sodium benzoate, 2-bromo-2-nitropropane-1,3-diol, formaldehyde, sodium o-phenylphenate, 5-chloro-2-methyl-4-isothiazolin-3-one and 2-methyl-4-isothiazolin-3-one and mixture thereof.

20. The fluxametamide composition as claimed in claim 1 or 14, wherein the solvent for oil dispersion (OD) is selected from the group consisting of vegetable oil (plant, seed or tree) or it's alkylated or ethoxylated or esterified; the alkylated vegetable oil may be methylated vegetable oil or ethylated vegetable oil; the vegetable oils include olive oil, kapok oil, castor oil, papaya oil, camellia oil, sesame oil, corn oil, rice bran oil, cotton seed oil, soybean oil, groundnut oil, rapeseed-mustard oil, linseed oil, tung oil, sunflower oil, safflower oil, coconut oil; the alkyl ester of vegetable oils; methyl ester, ethyl ester, propyl ester or butyl ester of vegetable oils, methylated seed oil, polyalkyleneoxide modified polydimethylsiloxane alkylphenol ethoxylate, rapeseed oil methyl ester, rapeseed oil ethyl ester, rapeseed oil propyl esters, rapeseed oil butyl esters, soybean oil methyl ester, soybean oil ethyl ester, soybean oil propyl ester, soybean oil butyl ester, castor oil methyl ester, castor oil ethyl ester, castor oil propyl ester, castor oil butyl ester, cotton seed oil methyl ester, cotton seed oil ethyl ester, cotton seed oil butyl ester, cotton seed oil propyl ester, tall oil fatty acids esters-tallow methyl ester, tallow ethyl ester, tallow propyl ester, bio-diesel, mineral oil (aromatic solvents, isoparaffin, base solvent), fatty acid amides (e.g. C₁-C₃ amines, alkylamines or alkanolamines with C₆-C₁₈ carboxylic acids), fatty acids, alkyl esters of fatty acids, methyl and ethyl oleate, methyl and ethyl soyate, alkyl benzenes and alkylnaphthalenes, polyalkylene glycol ethers, fatty acid diesters, fatty alkylamides and diamides, dialkylene carbonates, ketones and alcohols; the above oil based carrier/diluting agents may be used as solo and mixture thereof.

21. The fluxametamide composition as claimed in claim 1 or 14, wherein the cosolvent for oil dispersion (OD) is selected from the group consisting of cyclohexanone, acetophenone, NMP, dimethyl sulfoxide, benzyl alcohol, butanol, N-octanol, N-propanol, 2-ethyl hexanol, tetrahydro furfuryl alcohol, isophorone, fatty acid dimethyl amide, 2-hexylethyl lactate, propylene carbonate and mixture thereof.

22. The fluxametamide composition as claimed in claim 1 or 14, wherein the wetting agent for suspension concentrate (SC) is selected from the group consisting of ethylene oxide/propylene oxide block copolymer, polyarylphenyl ether phosphate, polyalkoxylated butyl ether, ethoxylated fatty alcohol, sodium dioctyl sulfosuccinate, sodium lauryl sulfate and sodium dodecyl benzene sulfonate, alkyl diphenyl sulfonates, sodium isopropyl naphthalene sulfonate, alkyl naphthalene sulfonate, organosilicons surfactants (as a wetting-spreading-penetrating agent); trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, modified form; polyalkyleneoxide modified heptamethyl trisiloxane, polyether modified polysiloxane, polyalkyleneoxide modified trisiloxane, polyalkyleneoxide modified polydimethylsiloxane, trisiloxane ethoxylate, polyoxyethylene methyl polysiloxane, polyether polymethyl siloxane copolymer, polyether modified polysiloxane; may or may not be in modified form, may be liquid or powder form and mixture thereof.

23. The fluxametamide composition as claimed in claim 1 or 14, wherein the dispersing agent for suspension concentrate (SC) is selected from the group consisting of naphthalenesulfonic acid, sodium salt condensated with formaldehyde, alkylated naphthalene sulfonate, sodium salt, sodium salt of naphthalene sulfonate condensate, sodium ligno sulfonate, sodium polycarboxylate, EO/PO based copolymer, phenol sulfonate, sodium methyl oleoyl taurate, styrene acrylic acid copolymer, propylene oxide-ethylene oxide-copolymer, polyethylene glycol 2,4,6-tristyrylphenyl ether, tristyrylphenol-polyglycol ether-phosphate, tristyrylphenole with 16 moles EO, tristyrylphenol-polyglycol ether-phosphate, oleyl-polyglycol ether with ethylene oxide, tallow fatty amine polyethylene oxide, nonylphenol polyglycol ether with 9-10 moles ethylene oxide and mixture thereof.

24. The fluxametamide composition as claimed in claim 1 or 14, wherein the suspending agent for suspension concentrate (SC) is selected from the group consisting of aluminum magnesium silicate, bentonite clay, silica, attapulgite clay and mixture thereof.

25. The fluxametamide composition as claimed in claim 1 or 14, wherein the antifoaming agent for suspension concentrate (SC) is selected from the group consisting of silicone oil, silicone compound, C₁₀˜C₂₀ saturated fat acid compounds or C₈˜C₁₀ aliphatic alcohols compound, silicone antifoam emulsion, dimethyl siloxane, polydimethyl siloxane, vegetable oil based antifoam, tallow based fatty acids, polyalkyleneoxide modified polydimethylsiloxane and mixture thereof.

26. The fluxametamide composition as claimed in claim 1 or 14, wherein the anti-freezing agent for suspension concentrate (SC) is selected from the group consisting of ethylene glycol, propane diols, glycerin or the urea, glycol (monoethylene glycol, diethylene glycol, polypropylene glycol, polyethylene glycol), glycerin, urea, magnesium sulfate heptahydrate, sodium chloride and mixture thereof.

27. The fluxametamide composition as claimed in claim 1 or 14, wherein the preservative for suspension concentrate (SC) is selected from the group consisting of 1,2-benzisothiazolin-3 (2H)-one, sodium salt, sodium benzoate, 2-bromo-2-nitropropane-1,3-diol, formaldehyde, sodium o-phenyl phenate, 5-chloro-2-methyl-4-isothiazolin-3-one and 2-methyl-4-isothiazolin-3-one and mixture thereof.

28. The fluxametamide composition as claimed in claim 1 or 14, wherein the thickener for suspension concentrate (SC) is selected from the group consisting of xanthan gum, PVK, carboxymethyl celluloses, polyvinyl alcohols, gelatin, sodium carboxymethylcellulose, hydroxyethyl cellulose, sodium polyacrylate, modified starch, acacia gum and mixture thereof.

29. The fluxametamide composition as claimed in claim 1 or 14, wherein the humectant for suspension concentrate (SC) is selected from the group consisting of urea, humic acid, glycerol, lactose and mixture thereof.

30. The fluxametamide composition as claimed in claim 1 or 14, wherein the solvent for suspo emulsion (SE) is selected from the group consisting of water, water soluble alcohols and dihydroxy alcohol ethers; water soluble alcohol or lower alcohol (1-4 carbon atoms); methanol, ethanol, n-propanol, isopropanol, n-butanol, tert-butanol; macromolecular alcohol; polyethylene glycol, sorbitol, glucitol, dihydroxy alcohol ethers; dihydroxy alcohol alkyl ether or dihydroxy alcohol aryl ethers; the examples of dihydroxy alcohol alkyl ether include ethylene glycol methyl ether, diethylene glycol methyl ether, propylene glycol methyl ether, di-propylene glycol methyl ether, ethylene glycol ethyl ether, diethylene glycol ethyl ether, propylene glycol ethyl ether, di-propylene glycol ethyl ether; the examples of dihydroxy alcohol aryl ethers include ethylene glycol phenyl ether, 5 diethylene glycol phenyl ether, propylene glycol phenyl ether, di-propylene glycol phenyl ether, and mixture thereof; hyrdocarbons include n-pentane, hexane(s), cyclohexane, methylcyclohexane, heptane, isooctane, benzene, toluene, xylene(s), isophorone and ester solvents such as methyloleate, dimethylamide and morpholineamide derivatives of C₆-C₁₆ fatty acids, and mono-alkylene carbonates such as ethylene carbonate, propylene carbonate and butylene carbonates, dimethylsulfoxide (DMSO), 2-ethylhexanol and n-butanol, n-alkylpyrrolidones, fatty acid dimethyl esters, fatty acid esters, dibasic esters, aromatic hydrocarbons and/or aliphatic hydrocarbons, one or more dimethylamides, such as C₈-dimethylamide, C₁₀-dimethylamide, C₁₂-dimethylamide, ethylene glycol, propylene glycol, polyalkylene glycols, aromatic hydrocarbons, methylpyrrolidinone (NMP); dimethylformamide (DMF); dimethylisosorbide (DMI); isophorone; acetophenone; 1,3-dimethyl-2-imidazolidonone; lactate esters; dimethyl and diethylcarbonates; alcohols including methanol; ethanol; iso-propanol; n-propanol; n-butanol; iso-butanol; and tert-butanol; methyl L-lactate, 2-ethylhexyl L-lactate, ethyl L-lactate, n-butyl L-lactate, octyl phenol ethoxylates and mixture thereof.

31. The fluxametamide composition as claimed in claim 1 or 14, wherein the emulsifier for suspo emulsion (SE) is selected from the group consisting of containing salts of dodecylbenzene sulphonate, Ca-salts or amine salts, and sulphonates of other C₁₁-C₁₆ alkylbenzenes, alkylether sulphates, alkylphenoletherphosphates and ester phosphates; non-ionic surfactants such as alkoxylated alcohols and alkylphenols, ethoxylated fatty acids, ethoxylated vegetable oils, ethoxylated castor oil, fatty acid esters, sorbitol, and their ethoxylated derivatives, ethoxylated amines, and condensates of glycerol; and catanionic emulsifiers such as a cationic amine, optionally in combination with an alkylsulphonate or ether sulphonate or ether phosphate, alkoxylated alcohols; alkoxylated alkylphenols; ethoxylated fatty acids; ethoxylated vegetable oils; ethoxylated tristyrylphenol (tristyrlphenol with 16 moles EO), tristyrylphenol-polyglycolether-phosphate, fatty acid esters of sorbitol and ethoxylated derivatives thereof; ethoxylated amines and condensates of glycerol; sulfonated alkylbenzenes in the range C₁₁-C₁₆ and salts thereof; alkylether sulphates; alkyletherphosphates; alkylphenoletherphosphates; or combinations thereof; salts of phosphate esters of ethoxylated tristyrylphenol; salts of sulphated ethers of ethoxylated tristyrylphenol; or a catanionic system, wherein a cationic amine is present in combination with an alkylsulphonate, an alkylethersulphonate, an ether sulphate, or an ether phosphate such as an alkyletherphosphate, nonylphenol polyethoxy ethanols, castor oil polyglycol ethers, polyadducts of ethylene oxide and polypropylene, tributyl phenoxy polyethoxy ethanol, octyl phenoxy polyethoxy ethanol and mixture thereof.

32. The fluxametamide composition as claimed in claim 1 or 14, wherein the stabilizer for suspo emulsion (SE) is selected from the group consisting of butylated hydroxytoluene (BHT) and epoxidized soybean oil (ESBO), epichlorhydrin and mixture thereof.

33. The fluxametamide composition as claimed in claim 1 or 14, wherein the anti-freezing agent for suspo emulsion (SE) is selected from the group consisting of ethylene glycol, propane diols, glycerine or the urea, glycol (monoethylene glycol, diethylene glycol, polypropylene glycol, polyethylene glycol), glycerine, urea, magnesium sulfate heptahydrate, sodium chloride and mixture thereof.

34. The fluxametamide composition as claimed in claim 1 or 14, wherein the antifoaming agent for suspo emulsion (SE) is selected from the group consisting of silicone oil, silicone compound, C₁₀˜C₂₀ saturated fat acid compounds or C₈˜C₁₀ aliphatic alcohols compound, silicone antifoam emulsion, dimethylsiloxane, polydimethyl siloxane, vegetable oil based antifoam, tallow based fatty acids, polyalkyleneoxide modified polydimethylsiloxane and mixture thereof.

35. The fluxametamide composition as claimed in claim 1 or 14, wherein the suspending agent for suspo emulsion (SE) is selected from the group consisting of aluminum magnesium silicate, bentonite clay, silica, silicone dioxide, attapulgite clay and mixture thereof.

36. The fluxametamide composition as claimed in claim 1 or 14, wherein the wetting agent for suspo emulsion (SE) is selected from the group consisting of ethylene oxide/propylene oxide block copolymer, polyarylphenyl ether phosphate, ethoxylated fatty alcohol, sodium dioctyl sulfosuccinate, sodium lauryl sulphate and sodium dodecyl benzene sulfonate, alkyl diphenyl sulfonates, sodium isopropyl naphthalene sulfonate, alkyl naphthalene sulfonate, octyl phenol ethoxylate, alkyl phenol ethoxylate and mixture thereof.

37. The fluxametamide composition as claimed in claim 1 or 14, wherein the wetting-spreading-penetrating agent for suspo emulsion (SE) is selected from the group consisting of organosilicone surfactants; trisiloxane ethoxylate, polydimethylsiloxane, polyoxyethylene methyl polysiloxane, polyoxyalkylene methyl polysiloxane, polyether polymethyl siloxane copolymer, heptamethyl trisiloxane, polyalkyleneoxide modified heptamethyl trisiloxane, heptamethyl trisiloxane ethoxylate, polyether modified polysiloxane, 10 mole ethylene oxide adduct of octylphenol, may or may not be in modified form, may be liquid or powder form and mixture thereof.

38. The fluxametamide composition as claimed in claim 1 or 14, wherein the preservative for suspo emulsion (SE) is selected from the group consisting of propionic acid and its sodium salt, sorbic acid and its sodium or potassium salt, benzoic acid and its sodium salt, p-hydroxy benzoic acid sodium salt; methyl p-hydroxy benzoate; and biocide such as sodium benzoate, 1,2-benzisothiazoline-3-one, 2-methyl-4-isothiazolin-3-one, 5-chloro-2-methyl-4-isothiazolin-3-one, potassium sorbate, para hydroxy benzoates and mixtures thereof.

39. The fluxametamide composition as claimed in claim 1 or 14, wherein the thickener for suspo emulsion (SE) is selected from the group consisting of thickening, gelling, and anti-settling agents, water-insoluble particulates and water-soluble polymers, clays and silicas, montmorillonite, bentonite; magnesium aluminum silicate; and attapulgite, natural extracts of seeds and 15 sea weeds are synthetic derivatives of cellulose and mixture thereof; examples of these types of materials include, but are not limited to, guar gum; locust bean gum; carrageenam; xanthan gum; alginates; methyl cellulose; sodium carboxymethyl cellulose (SCMC); hydroxyethyl cellulose (HEC) and mixture thereof; anti-settling agents are based on modified starches, polyacrylates, polyvinyl 20 alcohol and polyethylene oxide and mixture thereof.

40. The fluxametamide composition as claimed in claim 1 or 14, wherein the dispersing agent for suspo emulsion (SE) is selected from the group consisting of a polyesters, polyamides, poly-carbonates, polyurea and polyurethanes, acrylic polymers, acrylic graft copolymer, styrene copolymers, butadiene copolymers, polysaccharides, starch and cellulose derivatives, vinylalcohol, vinylacetate and vinylpyrrolidone polymers and copolymers, polyethers, epoxy, phenolic and melamine resins, polyolefins and define copolymers and mixture thereof; examples of polymers are acrylate polymers, poly(methacrylate), poly(ethyl methacrylate), poly(methylmethacrylate), acrylate copoylmers and styrene-acrylic copolymers, poly(styrene-co maleic anhydride), cellulosic polymers, ethyl cellulose, cellulose acetate, cellulose acetatebutyrate, acetylated mono, di, and triglycerides, poly(vinylpyrrolidone), vinyl acetate polymers and copolymers, poly(alkylene glycol), styrene butadiene copolymers, poly(orthoesters), alkyd resins, and mixture of two or more of these; examples of biodegradable polymers are biodegradable polyesters, starch, polylactic acid starch blends, polylactic acid, poly(lactic acid-glycolic acid) copolymers, polydioxanone, cellulose esters, ethyl cellulose, cellulose acetate butyrate, starch esters, starch esteraliphatic polyester blends, modified corn starch, polycaprolactone, poly(namylmethacrylate), wood rosin, polyanhydrides, polyvinylalcohol, polyhydroxybutyratevalerate, biodegradable aliphatic polyesters, and polyhydroxybutyrate and mixture thereof; the examples of dispersing agents are alkylated naphthalene sulfonate, sodium salt, sodium salt of naphthalene sulfonate condensate, sodium salt of alkyl naphthalene sulfonate, sodium ligno sulfonate, sodium ploycarboxylate, EO/PO block copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide and mixture thereof.

41. The fluxametamide composition as claimed in claim 1 or 14, wherein the buffering agent for suspo emulsion (SE) is selected from the group consisting of calcium hydroxyapatite, potassium dihydrogen phosphate, sodium hydroxide, carbonated apatite, calcium carbonate, sodium bicarbonate, tricalcium phosphate, calcium phosphates, carbonated calcium phosphates, amine monomers, lactate dehydrogenase and magnesium hydroxide and mixture thereof.

42. The fluxametamide composition as claimed in claim 1 or 14, wherein the humectant for suspo emulsion (SE) is selected from the group consisting of urea, humic acid, glycerol, lactose and mixture thereof.

43. The fluxametamide composition as claimed in claim 1 or 14, wherein the dispersing agent for wettable granule (WG) is selected from the group consisting of sodium polycarboxylate (sodium polyacrylate), naphthalene sulfonic acid, sodium salt condensates with formaldehyde, polyalcoxylated alkylphenol, naphthalene sulfonic acid formaldehyde condensate, methyl naphthalene-formaldehyde-condensate sodium salt, naphthalene condensates, lignosulfonates, calcium lignosulfonate, lignin sulfonate sodium salt, alkyl naphthalene sulfonate, sodium salt, alkyl naphthalene sulfonate and mixture thereof.

44. The fluxametamide composition as claimed in claim 1 or 14, wherein the wetting agent for wettable granule (WG) is selected from the group consisting of sodium N-methyl-N-oleoyl taurate, alkylated naphthalene sulfonate, sodium salt, mixture of isomers of dibutyl naphthalene sulphonic acid sodium salt, sodium di-isopropyl naphthalene sulphonate, sodium lauryl sulfate, dioctyl sulfate, alkyl naphthalene sulfonates, phosphate esters, sulphosuccinates and non-ionic such as tridecyl alcohol ethoxylate, alkyl or alkaryl sulfonates, alkylbenzene sulfonates, alpha olefin sulfonate and alkyl naphthalene sulfonates, ethoxylated or non-ethoxylated alkyl or alkaryl carboxylates, alkyl or alkaryl phosphate esters, alkyl polysaccharide, di or mono alkyl sulfosuccinate derivatives, alpha olefin sulfonates, alkyl naphthalene sulfonates, dialkyl sulphosuccinates, butyl, dibutyl, isopropyl and di-isopropyl naphthalene sulfonate salts, C₁₂ alkyl benzene sulfonate or C₁₀-C₁₆ alkyl benzene sulfonate, organosilicons surfactants; trisiloxane ethoxylate, polydimethylsiloxane, polyoxyethylene methyl polysiloxane, polyoxyalkylene methyl polysiloxane, polyether polymethyl siloxane copolymer, trisiloxane heptamethyl, polyalkyleneoxide modified heptamethyl trisiloxane, polyether modified polysiloxane, may or may not be in modified form, may be liquid or powder form and mixture thereof.

45. The fluxametamide composition as claimed in claim 1 or 14, wherein the antifoaming agent for wettable granule (WG) is selected from the group consisting of polydimethylsiloxane and mixture thereof.

46. The fluxametamide composition as claimed in claim 1 or 140, wherein the carrier for wettable granule (WG) is selected from the group consisting of china clay, silica, lactose anhydrous, ammonium sulfate, sodium sulfate anhydrous, corn starch, urea, EDTA, urea formaldehyde resin, diatomaceous earth, kaolin, bentonite, kieselguhr, fuller's earth, attapulgite clay, bole, loess, talc, chalk, dolomite, limestone, lime, calcium carbonate, powdered magnesia, magnesium oxide, magnesium sulphate, sodium chloride, gypsum, calcium sulphate, pyrophyllite, silicates and silica gels; fertilizers, for example, ammonium sulphate, ammonium phosphate, ammonium nitrate and urea; natural products of vegetable origin, for example, grain meals and flours, bark meals, wood meals, nutshell meals and cellulosic powders; and synthetic polymeric materials, ground or powdered plastics and resins, bentonites, zeolites, titanium dioxide, iron oxides and hydroxides, aluminium oxides and hydroxides, or organic materials such as bagasse, charcoal, or synthetic organic polymers and mixture thereof.

47. The fluxametamide composition as claimed in claim 1 or 14, wherein the humectant for wettable granule (WG) is selected from the group consisting of humic acid, glycerol, lactose, sodium sulphate anhydrous or mixture thereof.
